(19) United States
(12) Patent Application Publication
(10) Pub. No.: US 2012/0278123 A1
(43) Pub. Date: Nov. 1, 2012

(54) Method And System For Determining The Capacity Required To Complete Work During Planned Start And Finished Times

(76) Inventor: Dale T. Houle, Milford, CT (US)

(21) Appl. No.: 13/512,268

(22) PCT Filed: Nov. 29, 2010
(86) PCT No.: PCT/US2010/058245

§ 371 Date: May 25, 2012

Related U.S. Application Data
(60) Provisional application No. 61/266,093, filed on Dec. 2, 2009.
(60) Provisional application No. 61/357,081, filed on Jun. 21, 2010.

(51) Int. Cl. G06Q 10/06

(52) U.S. Cl. 705/7.25

(57) ABSTRACT

In one aspect, the present invention is directed to a method for determining the capacity required to complete work during planned start and finished times. The first step entails providing a plurality of Resource Group Names, wherein each Resource Group Name (RGN) represents a particular Work Center (WC) having predetermined resources associated therewith. The predetermined resources include equipment, operators, set-up person(s), fixtures and tooling. The method further includes the steps of selecting a particular item that is in a predefined process flow, providing data that represents a planned movement of the selected item along the predefined process flow, identifying all process steps in the predefined process flow through which the selected item must pass, identifying each Reporting Point (RP) in each selected item's predefined process flow, retrieving data that represents the Required Work Content (RWC) of the selected item at each process step along the predefined process flow, determining the Required Work Content (RWC) to completely perform all process steps in the overall process, providing, for each step of the predefined process flow, an amount of Allocated Time Buffer (ATB) required to accommodate variability associated with completing the Required Work Content (RWC), establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB), retrieving a document start date-time and a document finish date-time for each selected item that enters the predefined process flow, utilizing the Resource Group Name (RGN) representing the Work Center (WC) and the corresponding Work Center (WC) Daily Work Calendar (DWC), Required Work Content (RWC), Allocated Time Buffers (ATB) and document start or finish date-time to establish the planned start date-time and planned finish date-time at each process step in each item's open document's, and utilizing the resources in the Resource Group Name (RGN) representing the Work Center (WC) and the corresponding Work Center (WC) Daily Work Calendar (DWC) to map resource loading at each process step within each open document in accordance with the established planned start date-time and planned finish date-time at each process step to identify any local Allocated Time Buffer (ATB) overloads corresponding to any of the Work Centers (WC) and the resources associated therewith to determine additional capacity requirements.

### CROSS-REFERENCE TO RELATED APPLICATIONS

This application also claims the benefit of U.S. provisional application No. 61/266,093, filed Dec. 2, 2009, and U.S. provisional application No. 61/357,081, filed Jun. 21, 2010. The entire disclosures of the aforementioned application Nos. 61/266,093 and 61/357,081 are hereby incorporated by reference.

### TECHNICAL FIELD

The present invention generally relates to a method and system for determining the relative priority of items moving in a predefined process flow and the identification of those steps in a predefined process flow providing the greatest opportunities for improvement.

### BACKGROUND ART

Within a predefined process flow, there are times when the actual movement of an item from one Reporting Point (RP) to another Reporting Point (RP) is slower than the planned movement of the item. Such a situation requires identification of the cause of the delay and implementation of corrective measures and/or focused improvement efforts so as to prevent such delays from occurring in the future.

The premise of a predefined process flow incorporates the perspective of a fully integrated logistics process and the relevant elements associated with the processing and movement of material and its related information. This perspective is exemplified with regards to production processes in the publication entitled The Goal, A Process of Ongoing Improvement, by Eliyahu M. Goldratt and Jeff Cox, First Edition, 1984, Third Revised Edition, 2004, The North River Press Publishing Company. This perspective is further exemplified with regard to integrated process flows involving production and distribution as well as repair and distribution in the programs entitled “Supply Chain Technical Expert” and the “Supply Chain Deployment Expert” which are taught by the Avraham Y. Goldratt Institute, New Haven, Conn., all of which utilize the Theory of Contraints (TOC) as an overarching framework for assessing and managing process flows.

What is needed is a method and system that identifies delays in the movement of a predetermined item in a predefined process flow and provides information that allows a user to take appropriate corrective measures and/or make adjustments to particular steps of the predefined process flow.

### DISCLOSURE OF THE INVENTION

In order to address the foregoing deficiencies and problems, the present invention is directed to a method and system that provides significant improvement in inventory management as well as Managing, Planning and Scheduling work flow.

In one aspect, the present invention is directed to a method for determining the relative priority of in-process work and focusing process improvements comprising the steps of selecting an item that is to be reviewed or managed, utilizing transaction data that relates to the selected item and which was captured at regular Reporting Intervals (RI) at each Reporting Point (RP), and processing the provided transaction data with a processing resource to reveal an item's actual movement along a predefined process flow as compared to its planned movement along that same predetermined process flow. The method further includes the steps of determining the difference between the actual movement of the selected item and the planned movement of the selected item. The difference between actual-to-planned movement at regular Reporting Intervals (RI) and at each Reporting Point (RP) is used to determine the actual amount of downstream Time Buffer Remaining (TBR) in relation to the total planned Time Buffer (TB). The method effects comparison of the actual amount of downstream Time Buffer Remaining (TBR) to the planned amount of downstream Time Buffer Remaining (TBRP) at each Reporting Point (RP) and computation of the ratio TBR/TBRP. The ratio yields a Buffer Recovery Percent (BRP) for the selected item. The Buffer Recovery Percent (BRP) is determined for every item as it moves in a predefined process flow from one Reporting Point (RP) to another Reporting Point (RP). Relative priorities are assigned to all the items wherein the item with the lowest Buffer Recovery Percent (BRP) has the highest priority.

In another embodiment of the method of the present invention, the method further comprises the steps of computing an Estimated Time Buffer Consumption Ratio (BCRE) based on the estimated amount of downstream Allocated Time Buffer Remaining (ATBR) at each Reporting Interval (RI) and the total Allocated Time Buffer (ATB) between Reporting Points (RP). Such a computation is represented by the formula:

BCRE=ATBR/ATB

The present invention addresses the scenario wherein within a predetermined process flow, an item's actual movement may be slower than planned movement thereby requiring a need to (i) create an alert for a possible delay in an item's actual movement and, (ii) an action to check status of the item's actual movement for a possible delay. In order to address such a situation, the method of the present invention, in a further embodiment, comprises the steps of allowing the user to input an “Alert” threshold value, and a “Check Status” threshold value, identifying an item in the predefined process flow that has an Estimated Buffer Consumption Ratio (BCRE) that approaches the “Alert” threshold value and then subsequently approaches the “Check Status” threshold value thereby initiating action to “Check Status” of the item's actual movement.

In another embodiment of the method of the present invention, the method further comprises the steps of computing an actual time Buffer Consumption Ratio (BCR) based on the actual amount of downstream Time Buffer Remaining (TBR) and the total planned Time Buffer (TB), and computing a Planned time Buffer Consumption Ratio (BCRP) based on the Planned amount of downstream Time Buffer Remaining (TBRP) in relation to the total planned Time Buffer (TB). Such computations are represented by the formulae:

BCR=TBR/TB, and

BCRP=TBRP/TB

In a related aspect, the present invention is directed to a computer program for performing a method that determines the relative priority of in-process work in an electronic data system comprising a computer readable medium and computer program instructions recorded on the computer readable medium and executed by a processor, for performing the steps of selecting a particular item that is in a predefined process flow, utilizing transaction data that relates to the particular item and its movement through the predefined process flow, extracting from the transaction data particular transaction data that was provided at a regular Reporting Intervals (RI) and at each Reporting Point (RP), providing data that represents a planned movement of the selected item along the predefined process flow, processing the extracted transaction data to determine the selected item's actual movement along the predefined process flow and comparing the actual movement of the selected item to the planned movement of the selected item through the predefined process flow, determining the difference between the actual movement of the selected item and the planned movement of the selected item, providing a total planned Time Buffer (TB) for the movement of the selected item along the predefined process flow, computing the actual amount of downstream Time Buffer Remaining (TBR) in relation to the total planned Time Buffer (TB) using the determined difference, comparing the actual amount of downstream Time Buffer Remaining (TBR) to the Planned amount of downstream Time Buffer Remaining (TBRP) at regular Reporting Intervals (RI) and at each Reporting Point (RP) and computing the ratio TBR/TBRP wherein the ratio yields a Buffer Recovery Percent (BRP) for the selected item, determining the Buffer Recovery Percent (BRP) for every item as it moves in a predefined process flow from one Reporting Point (RP) to another Reporting Point (RP), and assigning relative priorities to all the items wherein the item with the lowest Buffer Recovery Percent (BRP) has the highest priority.

The present invention addresses the scenario wherein within a predetermined process flow, an item's actual movement is slower than planned movement thereby requiring a need to (i) plan for recovering excessive Time Buffer (TB) consumption and, (ii) put the plan to Recover Time Buffer (RTB) into action. In order to address such a situation, the method of the present invention, in a further embodiment, comprises the steps of allowing the user to input an “Assess and Plan” threshold value, and an “Action” threshold value, identifying an item in the predefined process flow that has Buffer Recovery Percent (BRP) that approaches the “Assess and Plan” threshold value and then subsequently initiating time buffer recovery assessment and planning. The method also identifies an item in the predefined process flow that has a Buffer Recovery Percent (BRP) value that approaches the “Action” threshold value thereby initiating the plan to Recover Time Buffer (RTB). The plan to Recover Time Buffer (RTB) is generally accomplished by following the adjusted priorities and/or applying more, better or faster resources to work on the remaining workload within the process flow in which the excessive buffer consumption has occurred. In certain circumstances, the action taken to Recover Time Buffer (RTB) is accomplished by the release of an additional unit of work from the upstream Physical inventory Buffer (PB) from which the downstream process flow draws or from the upstream work-in-process when the upstream Physical inventory Buffer (PB) is zero (i.e., Not-In-Stock). This particular type of action to Recover Time Buffer (RTB) is implemented when (i) the user deems it to be the appropriate course of action, (ii) there is currently inventory available in the upstream Physical Buffer (PB), or (iii) there is an upstream process flow with work-in-process that feeds that upstream PB when the PB is zero (i.e., Not-In-Stock), and (iv) the decision is made to reach back into the upstream process flow and expedite a part that is in-process. Thus, this change in priorities of the upstream work-in-process is accomplished by lowering that specific item's BRP through an adjustment in the item's TBR based on using the TBR and TBRP in both the downstream and upstream process flows. Such an adjustment is represented by the formula:

BRPA_{US}=(TBR_{US}+TBR_{DS})/(TBRP_{US}+TBRP_{DS})

wherein:
BRPA_{US} is the Adjusted upstream Buffer Recover Percent;
TBR_{US} is the current upstream Time Buffer Remaining;
TBR_{DS} is the current downstream Time Buffer Remaining;
TBRP_{US} is the current upstream Planned Time Buffer Remaining; and
TBRP_{DS} is the current downstream Planned Time Buffer Remaining.

The conditions for adjusting the upstream BRP include a Not-In-Stock (NIS) condition in the Physical Buffer (PB) from which the upstream process feeds and downstream process draws. However, in a further embodiment of the invention, a user may choose to adjust the BRP using a Not-In-Stock Physical Buffer Factor (PBF_{NIS}), described in the ensuing description, in place of or in addition to the BRPA_{US}.

A further embodiment of the method of the present invention addresses the scenario wherein the quantity of inventory issued from the Physical Buffer (PB), over a series of Reporting Intervals (RI), will add up to produce a cumulative Reporting Interval Demand (RID_{RI}) pattern that exceeds the cumulative Maximum Reporting Interval (RIM) Demand (RID_{RIMax}) pattern derived from historical data. In one embodiment, the historical data is generated by the method described in commonly owned U.S. Patent Application Publication No. 20060235734 entitled “Method and System for Determining Buffer Inventory Size”, referred to herein as “Enterprise Buffer Sizing Tool” or EBST. Thus, in one embodiment, the method of the present invention uses EBST to establish the cumulative Maximum Reporting Interval (RIM) Demand (RID_{RIMax}) during the Time-to-Reliably Replenish (TRR) starting from a TRR equal to one (1) Reporting Interval (RI) and computing the maximum quantity issued, incrementing the TRR by one (1) Reporting Interval (RI) and computing the maximum for two (2) Reporting Intervals (RI), and repeating this process until the number of Reporting Intervals (RI) equals the specified TRR. These foregoing method steps establish a Physical Buffer Pattern (PBP) based on accumulating the Maximum Reporting Interval (RIM) Demand (RID_{RIMax}) for each Reporting Interval (RI) throughout the TRR which can be viewed from the perspectives of the Physical Buffer Patterns (PBP) in terms of Physical Buffer Demand Pattern (PBDP), Physical Buffer Issue Pattern (PBIP) and Physical Buffer Replenish Pattern (PBRP). The Physical Buffer Pattern (PBP) is used as a point of reference from which actual issues of inventory per Reporting Interval (RI) can be tracked and variances recorded. Thus, inventory issue data is collected from a data source that relates to the selected item. The method of the present invention processes the issue data captured at regular Reporting Intervals (RI) with a processing resource to determine a selected item's actual Physical Buffer Pattern (PBP) through time and comparing the actual PBP to the historical PBP to identify variances. Such variances are used to identify changes in demand patterns that require further analysis so as to determine the cause of such changes and, if necessary, establish an updated historical PBP.

The method of the present invention also addresses the variability in demand wherein some items experience large infrequent (RI=1) RID_{1MaX} demands whose occurrences need to be anticipated and some items experience cumulative demand during the Time-To-Reliable-Replenish (TRR) in excess of the Physical Buffer (PB) resulting in a Not-In-Stock (NIS) situation. The actual quantities issued for each Reporting Interval (RI) are sorted in order of descending quantity and then summed together to determine the quantity of Reporting Interval (RI) issues that are needed to produce a total quantity issued that is greater than or equal to the Maximum, historical one (1) Reporting Interval (RIM) Demand (issue) quantity (RID_{1MaX}). Next, a Physical Buffer Factor (PBF) is computed. The computed PBF is based on the ratio of the number of Reporting Interval (RI) issues (required to produce a total quantity issued that is greater than or equal to the Maximum, historical one (1) Reporting Interval (RI) Demand (issue) quantity (RID_{1MaX})) to the total number of Reporting Intervals (RI) in the TRR. When the PBF decreases below a user defined level, it is used to create an adjustment in the BRPs of those items closest to completing the predefined process flow totaling a quantity that is greater than or equal to the Maximum, historical one (1) Reporting Interval (RIM) Demand (RID_{1Max}) less the on-hand quantity in the Physical Buffer (PB) by multiplying their current BRP by the PBF and computing an Adjusted BRP (BRPA). The user can decide to apply this PBF process to anticipate Maximum Reporting Interval (RIM) Demand (RID_{RIMax}) for one (1) RIM, two (2) RIM, etc. by selecting which RIM (i.e., x=1−n) is to be used to determine the anticipated RID_{RIMax-x} (i.e., x=1−n) quantity. An additional user-defined Not-In-Stock PBF (PBF_{NIS}) is applied to the BRP within a process flow when the quantity available to issue is zero and there is a request for a quantity of items to be issued.

The method of the present invention also addresses the variability in the process flow wherein some items in work experience excessive delays resulting in a negative BRP. Such excessive delays can be partially compensated for by increasing the rate of movement of the remaining items still in work by adjusting their current BRP. Such an adjustment is accomplished by multiplying the current BRP by a value computed by the formula:

PBF_{-BCR}=((PB−# of items with a BRP<0)/PB).

The method of the present invention also provides Time Buffer (TB) and Physical Buffer Pattern (PBP) Trend Information to focus improvement efforts and to allow for a re-adjustment of the Time Buffer (TB) size and/or the Physical Buffer (PB) size. In order to accomplish this task, the method effects obtaining, storing and evaluating transaction data and issue data for each item in work including the following data for that item:

BCR: Buffer Consumption Ratio;

BCRP: Planned Buffer Consumption Ratio;

BCRD: Difference between BCR and BCRP;

BCRV: BCR Variance;

PBPV: Physical Buffer Pattern Variance.

For each Reporting Point (RP) the BCRD_{RP} and BCRV_{RP} are computed in accordance with the following formula:

BCRD_{RPi}=(BCR_{RPi}−BCRP_{RPi})

BCRV_{RPi}=(BCRD_{RPi}−BCRD_{RPi-1}).

In accordance with the invention, this foregoing data is used to establish trends for each Reporting Point (RP) in the predefined process flow related to Allocated Time Buffer (ATB) consumption in order to: (1) ascertain opportunities for reducing Allocated Time Buffers (ATB) if there is a lack of use of allocated time buffers (ΣBCRV_{RP}>0), (2) process improvements if there is an overuse of allocated time buffers (ΣBCRV_{RP}<0), as well as for the entire process flow related to planned Time Buffer (TB) consumption in order to ascertain opportunities for increasing or decreasing specific Time Buffers (TB) in accordance with the intended Safety Time Buffer (STB) to maintain a balanced flow (#BCR_{Finish}>(STB/TB) as compared to the #BCR_{Finish}<(STB/TB) as compared to #BCR_{Finish}<0), and (3) ascertain changes in the demand patterns for each item that are based on the magnitude and number of Physical Buffer Pattern Variances (PBPV) occurring for each item's Maximum Reporting Interval (RIM) Demand (RID_{RIMax}) in accordance with which RID_{RI} first experienced the PBPV. This enables adjustments to be made to the Physical Buffer Pattern (PBP) so as to maintain an updated PBP from which to ascertain changes in demand patterns and on which to base the Physical Buffer Factor (PBF) used for anticipating a Maximum Reporting Interval (RIM) Demand quantity (RID_{RIMax}). For each item's Open Documents at each Reporting Interval (RI) the Physical Buffer Pattern Variance (PBPV_{RIM-RI}) for each Maximum Reporting Interval (RIM) Demand (RID_{RIMax}) is computed in accordance with the following formula:

PBPV_{RIM-RI}=((Σ₁^{RIM}RIDᵢ)_{RIM-RI}−(RID_{RIMax})).

The computations related to the following PBPV_{RIM-RI} conditions are captured for further analysis and possible changes to the perimeter of Physical Buffer Pattern (PBP) and Physical Buffer (PB) size (PBPV_{RIM-RI}<0) would indicate a variance within the perimeter of a PBP and could lead to a decrease in the perimeter, where as (PBPV_{RIM-RI}>0 and (RID_{RIMax} PBPV_{RIM-RI})<PB) would indicate a variance beyond the perimeter of the PBP but not beyond the Physical Buffer (PB) size and could lead to an increase in the PBP perimeter, and (PBPV_{RIM-RI}>0 and (RID_{RIMax} PBPV_{RIM-RI})>PB) would indicate a variance beyond the Physical Buffer (PB) (i.e., a Not-In-Stock) and could lead to an increase in the Physical Buffer (PB) size).

In a related aspect, the present invention is directed to a method for determining the capacity required to complete work during planned start and finished times. The first step of this method is to provide a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling. The method further comprises the steps of selecting a particular item that is in a predefined process flow, providing data that represents a planned movement of the selected item along the predefined process flow, identifying all process steps in the predefined process flow through which the selected item must pass, identifying each Reporting Point (RP) in each selected item's predefined process flow, retrieving data that represents the Required Work Content (RWC) of the selected item at each process step along the predefined process flow, determining the Required Work Content (RWC) to completely perform all process steps in the overall process, and providing, for each step of the predefined process flow, an amount of Allocated Time Buffer (ATB) required to accommodate variability associated with completing the Required Work Content (RWC). The method further comprises the step of establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB). The method further comprises the steps of retrieving a document start date-time for each selected item that enters the predefined process flow, and utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the planned start date-time and planned finish date-time at each process step in each item's open document's. The method further comprises the step of retrieving a document finish date-time for each selected item that enters the predefined process flow and utilizing the Resource Group Name (RGN) representing the Work Center (WC) and the corresponding Work Center (WC) Daily Work Calendar (DWC), Required Work Content (RWC), Allocated Time Buffers (ATB) and document finish date-time to establish the planned start date-time and planned finish date-time at each process step in each item's open document's. The method further comprises the step of utilizing the resources in the Resource Group Name (RGN) representing the Work Center (WC) and the corresponding Work Center (WC) Daily Work Calendar (DWC) to map resource loading at each process step within each open document in accordance with the established planned start date-time and planned finish date-time at each process step to identify any local Allocated Time Buffer (ATB) overloads corresponding to any of the Work Centers (WC) and the resources associated therewith.

In a further aspect, the present invention is directed to a method for achieving Impact Capacity Planning. In this embodiment, a method is provided that determines the capacity required to complete work during planned start and finished times. The first step of the method comprises the step of providing a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling. The method further comprises the steps of selecting a particular item that is in a predefined process flow, providing data that represents a planned movement of the selected item along the predefined process flow, identifying all process steps in the predefined process flow through which the selected item must pass, identifying each Reporting Point (RP) in each selected item's predefined process flow, retrieving data that represents the Required Work Content (RWC) of the selected item at each process step along the predefined process flow, determining the Required Work Content (RWC) to completely perform all process steps in the overall process, and providing, for each step of the predefined process flow, an amount of Allocated Time Buffer (ATB) required to accommodate variability associated with completing the Required Work Content (RWC). The next step comprises establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB). The method further comprises the steps of retrieving a document start date-time for each selected item that enters the predefined process flow, retrieving a document finish date-time for each selected item that enters the predefined process flow, utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the baseline planned start date-time and planned finish date-time at each process step in each item's open document's. The method further comprises the step of performing a first simulation that comprises simulating the Required Work Content (RWC) completion forward in time, according to the Work Center (WC) Daily Work Calendar (DWC) designated for the first simulation, by sequencing forward in time from the planned document start date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}). The next step comprises capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance). The next step comprises the step of performing a second simulation that comprises simulating the Required Work Content (RWC) completion backward in time, according to the Work Center (WC) Daily Work Calendar (DWC) designated for the second simulation, by sequencing backward in time from the planned document finish date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time. The next step entails capturing the resulting early document start date-time (global variance) and corresponding Work Center (WC) Reporting Point (RP) negative Buffer Consumption Ratio Variance (−BCRV) values (local variance). The next step comprises the step of performing a third simulation that comprises simulating forward in time the Required Work Content (RWC) completion, according to the Work Center (WC) Daily Work Calendar (DWC) designated for the third simulation, by sequencing forward in time from the planned document start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the first forward-in-time simulation that finished with a negative Buffer Consumption Ratio (−BCR_{FINISH}) into additional capacity requirements in Specific Windows of Time (SWT) for the corresponding Work Center (WC) and the resources associated therewith. The method includes the step of converting additional capacity requirements into financial requirements in accordance with user-defined “Over Time Labor Rates”.

In yet another aspect, the present invention is directed to a method for determining the capacity required to complete work during planned start and finished times. The first step of the method is to provide a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling. The method further comprises the steps of selecting a particular item that is in a predefined process flow, providing data that represents a planned movement of the selected item along the predefined process flow, identifying all process steps in the predefined process flow through which the selected item must pass, identifying each Reporting Point (RP) in each selected item's predefined process flow, retrieving data that represents the Required Work Content (RWC) of the selected item at each process step along the predefined process flow, determining the Required Work Content (RWC) to completely perform all process steps in the overall process, and providing, for each step of the predefined process flow, an amount of Allocated Time Buffer (ATB) required to accommodate variability associated with completing the Required Work Content (RWC). The next step in the method is to establish for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB). The method further comprises the steps of retrieving a document start date-time for each selected item that enters the predefined process flow, retrieving a document finish date-time for each selected item that enters the predefined process flow and utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the baseline planned start date-time and planned finish date-time at each process step in each item's open document's. The next step is to perform a first simulation comprising the step of simulating the Required Work Content (RWC) completion forward in time, according to the Work Center (WC) Daily Work Calendar (DWC) designated for the first simulation, by sequencing forward in time from the planned document start date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}). The next step comprises capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance). The next step of this method is to perform a second simulation comprising the step of simulating the Required Work Content (RWC) completion backward in time, according to the Work Center (WC) Daily Work Calendar (DWC) designated for the second simulation, by sequencing backward in time from the planned document finish date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time. The next step entails capturing the resulting early document start date-time (global variance) and corresponding Work Center (WC) Reporting Point (RP) negative Buffer Consumption Ratio Variance (−BCRV) values (local variance). The next step comprises performing a third simulation comprising the step of simulating forward in time the Required Work Content (RWC) completion, according to the Work Center (WC) Daily Work Calendar (DWC) designated for the third simulation, by sequencing forward in time from the planned document start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the first forward in time simulation that finished with a negative Buffer Consumption Ratio (−BCR_{FINISH}) into additional capacity requirements in Specific Windows of Time (SWT) for the corresponding Work Center (WC) and the resources associated therewith. The next step of this method is to convert additional capacity requirements into identification of the Primary Resource DRUM (RDRUM). The method further comprises the step of re-sequencing Required Work Content (RWC) on the Primary RDRUM, utilizing the user defined Dependent Setup Matrix (DSM) information, to reduce the overall time spent on setups during the Specific Windows of Time (SWT) requiring additional simulated capacity to bring the negative Buffer Consumption Ratio (−BCRV) values computed in the third simulation connected to documents for all or specific customers finishing with a negative Buffer Consumption Ratio (−BCR_{FINISH}) in the first simulation to zero. The next step is to hold the (Primary) Resource DRUM (RDRUM) schedule fixed and performing a fourth simulation that comprises the step of simulating the Required Work Content (RWC) completion, according to the Work Center (WC) Daily Work Calendar (DWC) designated for the fourth simulation, by sequencing forward in time from the scheduled RDRUM finish date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}) and by sequencing backward in time from the scheduled RDRUM start date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time. The method further comprises the steps of capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance), and capturing the resulting early document start date-time (global variance) and corresponding Work Center (WC) Reporting Point (RP) negative Buffer Consumption Ratio Variance (−BCRV) values (local variance). The next step comprises holding the Primary Resource DRUM (RDRUM) schedule fixed and performing a fifth simulation comprising the step of simulating the Required Work Content (RWC) completion, according to the Work Center (WC) Daily Work Calendar (DWC) designated for the fifth simulation, by sequencing forward in time from the scheduled RDRUM finish date-time and backward in time from the scheduled RDRUM start date-time through each Reporting Point (RP) in each item's open documents and converting all Reporting Point (RP) planned start date-time to planned finish date-time overloads as computed by the corresponding negative Buffer Consumption Ratio Variance (−BCRV) values that are associated with documents in the fourth simulation (Primary RDRUM forward/backward in time simulation) that finished with a negative Buffer Consumption Ratio (−BCR_{FINISH}) or an early document start into additional capacity requirements in Specific Windows of Time (SWT) for the corresponding Work Center (WC) and the resources associated therewith.

Other objects, features and advantages of the present invention will be apparent from the ensuing description.

### BRIEF DESCRIPTION OF THE DRAWINGS

The foregoing features of the present invention will become more readily apparent and may be understood by referring to the following detailed description of an illustrative embodiment of the present invention, taken in conjunction with the accompanying drawings, in which:

FIG. 1 is an exemplary graph illustrating the implementation of particular steps of the method of the present invention, including identifying each Reporting Point (RP) in each item's predefined process flow, the resources and time needed to complete the Required Work Content (RWC) for each Reporting Point (RP), the amount of Allocated Time Buffer (ATB) required to address the variability associated with the completion of each item's Required Work Content (RWC_{RP}) associated with each Reporting Point (RP) along a predetermined process flow and each item's Time-to-Reliably Replenish (TRR);

FIG. 2 is an exemplary graph illustrating the method steps of determining (i) the amount of Allocated Time Buffer (ATB) that each item's process steps will receive, (ii) the Safety Time Buffer (STB) for each item's overall process, and (iii) the Planned Time Buffer Remaining (TBRP) at each Reporting Point (RP);

FIG. 3 is an exemplary graph illustrating several steps of the method of the present invention, including the steps of allowing a user to define Buffer Recovery Percent (BRP) values that will be used as triggers for planning to Recover Time Buffer (RTB) and for taking actions to Recover Time Buffer (RTB);

FIG. 4A is an exemplary graph illustrating several steps of the method of the present invention, including the steps of computing an updated Buffer Recovery Percent (BRP) at regular Reporting Intervals (RI) and Reporting Points (RP) for each item's Open Documents, and flagging those items with Buffer Recovery Percent (BRP) values that are less than the user defined values in order to plan and take actions to Recover Time Buffer (RTB);

FIG. 4B is an exemplary graph illustrating several steps of the method of the present invention, including the steps of computing an updated Adjusted Buffer Recovery Percent (BRPA) based on Physical Buffer Factors (PBF) at regular Reporting Intervals (RI) and Reporting Points (RP) for each item's Open Documents, and flagging those items with Adjusted Buffer Recovery Percent (BRPA) values that are less than the user defined values in order to plan and take actions to Recover Time Buffer (RTB);

FIG. 5A is an exemplary graph illustrating the method steps of computing an Estimated Buffer Consumption Ratio (BCRE) for each item's Open Documents at regular Reporting Intervals (RI) between Reporting Points (RP);

FIG. 5B is an exemplary graph illustrating the method steps of computing an actual Buffer Consumption Ratio (BCR) for each item's Open Documents at regular Reporting Intervals (RI) and at each Reporting Point (RP);

FIG. 6 is an exemplary graph illustrating the method steps of graphically displaying the computed Buffer Consumption Ratio (BCR) for each item at each Reporting Point (RP);

FIG. 7 is an exemplary graph illustrating the method steps of computing a Planned Buffer Consumption Ratio (BCRP) for each item's Open Documents at regular Reporting Intervals (RI) and at each Reporting Point (RP);

FIG. 8 is an exemplary graph illustrating the method steps of graphically displaying the computed Planned Buffer Consumption Ratio (BCRP) for each item at each Reporting Point (RP);

FIG. 9 is an exemplary graph illustrating the method step of, for each item's Open Documents, at each Reporting Point (RP), computing the Buffer Consumption Ratio Difference (BCRD) between the Buffer Consumption Ratio (BCR) and the Planned Buffer Consumption Ratio (BCRP); and computing the Buffer Consumption Ratio Variance (BCRV) as the difference in BCRDs from one Reporting Point (RP) to the next Reporting Point (RP); and recording the Buffer Consumption Ratio (BCR_{FINISH}) as each item is completed;

FIGS. 10A and 10B are exemplary graphs illustrating the method step of, for each item managed, establishing the Maximum expected Reporting Interval (RIM) Demand (RID_{RIMax}) for each Reporting Interval (RI) of the Time-To-Reliably-Replenish (TRR); and establishing a graphical display of the Physical Buffer Patterns (PBP) based on accumulating the Maximum Reporting Interval (RIM) Demand (RID_{RIMax}) for each Reporting Interval (RI) throughout the TRR as viewed from the perspectives of Demand (PBDP), Issue (PBIP) and Replenish (PBRP); and establishing a numerical representation of the Maximum Reporting Interval (RIM) Demand (RID_{RIMax}) build up throughout the Time-To-Reliably-Replenish (TRR);

FIG. 11 is an exemplary graph illustrating the steps of, for each item, utilizing the numerical representation of the Maximum Reporting Interval (RIM) Demand (RID_{RIMax}) build up throughout the TRR, tracking the movement of the item's Open Documents at each Reporting Interval (RI), establishing the cumulative actual Reporting Interval Demand (RID_{RIM-RI}) for each Reporting Interval (RI) of the TRR, and, at each RI, computing the Physical Buffer Pattern Variance (PBPV_{RIM-RI}) between the cumulative actual Reporting Interval Demand (RID_{RIM-RI}) and the cumulative Maximum Reporting Interval (RIM) Demand (RID_{RIMax});

FIG. 12 is an exemplary graph illustrating the method steps of, for each item, recording the difference between the cumulative RID_{RIM-RI} and the corresponding RID_{RIMax}, identifying each occurrence wherein the cumulative RID_{RIM-RI} is greater than the corresponding RID_{RIMax}, maintaining an ongoing PBPV_{RIM-RI} record for all documents processed, and analyzing the PBPV_{RIM-RI} records to rank the PBPV_{RIM-RI} values according to the positive variance occurring in conjunction with (RID_{RIMax}+PBPV_{RIM-RI}) being greater than the Physical Buffer (PB), for increasing the size of the Physical Buffer Patterns (PB);

FIG. 13 is an exemplary graph illustrating the method steps of, for each item, recording the difference between the cumulative RID_{RIM-RI} and the corresponding RID_{RIMax}, identifying each occurrence wherein the cumulative RID_{RIM-RI} is greater than the corresponding RID_{RIMax}, maintaining an ongoing PBPV_{RIM-RI} record for all documents processed, and analyzing the PBPV_{RIM-RI} records to rank the PBPV_{RIM-RI} values according to the positive variance occurring in conjunction with (RID_{RIMax}+PBPV_{RIM-RI}) being less than the Physical Buffer (PB), for increasing the perimeter of the Physical Buffer Patterns (PBP) and in particular the Physical Buffer Demand Pattern (PBDP);

FIG. 14 is an exemplary graph illustrating the method steps of, for each item, recording the difference between the cumulative RID_{RIM-RI} and the corresponding RID_{RIMax}, identifying each occurrence wherein the cumulative RID_{RIM-RI} is less than the corresponding RID_{RIMax}, maintaining an ongoing PBPV_{RIM-RI} record for all documents processed, and analyzing the PBPV_{RIM-RI} records to rank the PBPV_{RIM-RI} values according to the negative variance occurring, for decreasing the perimeter of the Physical Buffer Patterns (PBP) and in particular the Physical Buffer Demand Pattern (PBDP);

FIG. 15 is an exemplary graph illustrating the method steps related to the analysis and computation of the Physical Buffer Factor (PBF) based on the ratio of the number of Reporting Interval Demands (RID) required to produce a total demand quantity that is greater than or equal to the selected RID_{RIMax-x}, which is used to create an adjustment in the BRP of an item's Open Documents when the computed PBF decreases below a user defined level;

FIG. 16 is an exemplary graph illustrating the method steps related to the analysis and computation of additional modifications to the Physical Buffer Factor (PBF) based on a user-defined Not-In-Stock Physical Buffer Factor (PBF_{NIS}), and a negative BCR value (PBF_{-BCR}) computed based on the quantity of a given item's Open Documents that are experiencing excessive delays while in work;

FIG. 17 is a block diagram of a computer network, in accordance with one embodiment of the invention, with which the method of the present invention can be implemented;

FIGS. 18A-18N are flow diagrams of the method of the present invention;

FIG. 19 is an exemplary graph that shows resources for use in particular Resource Group Names (RGN);

FIG. 20 is an exemplary graph that shows the configuration of the resources described in FIG. 19 arranged according to Work Center (WC);

FIG. 21 is an exemplary graph that illustrates the conversion of process step Time-Per-Unit (TPU) and Setup Time (SUT) to document process step Required Work Content (RWC) in Work Days (WDays) for the document quantity of the item as input to the document planning process in MANAGE;

FIGS. 22A-D are exemplary graphs showing data generated by the document planning process of MANAGE;

FIGS. 23 and 24 are exemplary graphs showing the processing steps implemented by Rough Cut Capacity Planning (RCCP) based on the data shown in FIG. 22A-D;

FIGS. 25A-B are exemplary graphs showing the processing steps implemented by Impact Capacity Planning (ICP) based on data shown in FIG. 22A-D;

FIGS. 26, 27A-B and 28A-C are exemplary graphs showing the processing steps implemented by Impact Capacity Planning (ICP) based on data shown in FIG. 22A-D; and

FIG. 29 is an exemplary graph showing Resource DRUM (RDRUM) planning after Demand DRUM (DDRUM) simulation and Resource Drum (RDRUM) setup minimization.

### BEST MODE FOR CARRYING OUT THE INVENTION

In order to facilitate understanding of the present invention, the ensuing description is divided into sections entitled “IMPROVE”, “MANAGE (Part A)”, “MANAGE (Part B)”, “PLAN” and “SCHEDULE”.

The “IMPROVE” section is directed to particular features and aspects of the present invention such as:
a) establishing global (Time Buffer) performance variance patterns;
b) establishing local (Allocated Time Buffer) performance variance patterns; and
c) focusing system improvements.

The “MANAGE” section is directed to particular features and aspects of the present invention such as:
a) planning documents (work orders) for items manufactured, repaired or ordered;
b) managing work flow using a single number to establish relative priorities;
c) establishing a planned start-date and a planned finish-date (i.e. delivery/due date) for each item's Open Documents or soon-to-be Open Documents; and
d) automatically adjusting work flow priorities based on specific conditions.

The “PLAN” section is directed to particular features and aspects of the present invention such as:
a) Rough Cut Capacity Planning (RCCP); and
b) Impact Capacity Planning (ICP).

The “SCHEDULE” section is directed to particular features and aspects of the present invention such as:
a) scheduling based on Impact Capacity Planning (ICP);
b) producing simulated global Time Buffer variance patterns and their corresponding local Allocated Time Buffer variance patterns;
c) selection of primary Resource DRUM (RDRUM);
d) scheduling primary Resource DRUM (RDRUM);
e) selection of secondary Resource DRUM (RDRUM); and
f) scheduling secondary Resource DRUM (RDRUM).

Due to the particular method of the present invention, and the manner in which it is described in the ensuing description, there are several sections of the ensuing description that are entitled “MANAGE” (e.g. MANAGE Part A, MANAGE Part B) and which are separated by the section entitled “IMPROVE”.

Commonly owned international patent application no. PCT/US2009/030163, filed Jan. 5, 2009, the disclosure of which application is hereby incorporated by reference, pertains to the analysis of inventory buffer consumption. In a preferred embodiment, the “MANAGE” portion of the method of the present invention utilizes the data generated by the method of the aforesaid international patent application no.: PCT/US2009/030163. However, it is to be understood that the “MANAGE” section may utilize comparable data generated by a method or technique other than what is disclosed in international patent application no.: PCT/US2009/030163. The aforesaid international patent application no.: PCT/US2009/030163 was published on Aug. 13, 2009 as International Publication No. WO 2009/099686 A1. The disclosure of International Publication No. WO 2009/099686 is hereby incorporated by reference.

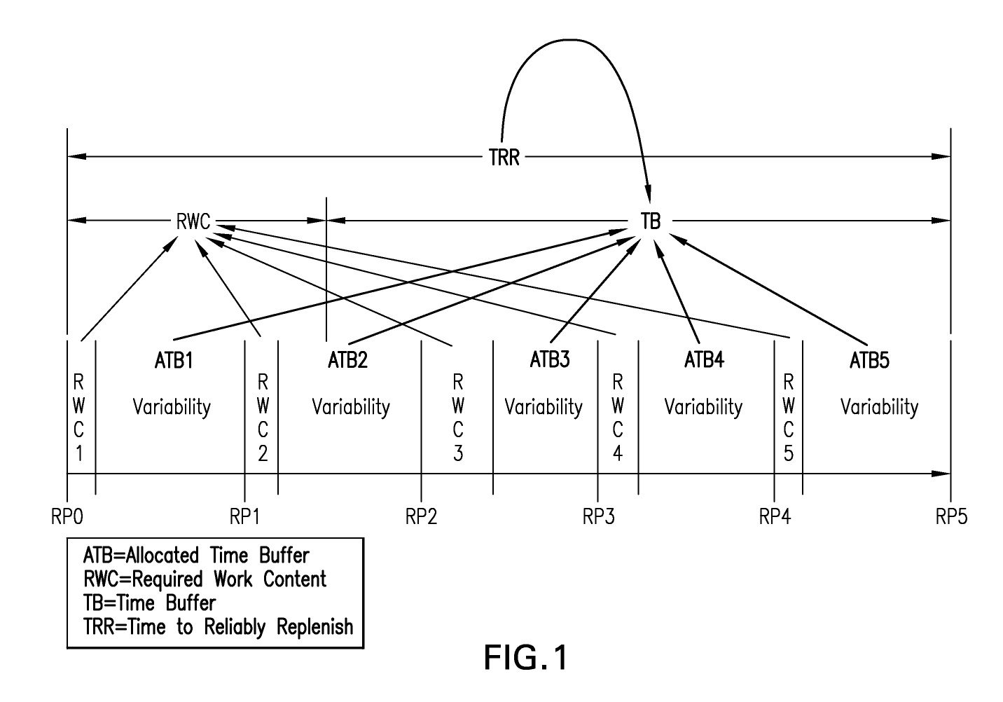

The ensuing description makes reference to FIGS. 1-29 of the drawings. The graphs and tables that are shown in the aforesaid drawings are exemplary and are presented to facilitate understanding of the invention.

Network, Computer System and Required Data

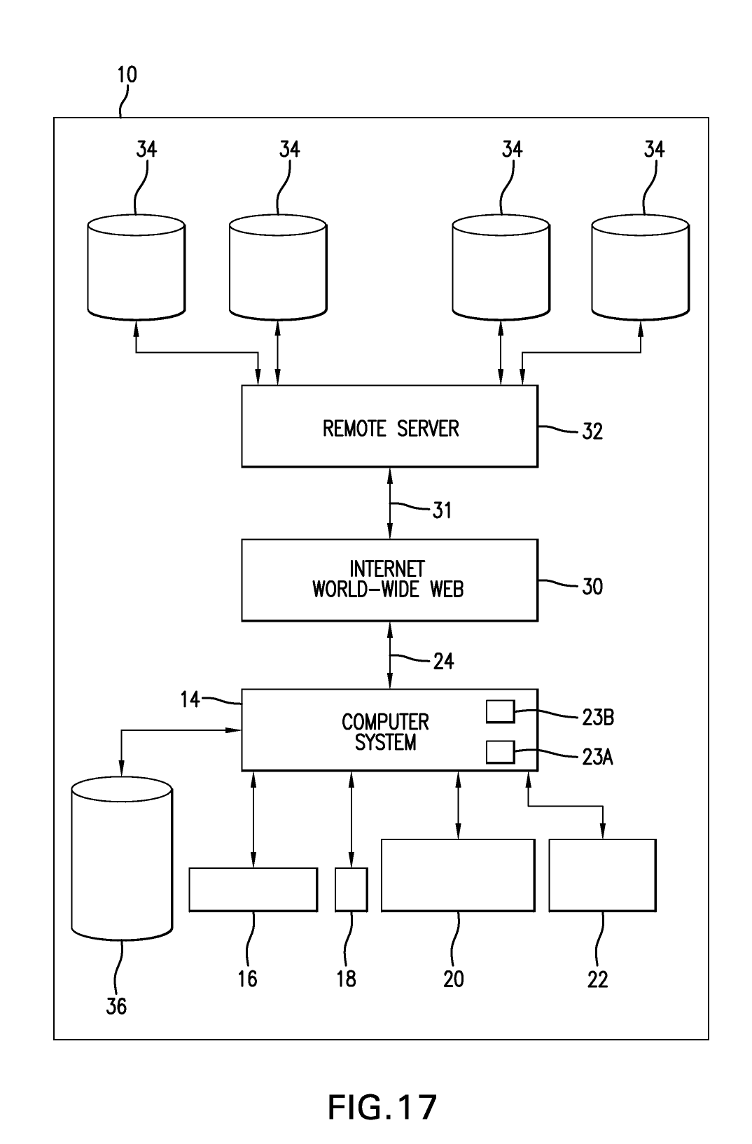

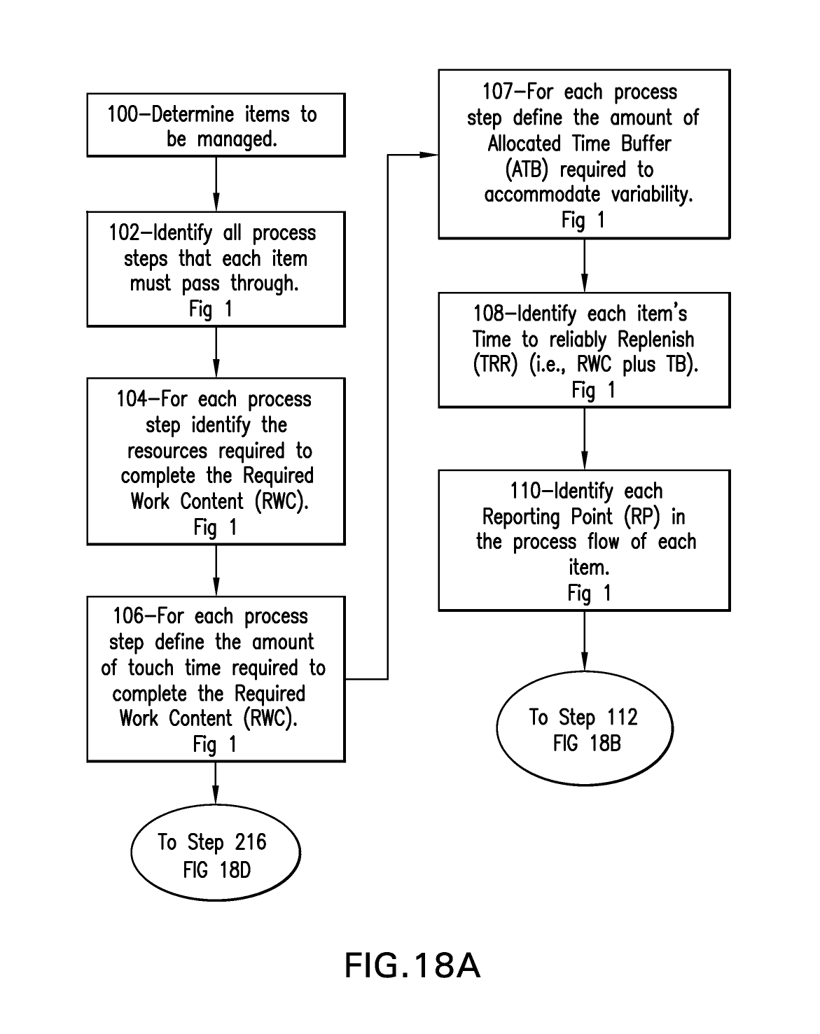

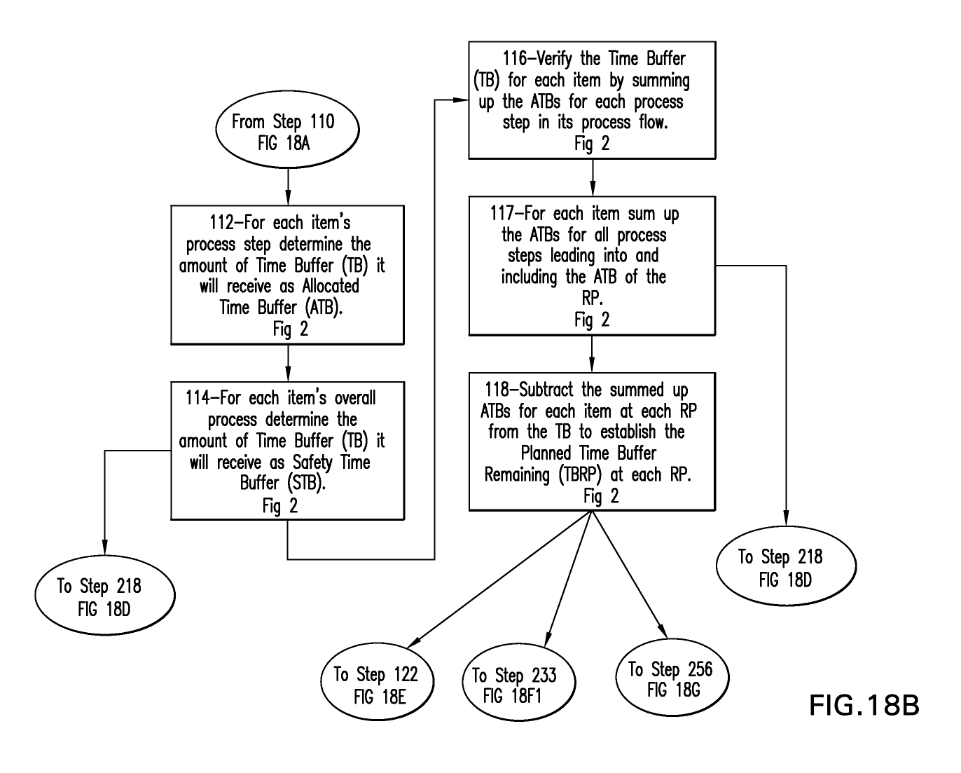

Referring to FIG. 17, there is shown network 10 that can be used to implement all embodiments of the method of the present invention. Network 10 comprises an end user computer system 14 having input devices such as keyboard 16, mouse 18, display device 20 and printing device 22. Computer system 14 can be configured as a personal computer, workstation, server system, and minicomputer or mainframe computer. Computer system 14 includes processor or CPU 23A and memory 23B. The processor 23A executes program instructions in order to carry out the functions of the present invention. The processor of computer system 14 is a microprocessor, such as an Intel Pentium® processor, but may also be a minicomputer or mainframe computer processor. Memory 23B stores program instructions that are executed by processor 23A. Memory 23B also stores data that is used and processed by processor 23A. Memory 23B may include electronic memory devices, such as random-access memory (RAM), read-only memory (ROM), programmable read-only memory (PROM), electrically erasable programmable read-only memory (EEPROM), flash memory, etc. and electromechanical memory, such as magnetic disk drives, tape drives, optical disk drives, etc. which may use an integrated drive electronics (IDE) interface, or enhanced IDE (EIDE), or ultra direct memory access (UDMA), or a small computer system interface (SCSI) based interface, or fast-SCSI, or wide SCSI, or fast and wide SCSI, etc., or a fiber channel-arbitrated loop (FC-AL) interface. Computer system 14 also includes input/output interfaces, and network adapters. Display device 20 can be configured as a display screen which can comprise an CRT or LCD monitor.

Computer system 14 is in electronic data communication with data link 24. Data link 24 can be configured as any type of medium capable of transmission of data signals. Thus, data link 24 can be configured as a dedicated land line, phone lines, broadband cable, etc. Data link 24 can also be configured as a wireless system such as a satellite uplink and down link system. Data link 24 is also in data communication with internet or world-wide-web 30. Network 10 includes data link 31 which is in data communication with internet 30. Data link 31 can have the same configuration as data link 24. Network 10 further includes remote server 32 that is in data communication with internet 30 via data link 31. Although one server 32 is shown, it is to be understood that more than one server can be utilized.

Network 10 further includes data bases 34. Each data base 34 stores transaction data that relates to a specific item that is in a predefined process flow. The specific item can be a part, component or product, or it can be particular step in an overall process, i.e. manufacturing process. The transaction data comprises data that is collected at regular Reporting Intervals (RI) at predetermined Reporting Points (RP). In a preferred embodiment, the specific item is monitored at each predetermined Reporting Point (RP) at regular Reporting Intervals (RI). Data base 34 also stores data that represents the planned movement of the specific item through the predefined process flow.

In a preferred embodiment, if the specific item is a part, component or product, data base 34 also stores data pertaining to demand requirements for that particular part, component or product. Such data includes requisition data such as the date the requisition is placed and completed, the time for the requisition to be completed if a part is issued from other than the shelf (a Not-In-Stock-Situation), or the time for the shelf to be replenished (i.e. Time To Reliably Replenish or TRR) if the part was issued from the shelf. The requisition data may also include component or part serial numbers, and project codes. The data bases 34 may include other data as well such as production, repair and/or maintenance history of all parts or components. As used herein, the terms “parts”, “components”, and “products” are used interchangeably and are collectively referred to herein as “item” or “items”.

Referring to FIG. 17, network 10 may also include data base 36 which is located on the same premises as computer system 14. Data base 36 may be configured to store the same data stored in data bases 34 and/or store any resulting analysis and data generated by the implementation of the method of the present invention on computer system 14.

All embodiments of the method of the present invention may be implemented with computer system 14, data bases 34 and data bases 36. However, it is to be understood that the algorithms and graphic displays presented herein are not inherently related to any particular computer or other apparatus. Various general-purpose systems may also be used with programs in accordance with the teachings herein, or it may be more convenient to construct more specialized apparatus to perform the required method steps. The required structure for a variety of these systems will appear from the description below. In addition, the present invention is not described with reference to any particular programming language. It is appreciated a variety of programming languages may be used to implement the teachings of the present invention as described herein.

Manage: Part A

The MANAGE portion of this embodiment of the present invention is directed to Time Buffer Management. In accordance with the invention, Time Buffer Management, as implemented by the method of the present invention, can be used in the following three areas: (a) day-to-day focus and decision making, (b) buffer trend analysis to resize current Time Buffers (TB) and Physical Buffers (PB), and (c) buffer trend analysis for the purpose of focusing improvement efforts.

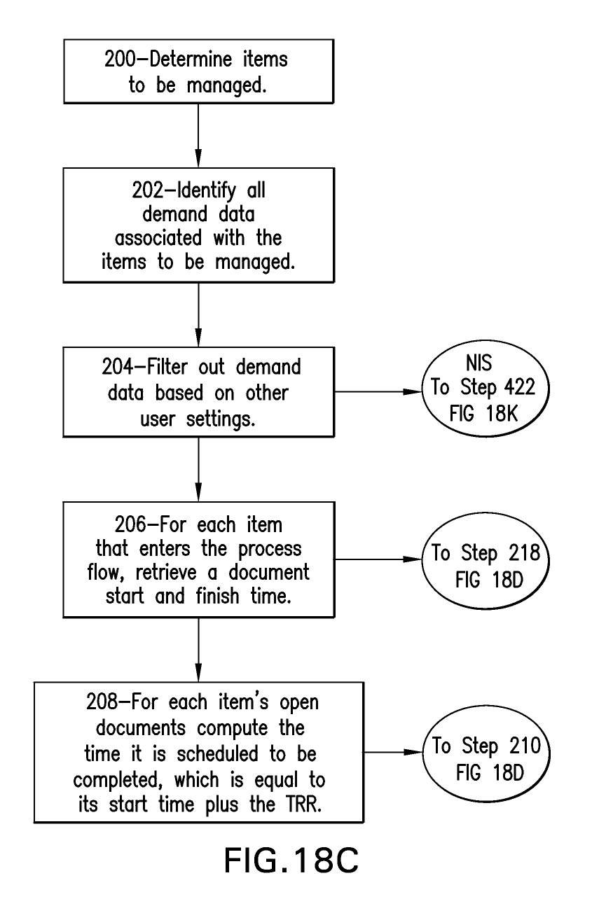

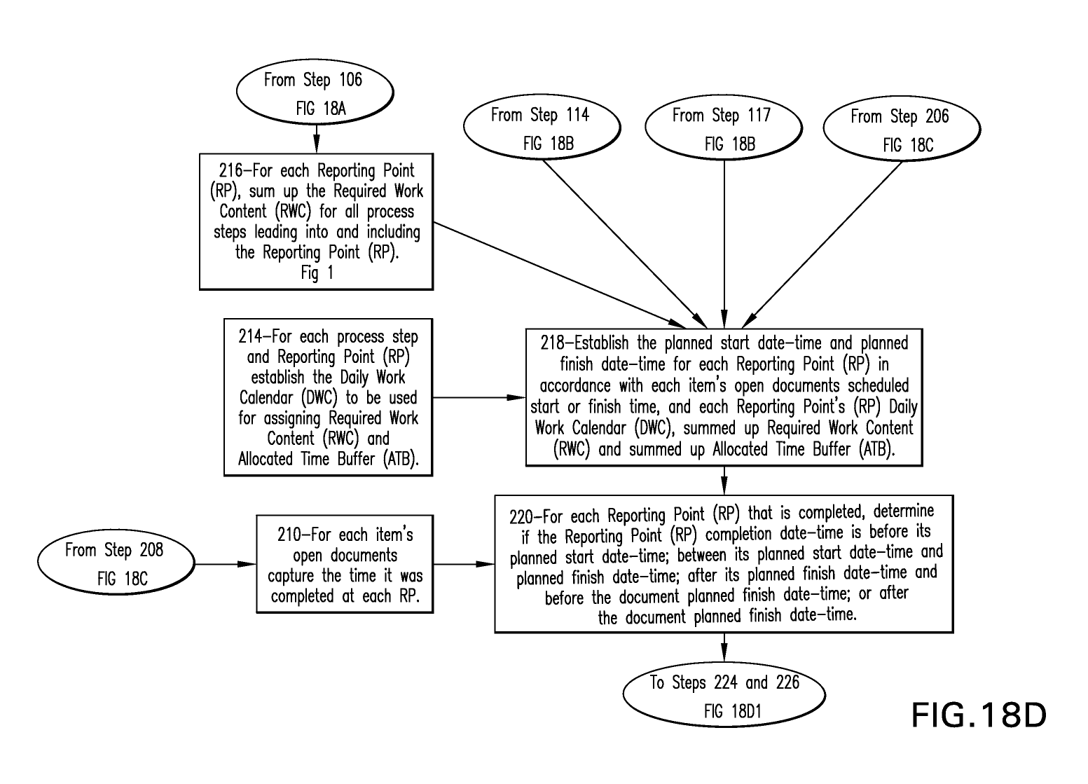

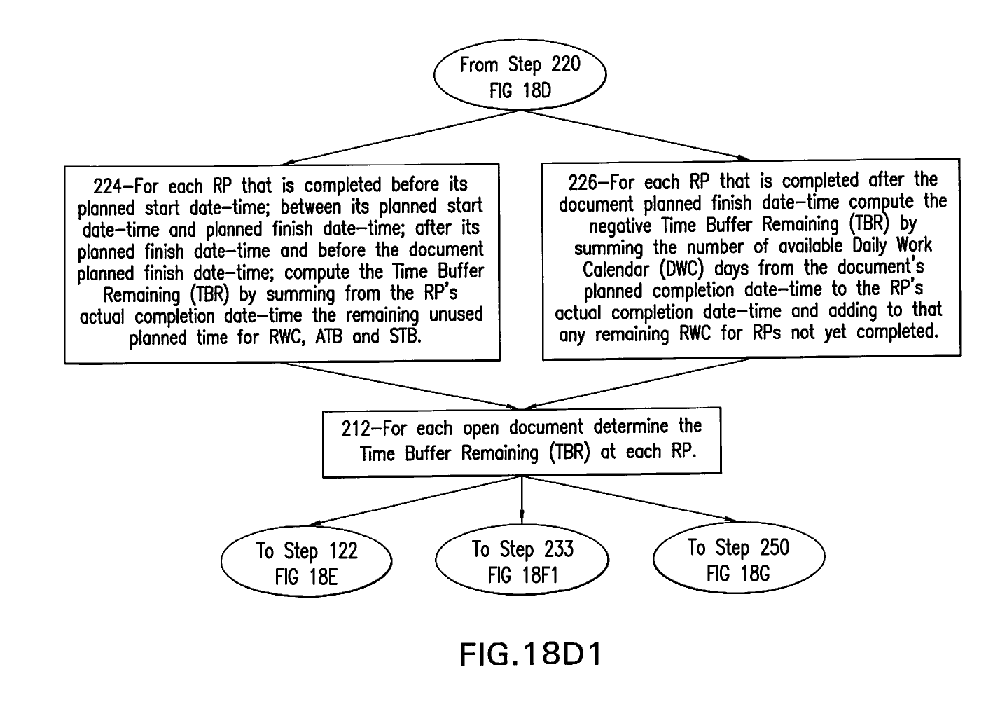

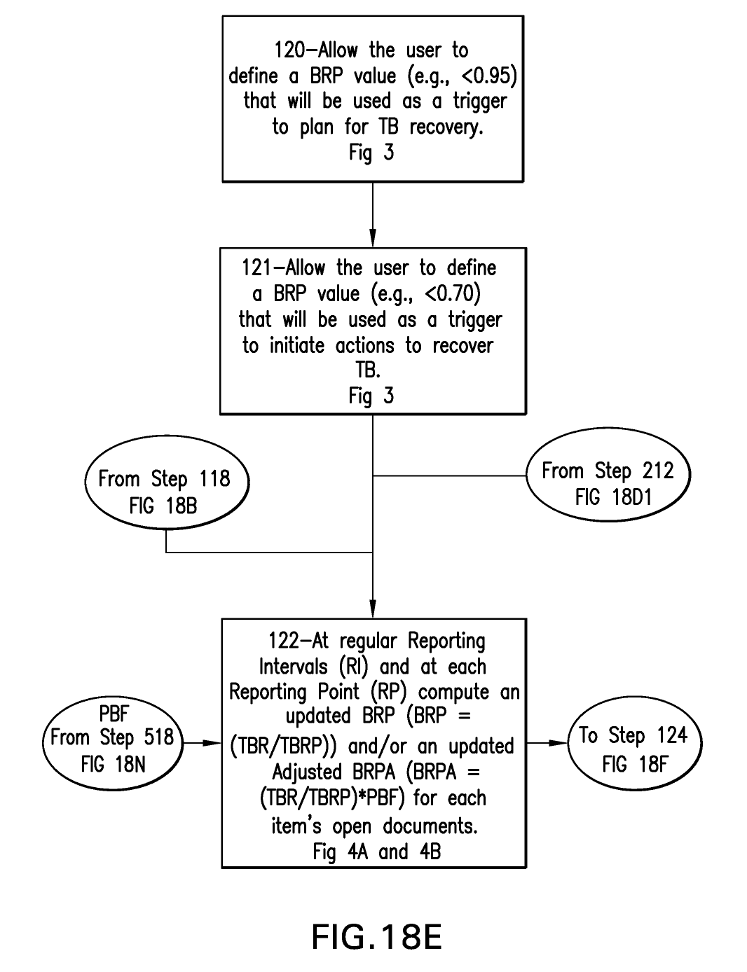

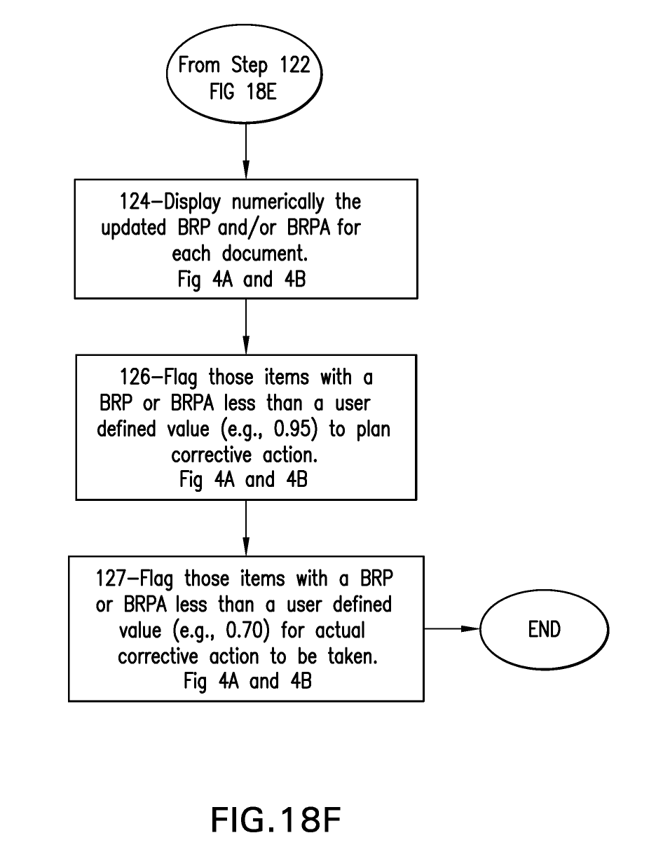

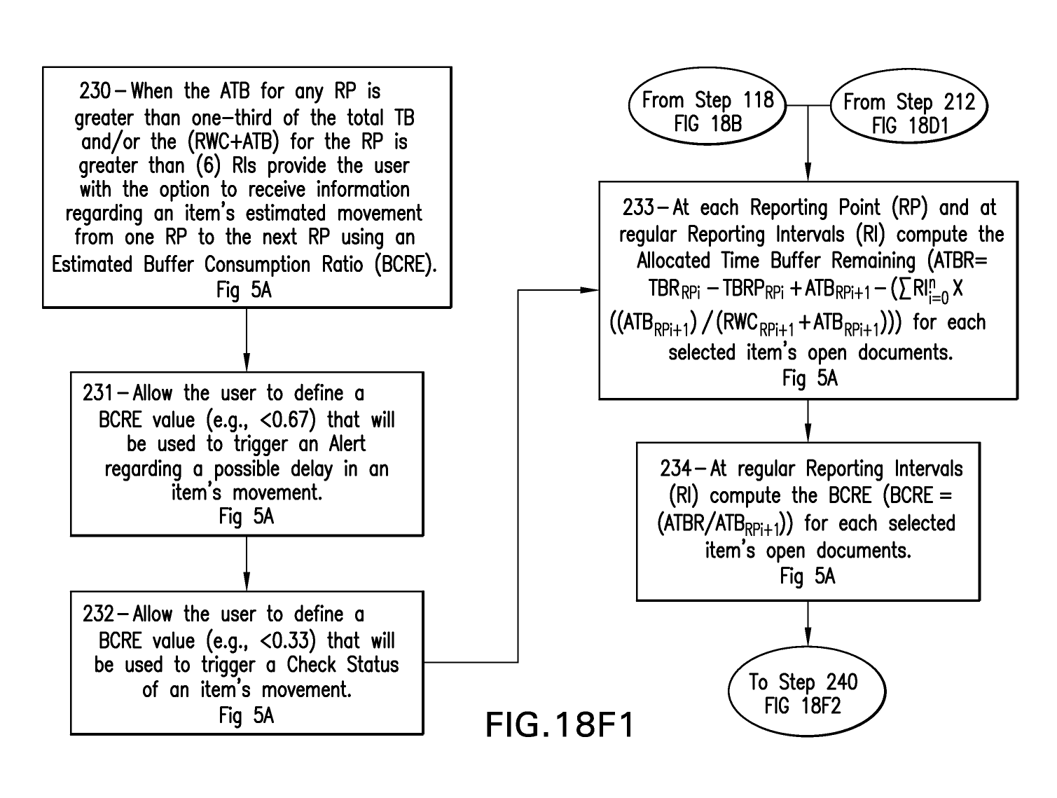

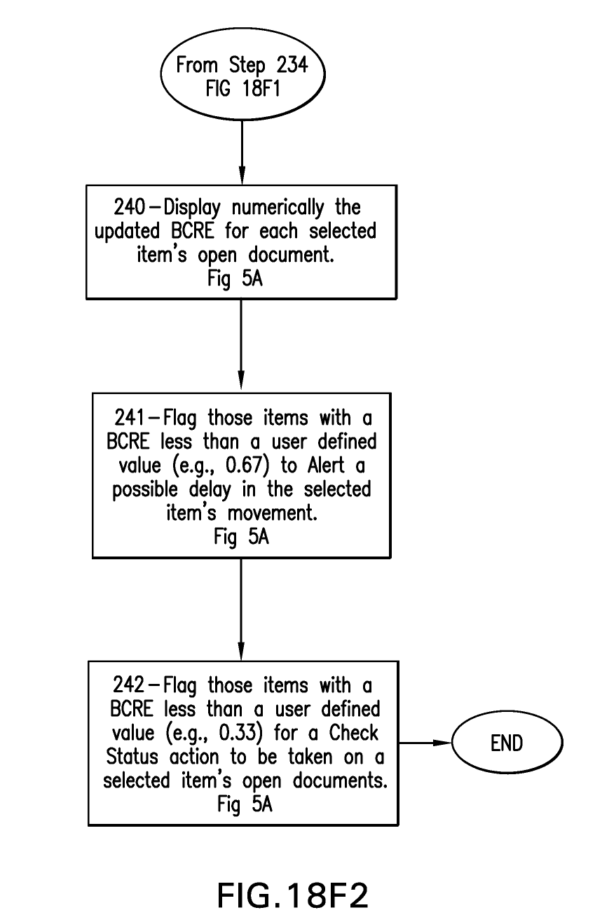

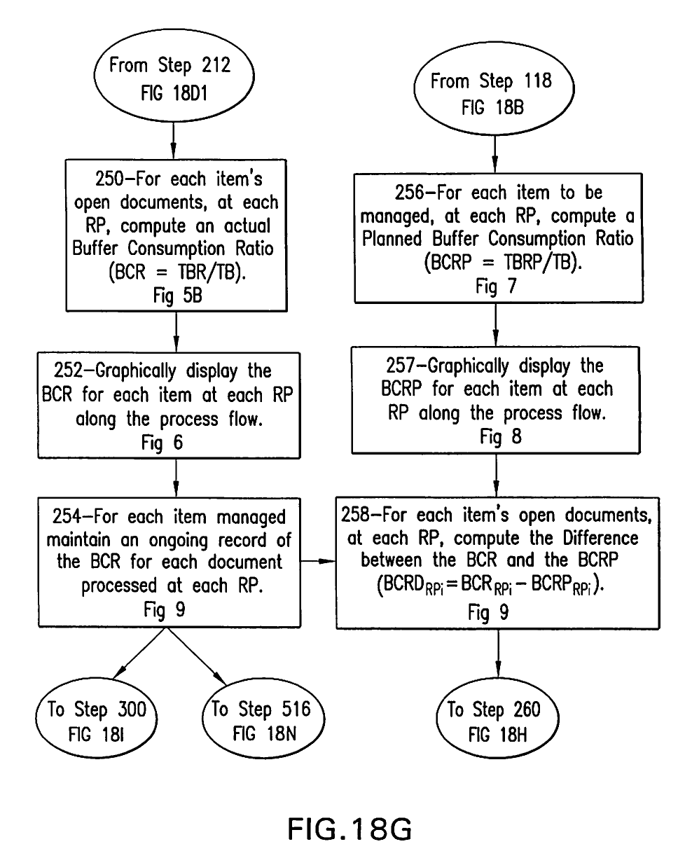

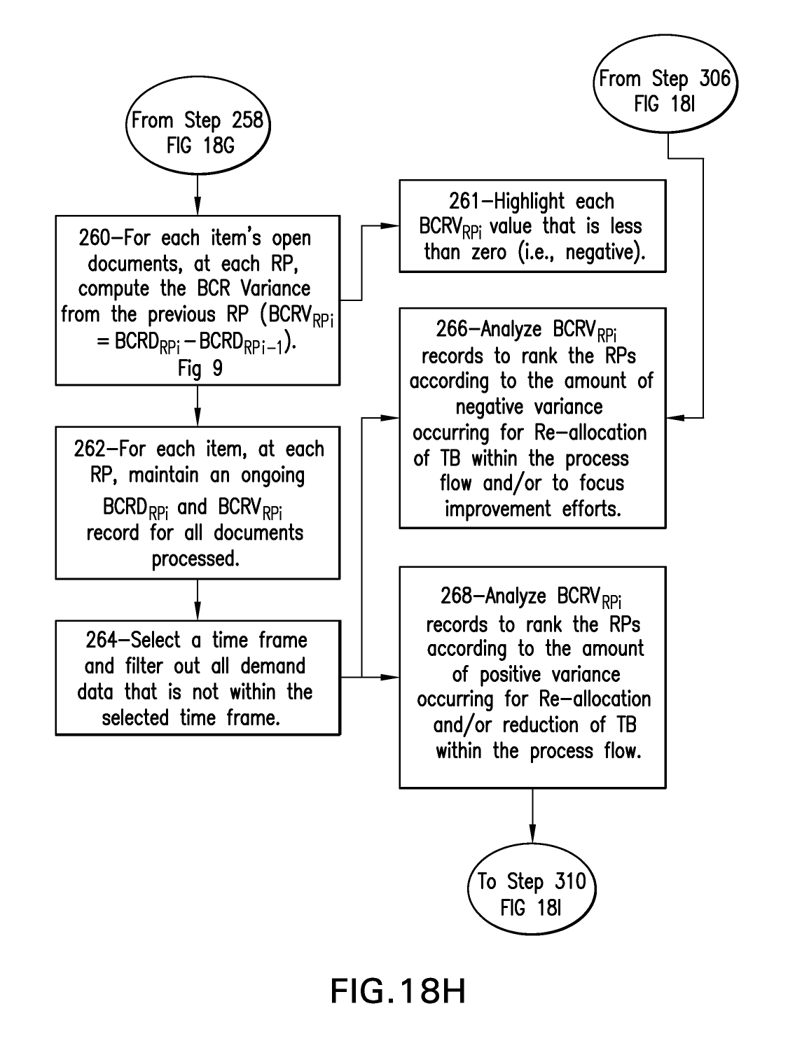

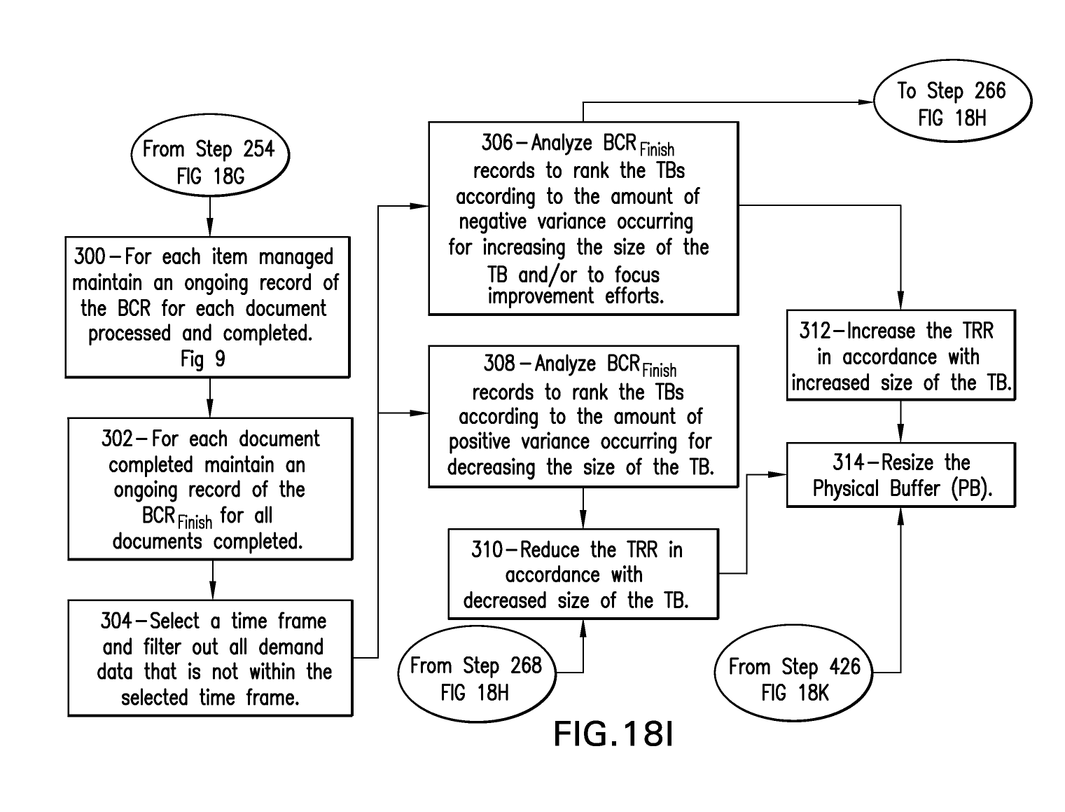

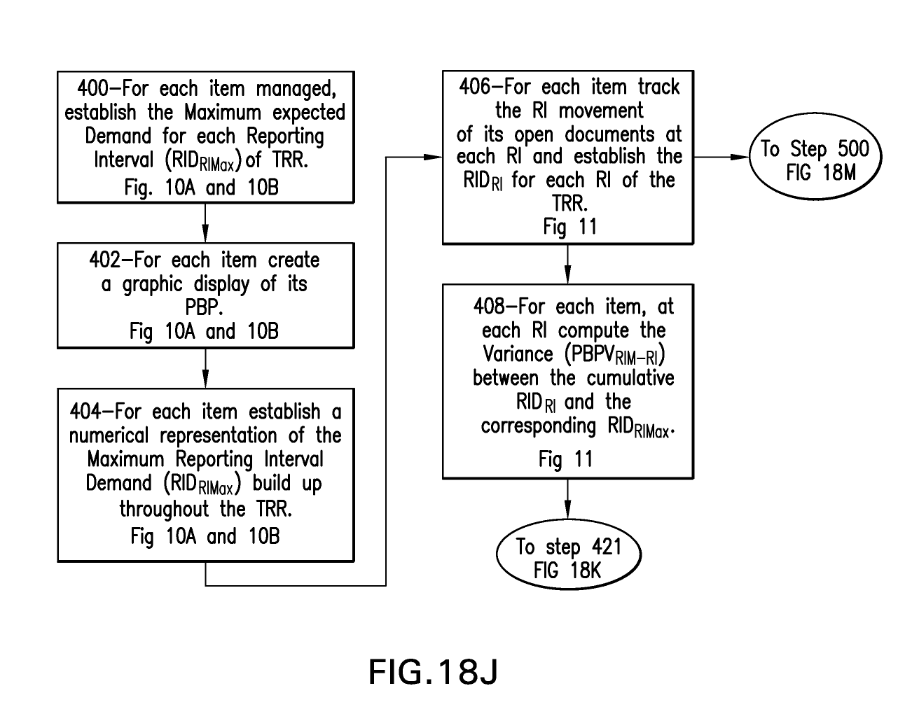

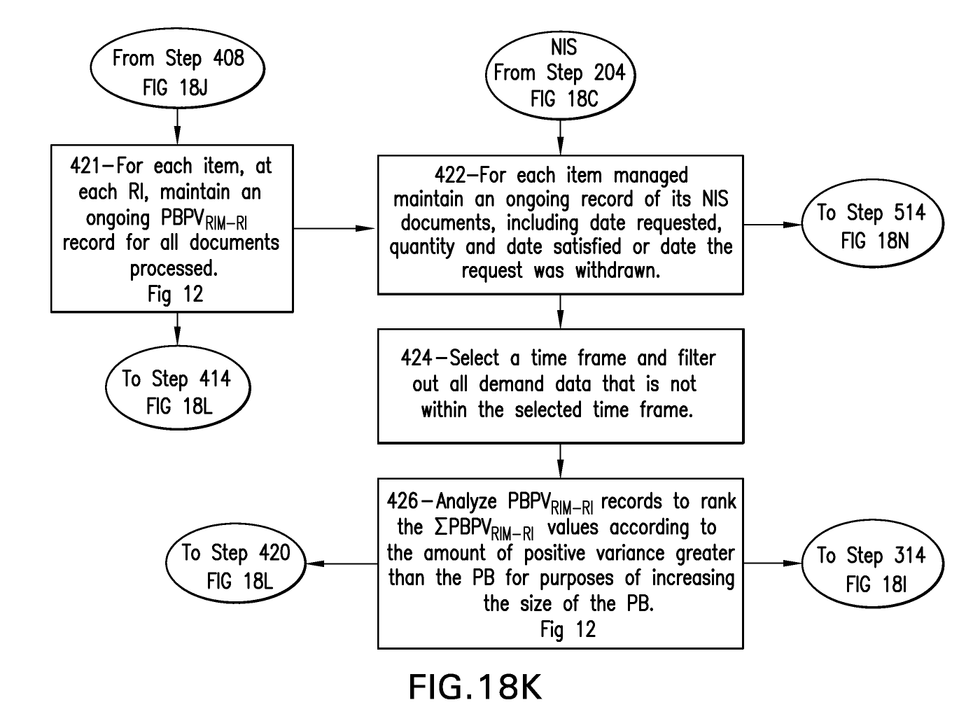

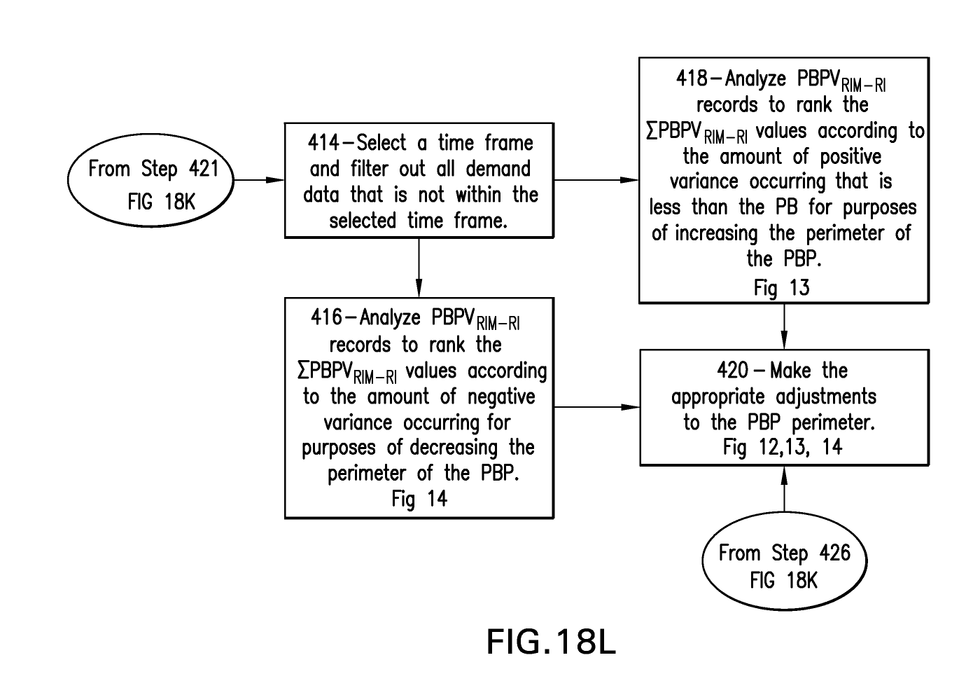

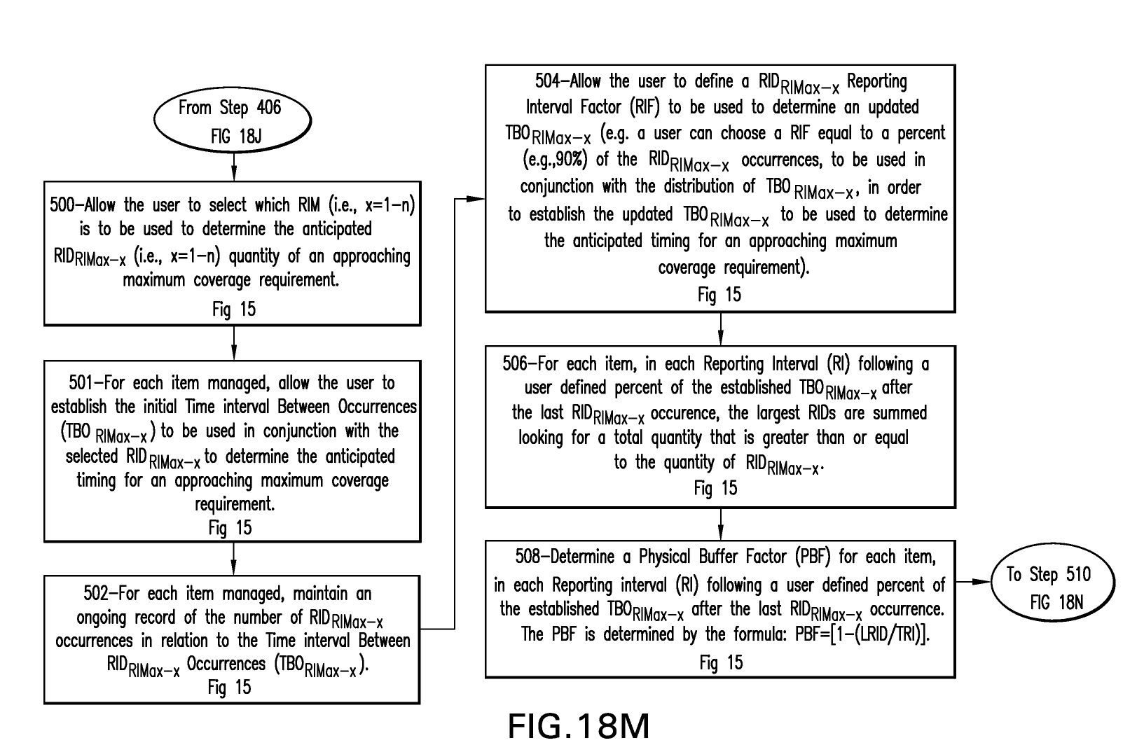

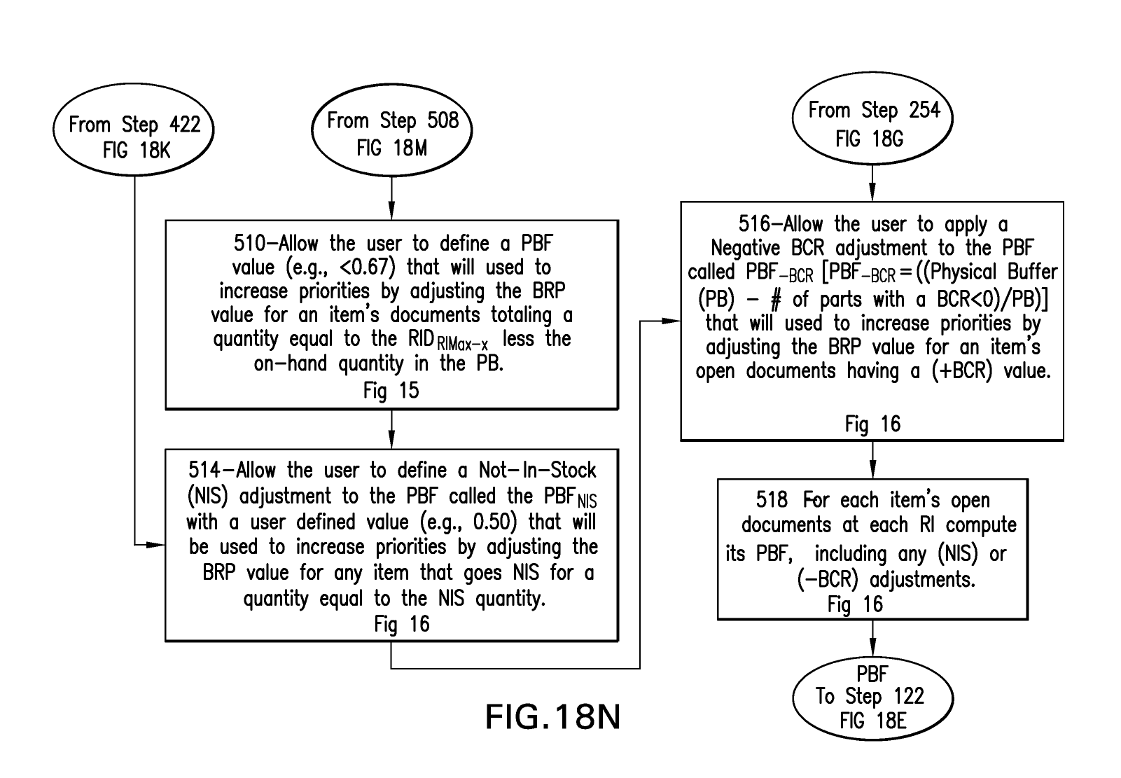

Referring to FIG. 18A, in one embodiment, step 100 is the first step of the method of the present invention. Step 100 entails determining, selecting or specifying the item that is to be reviewed or managed. The user inputs data representing the selected item into computer system 14 via keyboard 16 and/or mouse 18. This step also retrieves data from database 34 and/or database 36 which relates to the selected item. In this particular case, the data retrieved from database 34 and/or database 36 consists of transaction data that pertains to the selected item's movement through a predefined process flow. The predefined process flow can be an entire supply chain, manufacturing process, or a portion thereof, wherein an item (e.g. raw material, component, part, product, etc.) passes through a series of process steps to undergo some type of processing. The process step can be a physical step, such as machining raw material, or it can be a procedural-type step such as quality inspection and/or the application of serial numbers and codes or it can be transportation.

The term “Open Documents”, as used herein, is defined to be the real time history of the flow of the item through the predefined process flow.

The data retrieved from the databases 34 and 36 may also include “demand data” that relates to the selected item. The term “demand data” as used herein refers to all data that pertains to requisitions for the selected item between the supplier and the consumer. Typically, an item for which demand data is to be reviewed is an item that is subject to variable demand patterns and/or problems in establishing a reliable and/or desirable Time-to-Reliably-Replenish (TRR).

Referring to FIGS. 1 and 18A, step 102 identifies all process steps through which each selected item must pass. Each process step is a single step that is part of an overall process that produces or provides a processed item. Examples include machining pieces of raw material, conformal coating, painting, component assembly, transportation, etc.

Step 104 identifies the resources required to complete the Required Work Content (RWC). The RWC is the total required work needed to completely perform all process steps in the overall process.

Referring to FIGS. 1 and 18A, step 106 defines, for each process step, the amount of touch time required to complete the Required Work Content (RWC). Thus, this step defines the amount of touch time required to complete each step in the process. This step also computes the total touch time required to complete all process steps. This computed total time is therefore the total amount of touch time required to complete the RWC.

After step 106, the method then shifts to two portions of the method simultaneously. The first portion starts at step 107 and the second portion starts at step 216. The portion of the method starting with step 107 is discussed first and the portion of the method starting with step 216 is discussed later in the ensuing description.

Referring to FIGS. 1 and 18A, step 107 defines, for each process step, the amount of Allocated Time Buffer (ATB) required accounting for the variability associated with completing the Required Work Content (RWC). Thus, this step defines the amount of Allocated Time Buffer (ATB) required at each step in the process. This step also computes the total Time Buffer (TB) required to complete all process steps. This computed total time is therefore the total amount of Time Buffer (TB) required to account for the variability associated with completing the RWC. An example of a variability associated with completing the Required Work Content (RWC) is an unexpected delay in or additional time needed to complete a conformal coating process. In the example, the planned amount of time for completing the conformal coating process was two hours. However, the process used more coating material than expected and so the conformal coating machine had to be shut down for an hour in order to replenish it with the coating material. This is just one example and there are many more examples of variabilities.

Step 108 identifies each selected item's Time-To-Reliably Replenish (TRR). The TRR can be a known value, already stored in database 34 or database 36. In one embodiment, the TRR is computed using the method described in commonly owned U.S. Patent Application Publication No. 20060235734 entitled “Method and System for Determining Buffer Inventory Size”, the disclosure of which published application is hereby incorporated by reference. The method disclosed in U.S. Patent Application Publication Number 20060235734 is also described in International Application No. PCT/US2006/012895 which was published on Oct. 26, 2006 under International Publication No. WO 2006/113156. The entire disclosure of International Publication No. WO 2006/113156 is hereby incorporated by reference.

Referring to FIGS. 1 and 18A, step 110 identifies each Reporting Point (RP) in each selected item's predefined process flow. As shown in FIG. 1, there are multiple Reporting Points RP1, RP2, RP3, RP4, etc. In a preferred embodiment, transaction data, such as the transaction data retrieved in step 100, is based on data collected at the Reporting Points RP1, RP2, RP3, RP4, etc.

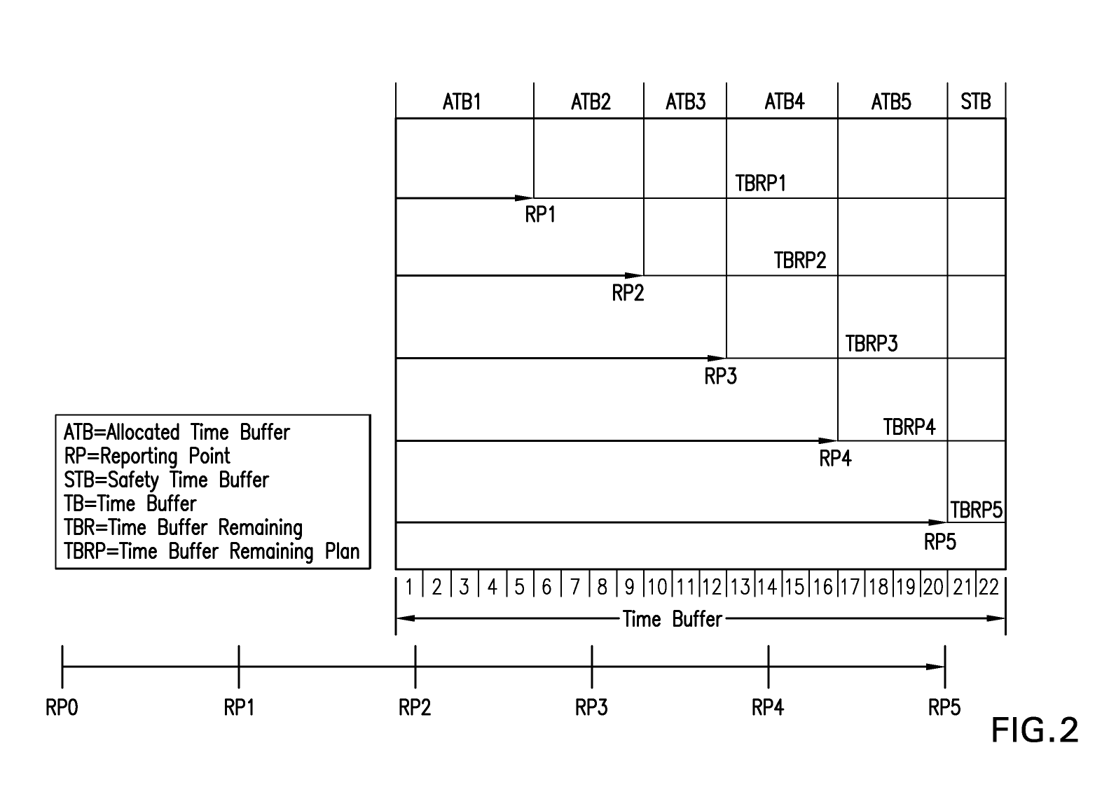

Referring to FIGS. 2 and 18B, the next step of the method is step 112. This step determines, for each process step through which the selected item moves, the amount of Time Buffer (TB) that the process step will receive as Allocated Time Buffer (ATB). Thus, theoretically, each process step should be completed within its Allocated Time Buffer (ATB).

Referring to FIGS. 2 and 18B, step 114 determines, for each selected item's overall process, the amount of Time Buffer (TB) it will receive as a Safety Time Buffer (STB). As an example, FIG. 2 shows an overall process having five (5) process steps and five (5) Reporting Points RP1, RP2, RP3, RP4 and R5. Each process step has an Allocated Time Buffer (ATB) assigned thereto. For example, the first process step has ATB1 which is five (5) units. The entire (5) process steps in total are allocated twenty (20) time units. The overall process is allocated a Safety Time Buffer (STB) of two (2) units. Therefore, the Time Buffer (TB) for the entire process is twenty two (22) units.

After step 114, the method then shifts to two portions of the method simultaneously. The first portion starts at step 116 and the second portion starts at step 218. The portion of the method starting with step 116 is discussed first and the portion of the method starting with step 218 is discussed later in an ensuing description.

Step 116 verifies the Time Buffer (TB) for a selected item's overall process by summing the Allocated Time Buffers (ATB) for each process step in the predefined process flow.

Step 117 effects a summation of all the ATBs for all process steps leading into and including the Reporting Point (RP).

After step 117, the method then shifts to two portions of the method simultaneously. The first portion starts at step 118 and the second portion starts at step 218. The portion of the method starting with step 118 is discussed first and the portion of the method starting with step 218 is discussed later in an ensuing description.

Step 118 determines the Planned Time Buffer Remaining (TBRP) at each Reporting Point (RP). This is accomplished, for each Reporting Point (RP), by subtracting the value representing the summation of the ATBs from each of the preceding Reporting Points (RP), which was determined in step 117, from the Time Buffer (TB) to establish the Planned Time Buffer Remaining (TBRP) at each Reporting Point (RP).

After step 118, the method then shifts to three portions of the method simultaneously. The first portion starts at step 122, the second portion starts at step 233, and the third portion starts at step 256. The portion of the method starting with step 122 is discussed first and the portions of the method starting with steps 233 and 256 are discussed at a later point in the ensuing description.

An important factor of Time Buffer Management resides in the monitoring of the movement of items in the “Time-Domain” concurrent with their movement through a predefined process flow. The process for monitoring an item's movement in the “Time-Domain” begins with steps 200-212 which are shown in FIGS. 18C, 18D and 18D1.

In step 200, it is determined which items are to be managed or reviewed. Thus, the user would enter some identifying data into computer system 14 via keyboard 16 that identifies a particular item to be managed.

Step 202 identifies all demand data associated with the selected items.

In step 204, the user inputs desired filter settings into computer system 14. In response, computer system 14 processes the demand data for the item in question and filters out demand data based on the user's filter settings. One function of step 204 is to segregate demand for stock replenishment actions from the demands made from stock at the wholesale, retail or local repair/production process level. In the event an item selected to be managed is Not-In-Stock (NIS), or has a history of NIS occurrences, the method shifts to another portion of the method that determines a Physical Buffer Factor (PBF) and re-sizes Physical Buffers (PB). Specifically, the information developed in steps 200, 202 and 204 is routed to step 422 which is part of the method to re-size the Physical Buffer (PB) and relates to the Physical Buffer Factor (PBF). The portion of the method of the present invention that relates to the Physical Buffer Factor (PBF) commences at step 500 (see FIG. 18M) and is described later in the ensuing description. The portions of the method of the present invention that relate to the re-sizing of Physical Buffers (PB) commence at step 300 (see FIG. 18I) and step 422 (see FIG. 18K) and are described later in the ensuing description.

Step 206 retrieves a document start and finish time for each item that enters the process flow.

After step 206, the method then shifts to two portions of the method simultaneously. The first portion starts at step 208 and the second portion starts at step 218. The portion of the method starting with step 208 is discussed first and the portion of the method starting with step 218 is discussed later in an ensuing description.

Step 208 computes, for each item's Open Documents, the amount of time within which it is scheduled to be completed. This amount of time is equal to the item's start time plus the TRR associated with that item. The TRR can be a known value previously generated by the method described in the aforementioned US Patent Application Publication 20060235734.

After step 208, the method continues with step 210 shown in FIG. 18D. In step 210, for each item's Open Documents, this step retrieves the time it was completed at each Reporting Point (RP).

In FIG. 18D and step 214, for each process step and Reporting Point (RP) a Daily Work Calendar (DWC) is established which is used for assigning Required Work Content (RWC) and Allocated Time Buffer (ATB).

Referring to FIGS. 1 and 18D, step 216 sums up for each Reporting Point (RP) the Required Work Content (RWC) for all process steps leading into and including the Reporting Point (RP). As described in the foregoing description, step 216 also receives data and information provided by step 106.

In FIG. 18D and step 218, the planned start date-time and planned finish date-time for each Reporting Point (RP) is established in accordance with each item's open documents scheduled start time or scheduled finish time, and each Reporting Point's (RP) Daily Work Calendar (DWC), summed up Required Work Content (RWC) and summed up Allocated Time Buffer (ATB). As described in the foregoing description, step 218 also receives data and information provided by steps 114, 117, 206, 214, and 216.

After step 218, the method continues with step 220 shown in FIG. 18D. In step 220, for each Reporting Point (RP) that is completed, the step determines if the Reporting Point (RP) completion date-time is before its planned start date-time, or between its planned start date-time and planned finish date-time, or after its planned finish date-time and before the document planned finish date-time, or after the document planned finish date-time. This step also receives the data and information provided by step 210.

After step 220, the method continues simultaneously with steps 224 and 226 which are shown in FIG. 18D1. In step 224, for each Reporting Point (RP) that is completed before its planned start date-time, between its planned start date-time and planned finish date-time, after its planned finish date-time and before the document planned finish date-time, the Time Buffer Remaining (TBR) is computed by summing from the Reporting Point (RP)'s actual completion date-time the remaining unused planned time for RWC, ATB and STB. In step 226, for each Reporting Point (RP) that is completed after the document planned finish date-time, the negative Time Buffer Remaining (TBR) is computed by summing the number of available Daily Work Calendar (DWC) days from the document's planned completion date-time to the Reporting Point (RP)'s actual completion date-time and adding to that any remaining RWC for Reporting Points (RPs) not yet completed.

Step 212 determines, for each item's Open Documents, the Time Buffer Remaining (TBR) at each Reporting Point (RP) from the information made available from steps 224 and 226.

After step 212, the method shifts to steps 122, 233 and 250 simultaneously. Step 122 is described in the ensuing description after the description of steps 120 and 121. Steps 233 and 250 are described in the ensuing description after the description of steps 120-127.

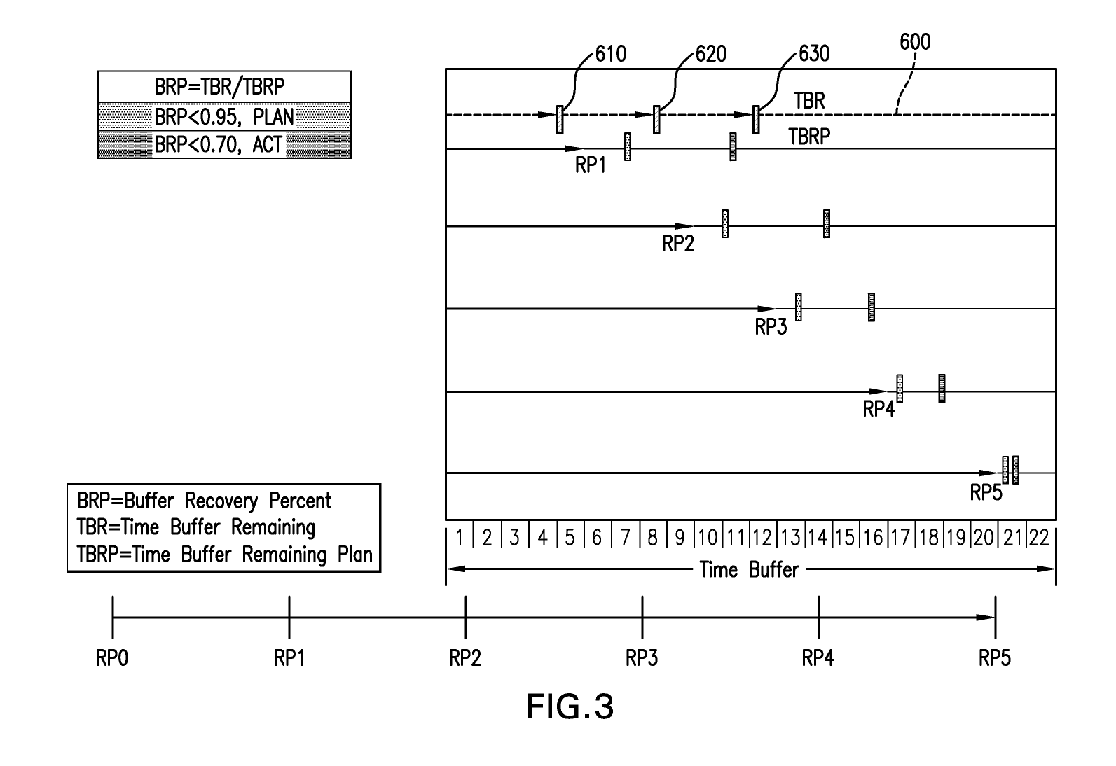

Referring to FIGS. 3 and 18E, step 120 allows the user to define a first Buffer Recovery Percent (BRP) value that is used as a trigger to initiate the plan to Recover Time Buffer (RTB). Step 121 allows the user to define a second Buffer Recovery Percent (BRP) value that is used as a trigger to initiate the actions to Recover Time Buffer (RTB). The user inputs the user-defined first and second BRP values into computer system 14 via keyboard 16. The actual Buffer Recovery Percent (BRP) is computed by the formula

BRP=TBR/TBRP,

wherein TBR is the actual Time Buffer Remaining and TBRP is the Planned Time Buffer Remaining. FIGS. 3 and 18E shows an example wherein the first user-defined BRP value is less than 0.95 but greater than 0.70, and the second user defined BRP value is less than 0.70. In FIG. 3, dotted line 600 represents the Time Buffer Remaining (TBR) when RP1 actually reported in as being complete. Rectangles 610, 620 and 630 represent three different examples of the amount of Time Buffer Remaining (TBR). Rectangle 610 shows that the amount of TBR remaining is greater than the Planned Time Buffer Remaining (TBRP) which would produce a BRP value greater than 1.0. Rectangle 620 shows the amount of Time Buffer Remaining (TBR) to be less than Planned Time Buffer Remaining (TBRP) and would yield a BRP value less than 0.95, but not less than 0.70. Rectangle 630 shows the Time Buffer Remaining (TBR) is much less than Planned Time Buffer Remaining (TBRP) which would yield a BRP value less than 0.70.

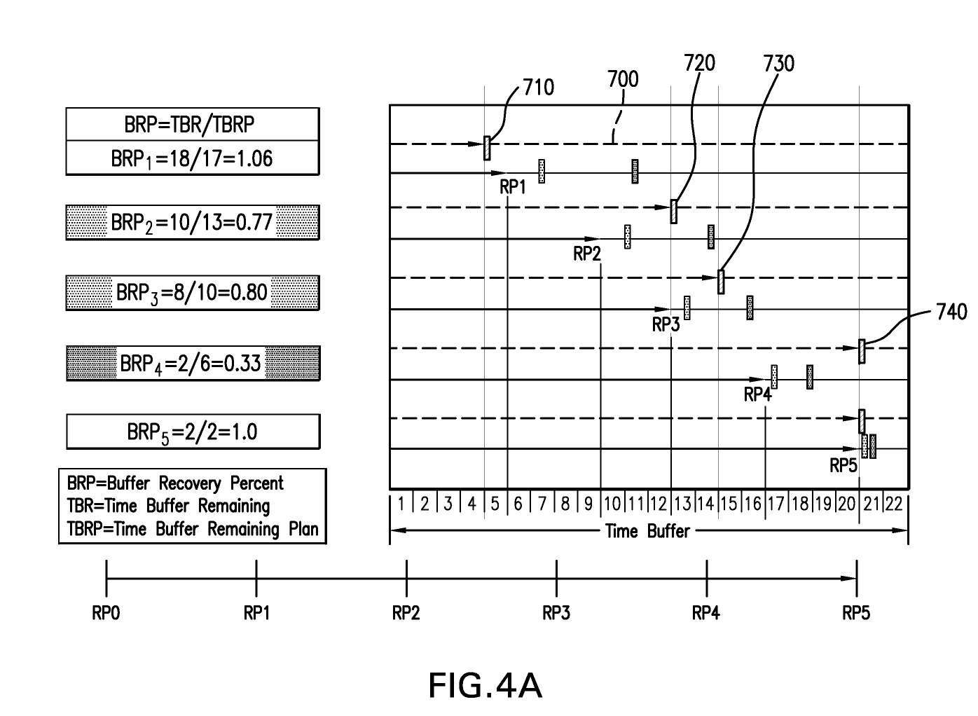

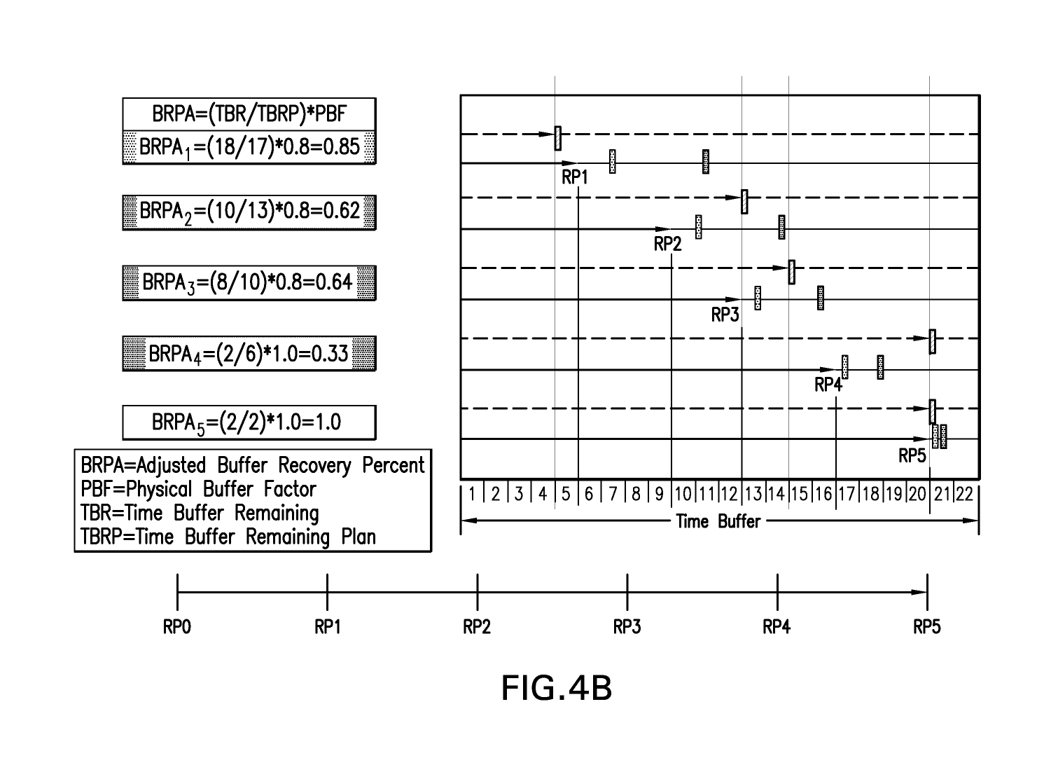

In step 122, an updated Buffer Recovery Percent (BRP) and/or an updated Adjusted Buffer Recovery Percent (BRPA) is computed at regular Reporting Intervals (RI) and at each Reporting Point (RP) for each selected item's Open Documents. The term “Open Documents”, as used herein, is defined to be the real time history of the flow of the item through the predefined process flow. An example of this step is shown in FIGS. 4A and 4B. As described in the foregoing description, step 122 also receives data and information provided by steps 118 and 212. Step 122 also receives Physical Buffer Factor (PBF) information and data provided by step 518 which is described later in the ensuing description. The updated Buffer Recovery Percent (BRP) and the updated Adjusted Buffer Recovery Percent (BRPA) are computed by the following formulae:

BRP=(TBR/TBRP), and

BRPA=(TBR/TBRP)*PBF

wherein the symbol * denotes multiplication.

Referring to FIG. 18F, in step 124, the updated Buffer Recovery Percent (BRP) and/or the updated Adjusted Buffer Recovery Percent (BRPA) for each Open Document is displayed numerically on display device 20.

Step 126 flags those items with a computed Buffer Recovery Percent (BRP) or a computed Adjusted Buffer Recovery Percent (BRPA) that is less than the first user predefined BRP value (e.g., 0.95) to initiate the planning of corrective action to Recover Time Buffer (RTB). Step 127 flags those items with a computed BRP or a computed BRPA that is less than the second user defined BRP value (e.g., 0.70) so that actual corrective action can be taken to Recover Time Buffer (RTB). Examples of this step are shown in FIG. 4A. Dotted line 700 represents the Time Buffer Remaining (TBR) when RP1 actually reported in as complete. Rectangle 710 corresponds to when RP1 actually reported in as complete resulting in the Time Buffer Remaining (TBR) being greater than planned (TBRP) (i.e. 22−4=18) versus (22−5=17) and a BRP₁=1.06. Since 1.06 is greater than 0.95, this BRP₁ value is not flagged for planned corrective action or actual corrective action. Rectangle 720 identifies the time buffer consumed when RP2 was reported to be complete is twelve (12) and the corresponding Time Buffer Remaining (TBR) is ten (10) (i.e. 22−12=10). The Planned value for the Time Buffer Remaining (TBRP) at the reported completion of RP2 was thirteen (13) (i.e. 22−9=13) and therefore, BRP₂=10/13=0.77. Thus, the selected item having the Buffer Recovery Percent BRP₂=0.77 is flagged to plan corrective action to Recover Time Buffer (RTB). Rectangle 730 identifies the time buffer consumed when RP3 was reported to be complete as being fourteen (14) and the corresponding Time Buffer Remaining (TBR) is eight (8) (i.e. 22−14=8). The Planned value for the Time Buffer Remaining (TBRP) at the reported completion of RP3 was ten (10) (i.e. 22−12=10) and therefore, BRP₃=8/10=0.80 which is less than 0.95, but not less than 0.70. Thus, the selected item having a BRP₃=0.80 will be flagged for planned corrective action to Recover Time Buffer (RTB). Rectangle 740 identifies the time consumed when RP4 was reported to be complete as being twenty (20) and the corresponding Time Buffer Remaining (TBR) is two (2) (i.e. 22−20=2). The Planned value for the Time Buffer Remaining (TBRP) at the reported completion of RP4 was six (6) (i.e. 22−16=6) and therefore, BRP₄=2/6=0.33 which is less than 0.70. Therefore, the selected item having a BRP₄=0.33 is flagged for actual corrective action to Recover Time Buffer (RTB). The selected item having BRP₅=1.0 is not flagged for any planning of corrective action or actual corrective action since the BRP value is greater than the first user defined BRP value of 0.95.

In FIG. 4B, the TBR and TBRP values are the same as those used in FIG. 4A. Instead of computing the BRP value, an adjusted BRP value (BRPA) is now being computed. The BRPA value is the BRP value multiplied by a Physical Buffer Factor (PBF) to lower the BRP value and increase the priorities at certain times and at certain Reporting Points (RP). As shown in FIG. 4B, the selected item having the Adjusted Buffer Recovery Percent BRPA₁=0.85 is flagged to plan corrective action to Recover Time Buffer (RTB). The selected item having the Adjusted Buffer Recovery Percent BRPA₂=0.62 and the selected item having the Adjusted Buffer Recovery Percent BRPA₃=0.64 and the selected item having the Adjusted Buffer Recovery Percent BRPA₄=0.33 are all flagged for actual corrective action to Recover Time Buffer (RTB). The selected item having BRP₅=1.0 is not flagged for any planning of corrective action or actual corrective action since the BRP value is greater than the first user defined BRP value of 0.95. The portion of the method of the present invention that relates to BRP or BRPA ends at step 127. Step 230, as will now be described, commences the portion of the method of the present invention that relates to Estimated Buffer Consumption Ratio (BCRE).

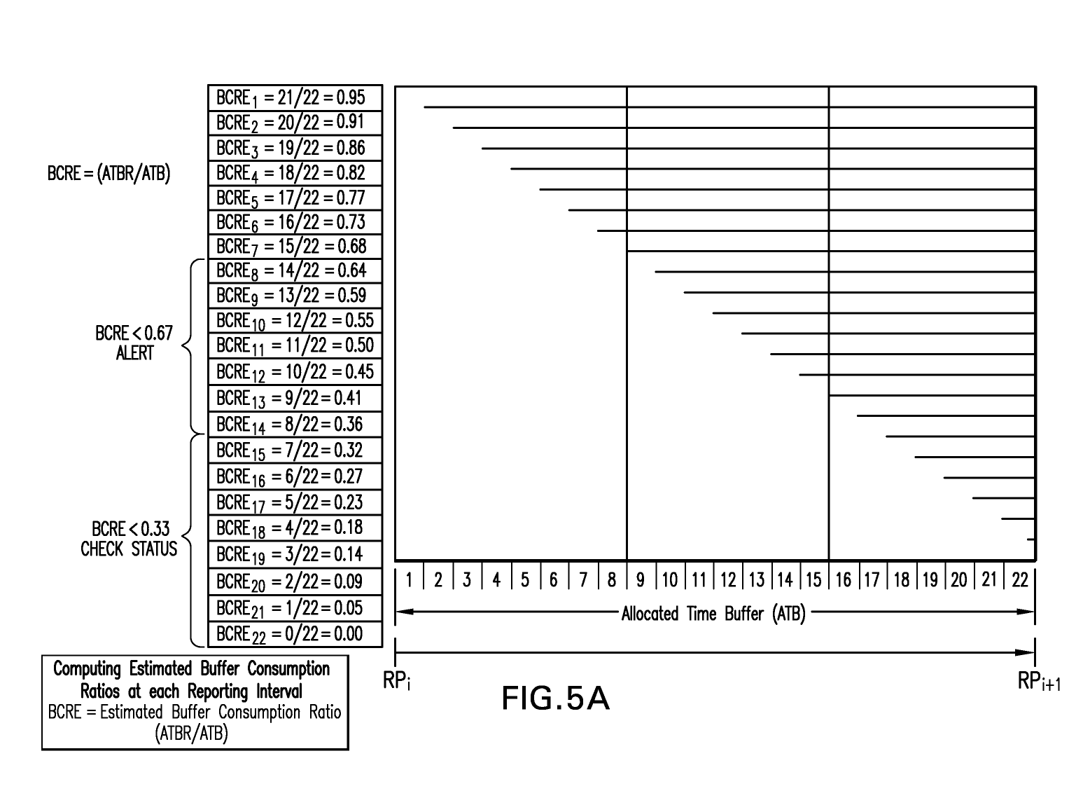

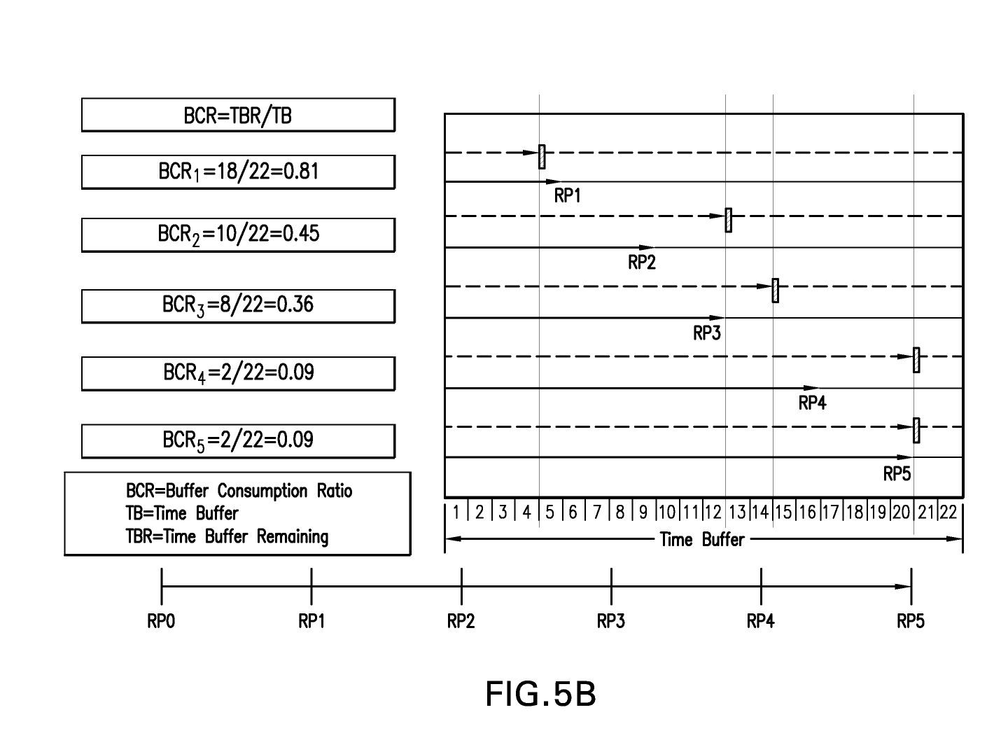

Referring to FIGS. 5A and 18F1, step 230 provides the user with the option to receive information regarding an item's estimated movement between two Reporting Points (RP) using an Estimated Buffer Consumption Ratio (BCRE) whenever the ATB for any RP is greater than one-third of the total TB and/or the (RWC+ATB) for the RP is greater than six (6) Reporting Intervals (RIs). Step 231 allows the user to define a first Estimated Buffer Consumption Ratio (BCRE) value that is used to trigger an “Alert” to a possible delay in an item's movement from one Reporting Point (RPᵢ) to the next Reporting Point (RPᵢ₊₁). Step 232 allows the user to define a second Estimated Buffer Consumption Ratio (BCRE) value that is used as a trigger to “Check Status” of an item's movement from one Reporting Point (RPᵢ) to the next Reporting Point (RPᵢ₊₁).

In step 233, the Allocated Time Buffer Remaining (ATBR) is computed at each Reporting Point (RP) and at regular Reporting Intervals (RI) between Reporting Points (RP) for each selected item's Open Documents. The term “Open Documents”, as used herein, is defined to be the real time history of the flow of the item through the predefined process flow. As described in the foregoing description, step 233 also receives data and information provided by steps 118 and 212. In step 234, the Estimated Buffer Consumption Ratio (BCRE) is computed at regular Reporting Intervals (RI) between Reporting Points (RP) for each selected item's Open Documents. The user inputs the user defined first and second BCRE values into computer system 14 via keyboard 16. The Estimated Buffer Consumption Ratio (BCRE) is computed at each Reporting Interval (RI) by the formula:

BCRE=ATBR/ATB_{RPi+1}, and

ATBR=TBR_{RPi}−TBRP_{RPi}+ATB_{RPi+1}−(ΣRIⁿᵢ₌₀X((ATB_{RPi+1})/(RWC_{RPi+1}+ATB_{RPi+1}))), and

n=the number of Reporting Intervals (RI) after RPᵢ reported complete

wherein the ATBR is incrementally reduced at each Reporting Interval (RI) by an amount of time equal to (ΣRIⁿᵢ₌₀X ((ATB_{RPi+1})/(RWC_{RPi+1}+ATB_{RPi+1}))). FIGS. 5A and 18F1 shows an example wherein the first user defined BCRE value is less than the 0.67 but greater than 0.33, and the second user defined BRP value is less than 0.33.

Referring to FIG. 18F2, in step 240, the Estimated Buffer Consumption Ratio (BCRE) for each selected item's Open Document is displayed numerically on display device 20.

Step 241 flags those items with a computed BCRE that is less than the first user predefined BCRE value (e.g., 0.67) to “Alert” a possible delay in item movement. Step 242 flags those items with a computed BCRE that is less than the second user defined BRP value (e.g., 0.33) so that action can be taken to Check Status of the item's movement. As shown in FIG. 5A, the selected items having BCRE values less than 0.67 are flagged with an Alert and those items having BCRE values less than 0.33 are flagged with a Check Status.

Step 250, as will now be described, commences the IMPROVE portion of the method of the present invention that relates to actual Buffer Consumption Ratio (BCR).

Improve

Referring to FIGS. 5B and 18G, step 250 computes, for each item's Open Documents and at each Reporting Point (RP), an actual Buffer Consumption Ratio (BCR). The BCR is computed in accordance with the formula:

BCR=TBR/TB.

The Buffer Consumption Ratio (BCR) uses the same information related to the Time Buffer Remaining (TBR) when each Reporting Point (RP) is reported in as complete and then divides it by the total Time Buffer (TB) instead of the amount of Planned Time Buffer Remaining (TBRP). Exemplary results of step 250 are illustrated in FIG. 5B.

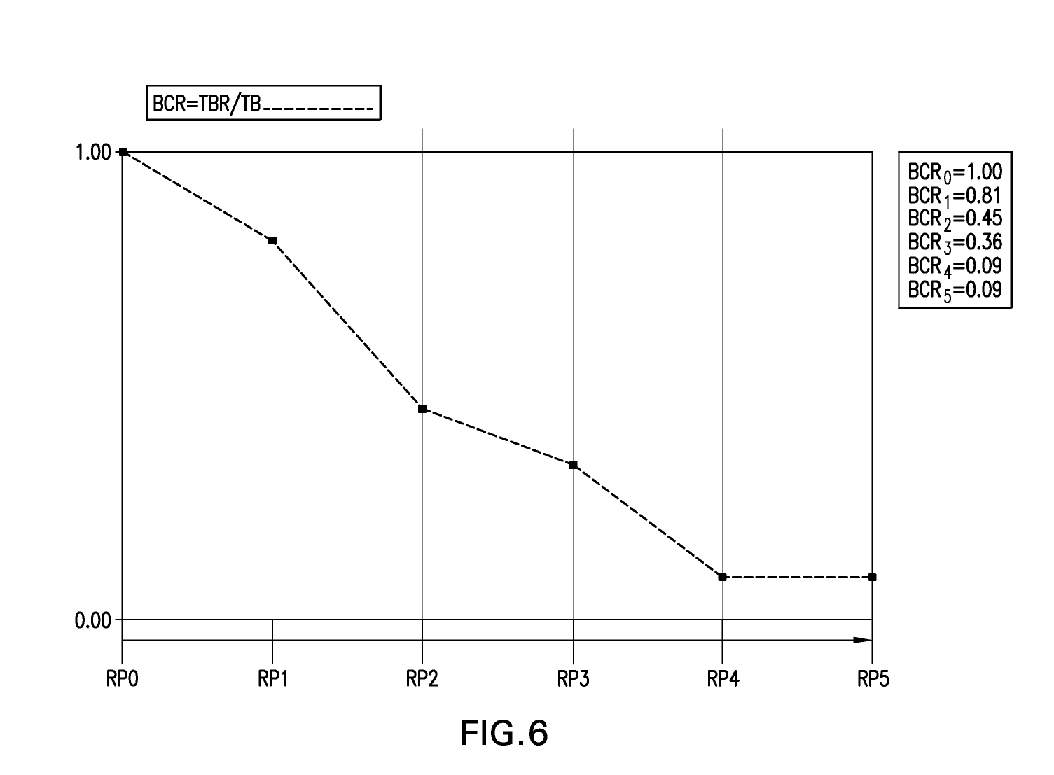

Step 252 graphically displays the Buffer Consumption Ratio (BCR) for each item at each Reporting Point (RP) along the predefined process flow. In this step, the BCR is displayed on display device 20. An example of the implementation of this step is shown in FIG. 6.

Step 254 maintains, for each item managed, an ongoing record of the Buffer Consumption Ratio (BCR) for each document processed at each Reporting Point (RP). After step 254, the method shifts simultaneously to steps 300 and 516. Steps 300 and 516 are discussed later in the ensuing description.

As described in the foregoing description, step 256 receives data and information provided by step 118. In step 256, for each item to be managed and at each Reporting Point (RP) associated with that item, a Planned Buffer Consumption Ratio (BCRP) is computed. The BCRP is found by the formula:

BCRP=TBRP/TB.

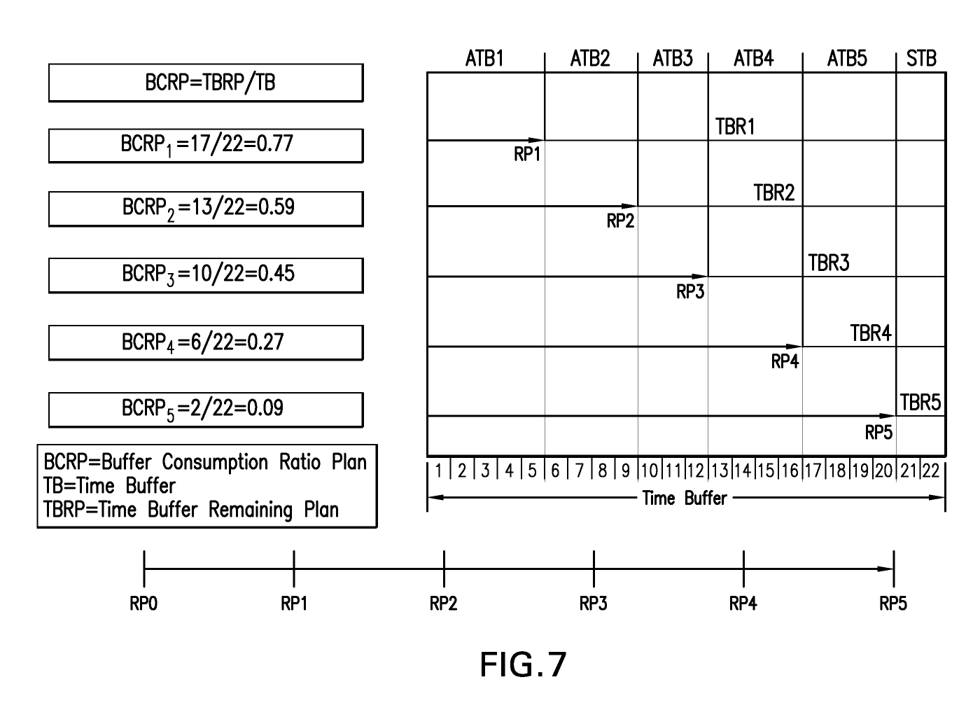

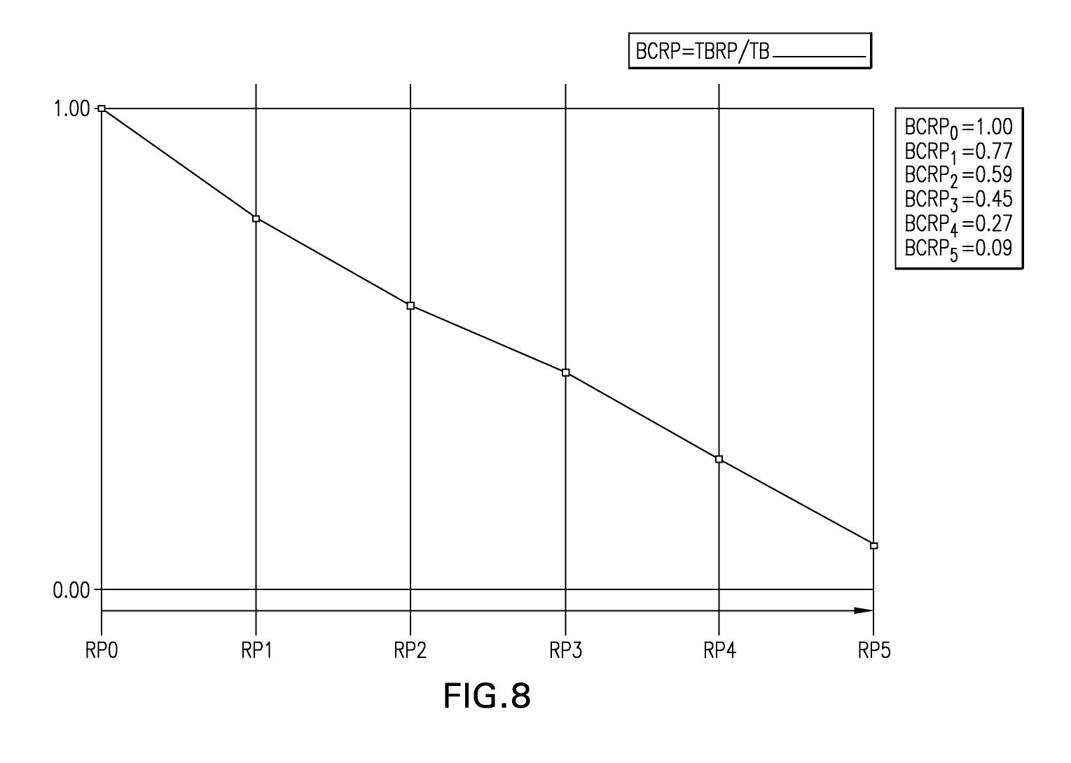

Exemplary results of step 256 are illustrated in FIG. 7. In step 257, the computed BCRP is displayed on display device 20. An example of the computation and display of the BCRP is illustrated in FIG. 8.

Step 258 computes, for each item's Open Document and at each Reporting Point (RP) associated with that item, the difference between the Buffer Consumption Ratio (BCR) and the Planned Buffer Consumption Ratio (BCRP). This difference is computed by the formula:

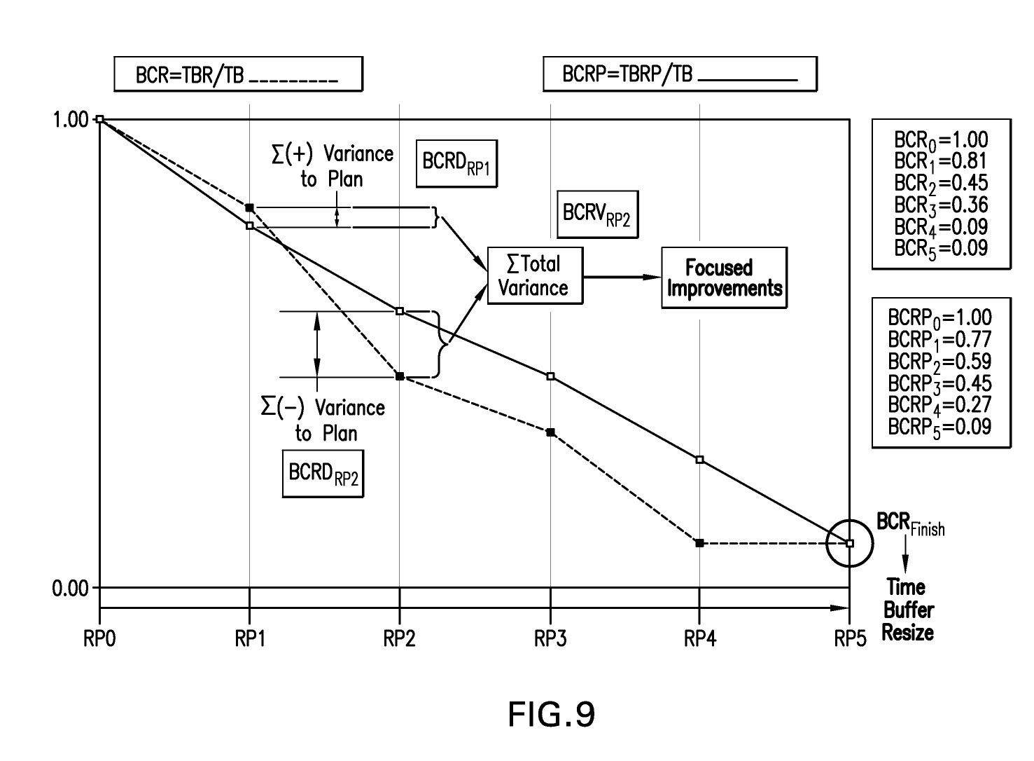

BCRD_{RPi}=BCR_{RPi}−BCRP_{RPi}

wherein the BCRD_{RPi} is the difference between the BCR_{RPi} and BCRP_{RPi}. This step also receives results of step 254 as described in the foregoing description. This difference is displayed on display device 20. An example of the results of this step is shown in FIG. 9. After step 258, the method proceeds to step 260.

Referring to FIGS. 9 and 18H, step 260 computes, for each item's Open Document and at each Reporting Point (RP) associated with that item, the BCR Variance (BCRV) relative to the previous Reporting Point (RP). This BCRV_{RPi} is computed by the following formula:

BCRV_{RPi}=BCRD_{RPi}−BCRD_{RPi-1}

FIG. 9 shows an example of the implementation of step 260. Step 261 receives data generated by step 260 and highlights each BCRV_{RPi} value that is less than zero (i.e. negative) when graphically displaying the BCRV_{RPi} values on display device 20.

The method proceeds to step 262 after step 260. Step 262 maintains, for each item and at each Reporting Point (RP) associated with that item, ongoing BCRD_{RPi} and BCRV_{RPi} records for all documents processed. The “BCRD_{RPi}” value is the difference between the BCR_{RPi} and BCRP_{RPi} which was computed in step 258. The “BCRV_{RPi}” value is the BCR variance which was computed in step 260.

Next, in step 264, the user selects a time frame and filters out all demand data that is not within the selected time frame. The user inputs data representing the selected time frame using keyboard 16.

Next, after step 264, steps 266 and 268 are performed simultaneously. Step 266 analyzes BCRV_{RPi} records to rank the Reporting Points (RP) according to the amount of negative variance occurring for reallocation of the Time Buffer (TB) within the process flow and/or to focus improvement efforts. As described in the ensuing description, step 266 also receives data and information provided by step 306. Step 266 results in the desired focused local improvements. In step 268, the BCRV_{RPi} records are analyzed to rank the Reporting Points (RP) according to the amount of positive variance occurring for reallocation and/or reduction of Time Buffer (TB) within the process flow. The information and data generated in step 268 is provided to step 310 which is part of the Time-Buffer-Resizing segment of the method of the present invention which is described in the ensuing description.

Steps 300-314 of the method of the present invention implement resizing of Time Buffers (TB) and Physical Buffers (PB). As described in the foregoing description, after completion of step 254, the method shifts to steps 258, 300 and 516 simultaneously. Step 258 and the subsequent method steps were already described in the foregoing description. Referring to FIG. 18I, in step 300, for each item managed, an ongoing record is maintained for the BCR for each document processed and completed.

Next, in step 302, for each document completed, an ongoing record of the BCR_{FINISH} is maintained for all documents completed.

In step 304, the user selects a time frame that is used to filter out all demand data that is not within the selected time frame. The user inputs this selected time frame into computer system 14 via keyboard 16.

After step 304, the method shifts to steps 306 and 308 simultaneously. In step 306, the BCR_{FINISH} records for each item are analyzed to rank the Time Buffer (TB) according to the amount of negative variance occurring for increasing the size of the Time Buffer (TB) and/or to focus improvement efforts. The information and data generated in step 306 is provided to step 266 which is part of the method for focused process improvement efforts which is described in the foregoing description. The method then shifts to step 312 which increases the TRR in accordance with the increased size of the Time Buffer (TB). After step 312, step 314 resizes the Physical Buffer (PB). In one embodiment, the method described in the aforesaid US Patent Application Publication No. 20060235734, entitled “Method and System for Determining Buffer Inventory Size”, is used to resize the Physical Buffer (PB). The results provided by step 314 are a desired focus of global improvements.

In step 308, the BCR_{FINISH} records for each item are analyzed to rank the Time Buffer (TB) according to the amount of positive variance occurring for decreasing the size of the Time Buffer (TB).

Step 310 is the next step after step 308, and is also the next step after step 268 which was described in the foregoing description. Step 310 reduces the Time to Reliably Replenish (TRR) in accordance with the decreased size of the Time Buffer (TB). After step 310, the method shifts to step 314 which was described in the foregoing description.

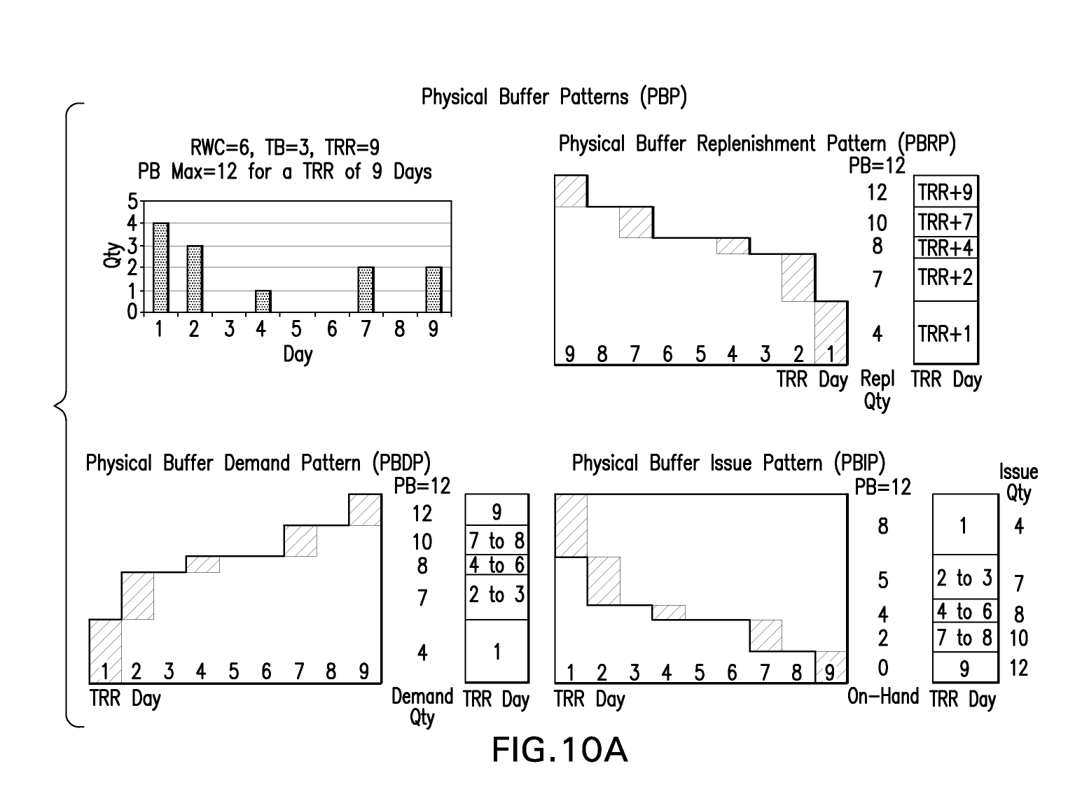

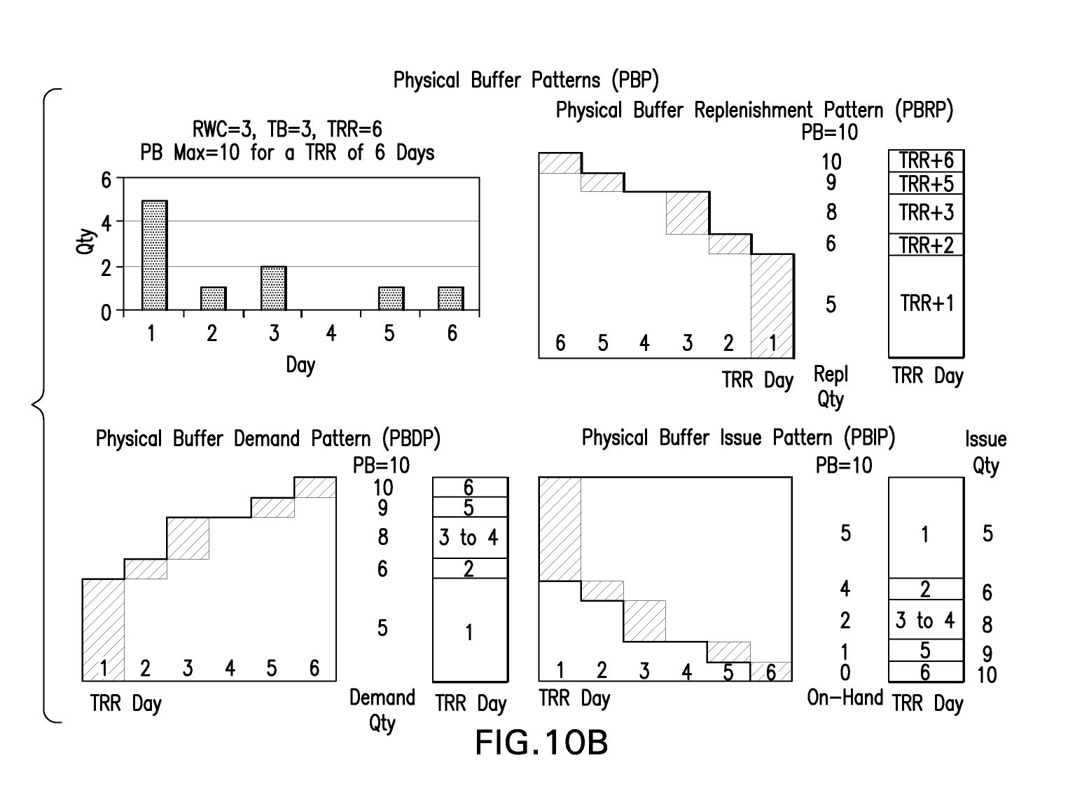

The method of the present invention also provides establishment, analysis and adjustment of an item's Physical Buffer Pattern (PBP). Such adjustments are made to the PBP in order maintain its effectiveness in identifying changes in an item's demand pattern as the item flows through the predefined process flow during a Time-To-Reliably Replenish (TRR). In order to accomplish these functions, steps 400-420, are implemented. These steps may be executed concurrently with the method steps described in the foregoing description. Referring to FIGS. 10A, 10B and 18J, step 400 establishes, for each item managed, a Maximum expected Demand for each Reporting Interval (RID_{RIMax}) of Time-To-Reliably Replenish (TRR). The aforesaid, commonly owned U.S. Patent Application Publication No. 20060235734 provides a technique by which a maximum demand for a Reporting Interval (RI) can be determined. However, other suitable methods may be used to establish the Maximum Demand for each Reporting Interval (RID_{RIMax}). In FIGS. 10A and 10B, the maximum expected demand during the TRR is represented by “PB Max” which is the “Maximum Physical Buffer Size”. In FIG. 10A, PB Max=12 for a TRR of nine (9) days. In FIG. 10B, PB Max=10 for a TRR of six (6) days. Step 402 graphically displays, on display device 20, the Physical Buffer Patterns (PBP) which are shown in FIGS. 10A and 10B. In FIGS. 10A and 10B, step 404 establishes, for each item, a numerical representation of the Maximum Reporting Interval Demand (RID_{RIMax}) build-up throughout the TRR.

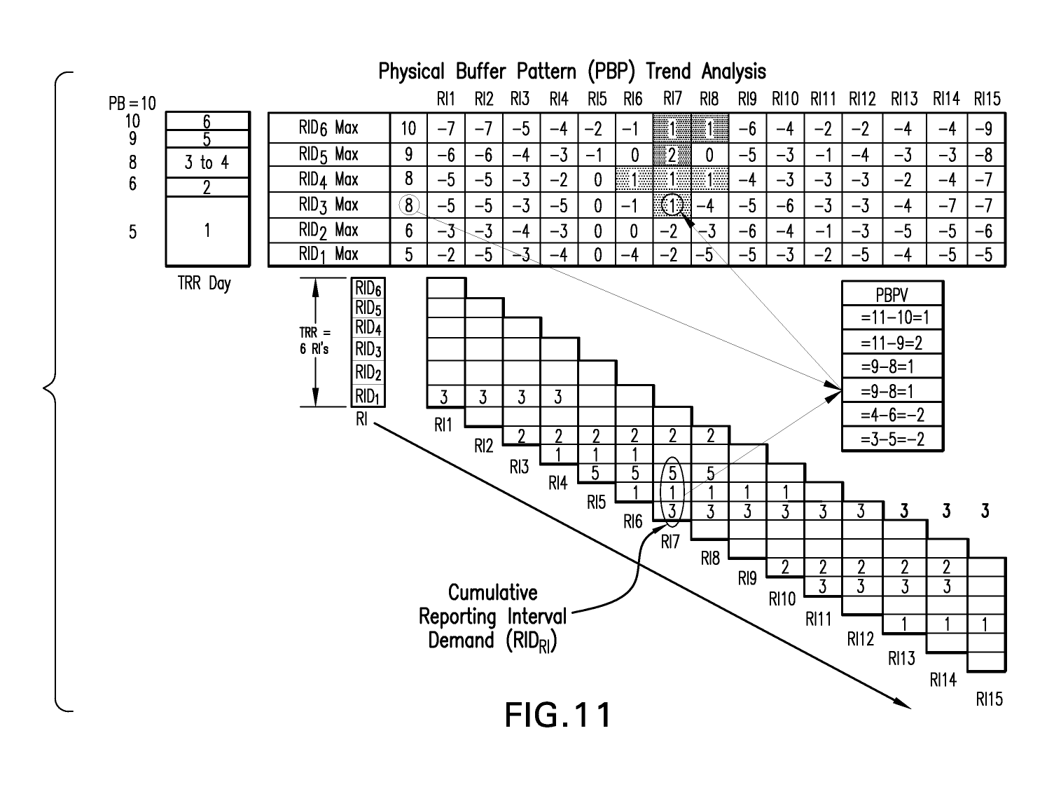

FIG. 11 illustrates the implementation of steps 406 and 408 described in FIG. 18J. Step 406 tracks, for each item, the movement of its Open Documents at each Reporting Interval (RI) and establishes the actual Reporting Interval Demand (RID_{RI}) for each Reporting Interval (RI) of the TRR. The data and information generated at step 406 is provided to steps 408 and 500 simultaneously. Step 500 starts a subset of method steps that relate to a Physical Buffer Factor (PBF) and is described in the ensuing description. Step 408 computes the Variance (PBPV_{RIM-RI}) between the cumulative RID_{RI} and the corresponding RID_{RIMax} for each item, at each Reporting Interval (RI), using the following formula:

PBPV_{RIM-RI}=((Σ₁^{RIM}RIDᵢ)_{RIM-RI}−(RID_{RIMax}))

wherein:

“RID” is the Reporting Interval Demand;

“RIM” is the Reporting Interval for each RID_{RIMaX} for which the PBPV_{RIM-RI} is being calculated;

“RID_{RIMax}” is the Maximum Reporting Interval Demand—at each RIM throughout the TRR;

“PBPV_{RIM-RI}” is the variance between the cumulative RID_{RI} and the corresponding RID_{RIMax}; and

“i” is the index used to compute the cumulative RID_{RIM-RI} at each Reporting Interval (RI) by summing the individual RID's from RIDᵢ₌₁ to RID_{i=RIM}.

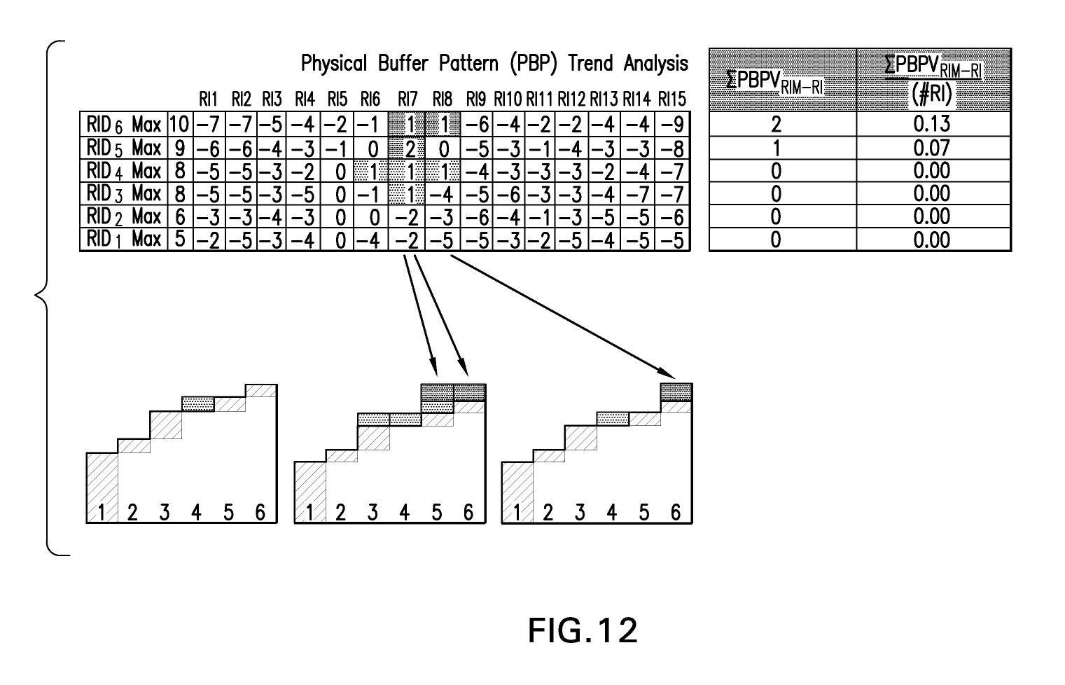

Referring to FIGS. 12 and 18K, step 421 maintains, for each item and at each Reporting Interval (RI), an ongoing PBPV_{RIM-RI} record for all documents processed. The data and information generated at step 421 is provided to steps 422 and 414 simultaneously. Step 414 starts a subset of method steps that relate to adjusting the Physical Buffer Patterns (PBP) and is described in the ensuing description.

Step 422 maintains, for each item managed, an ongoing record of its NIS (Not-In-Stock) documents, including date requested, quantity and date satisfied, or date the request was withdrawn. This step also receives data and information generated by step 204 which was discussed in the foregoing description.

After step 422, the method shifts to steps 424 and 514 simultaneously. Step 424 selects a time frame and filters out all demand data that is not within the selected time frame. In step 426, the PBPV_{RIM-RI} records are analyzed to rank the ΣPBPV_{RIM-RI} values according to the amount of positive variance occurring greater than the PB, in both magnitude and frequency of occurrence, for increasing the size of the PB in accordance with Not-In-Stock situations. The implementation of step 426 is illustrated in FIG. 12. After step 426, step 314 resizes the Physical Buffer (PB). In one embodiment, the method described in the aforesaid US Patent Application Publication No. 20060235734, entitled “Method and System for Determining Buffer Inventory Size”, is used to resize the Physical Buffer (PB). The results, provided by step 314, are a desired focus of global improvements.

As described in the foregoing description, after step 421, the process shifts to steps 414 and 422 simultaneously. Step 422 and the steps subsequent thereto were described in the foregoing description. The ensuing description pertains to FIG. 18L and step 414 and the steps subsequent thereto. Step 414 selects a time frame and filters out all demand data that is not within the selected time frame. After step 414, steps 416 and 418 are executed simultaneously.

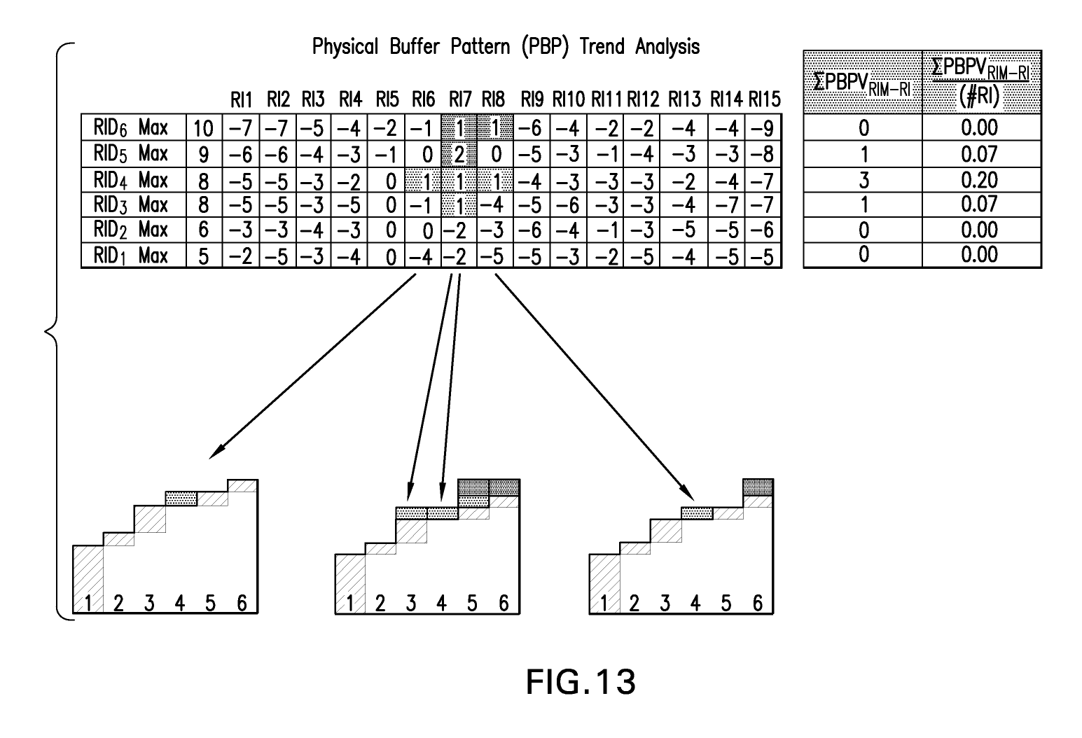

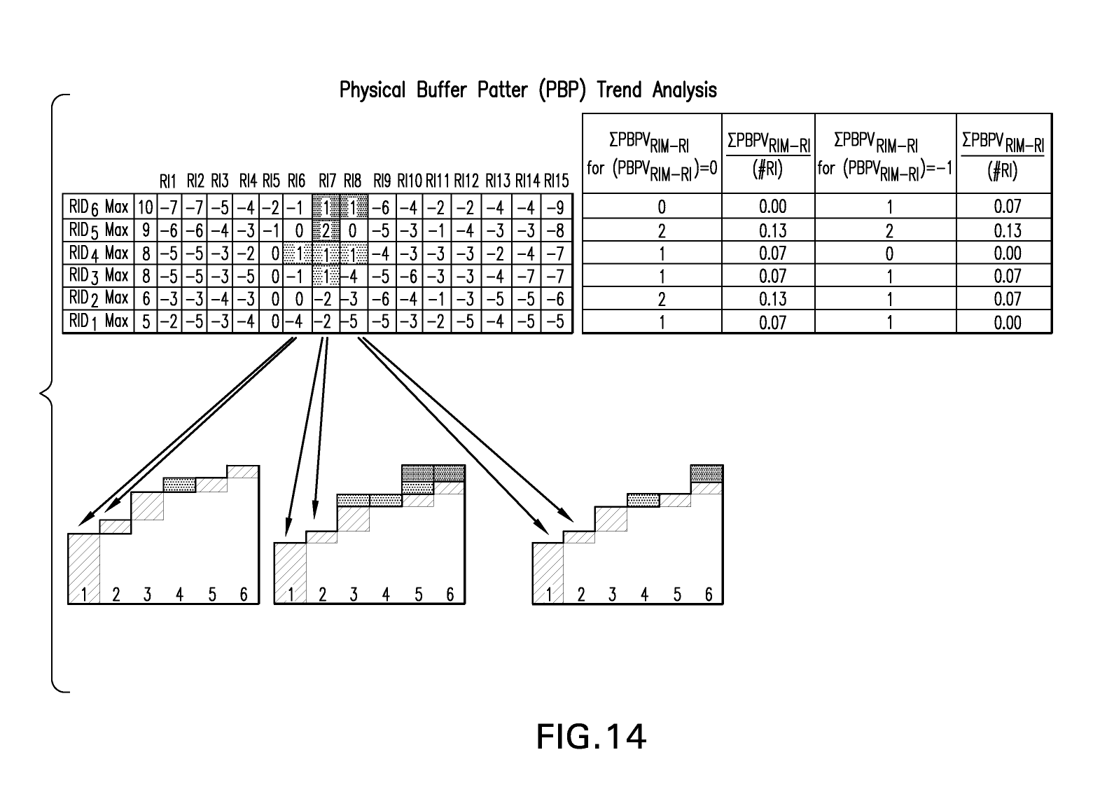

In step 416, the PBPV_{RIM-RI} records are analyzed to rank the PBPV_{RIM-RI} values according to the amount of negative variance occurring, both in magnitude and frequency of occurrence, for decreasing the perimeter of the Physical Buffer Pattern (PBP). In step 418, the PBPV_{RIM-RI} records are analyzed to rank the PBPV_{RIM-RI} values according to the amount of positive variance occurring less than the PB, in both magnitude and frequency of occurrence, for increasing the perimeter of the PBP. The implementation of step 416 is illustrated in FIG. 14 and step 418 is illustrated in FIG. 13. After steps 426, 416 and 418, step 420 makes the appropriate adjustments to the PBP perimeter.

Manage (Part B)

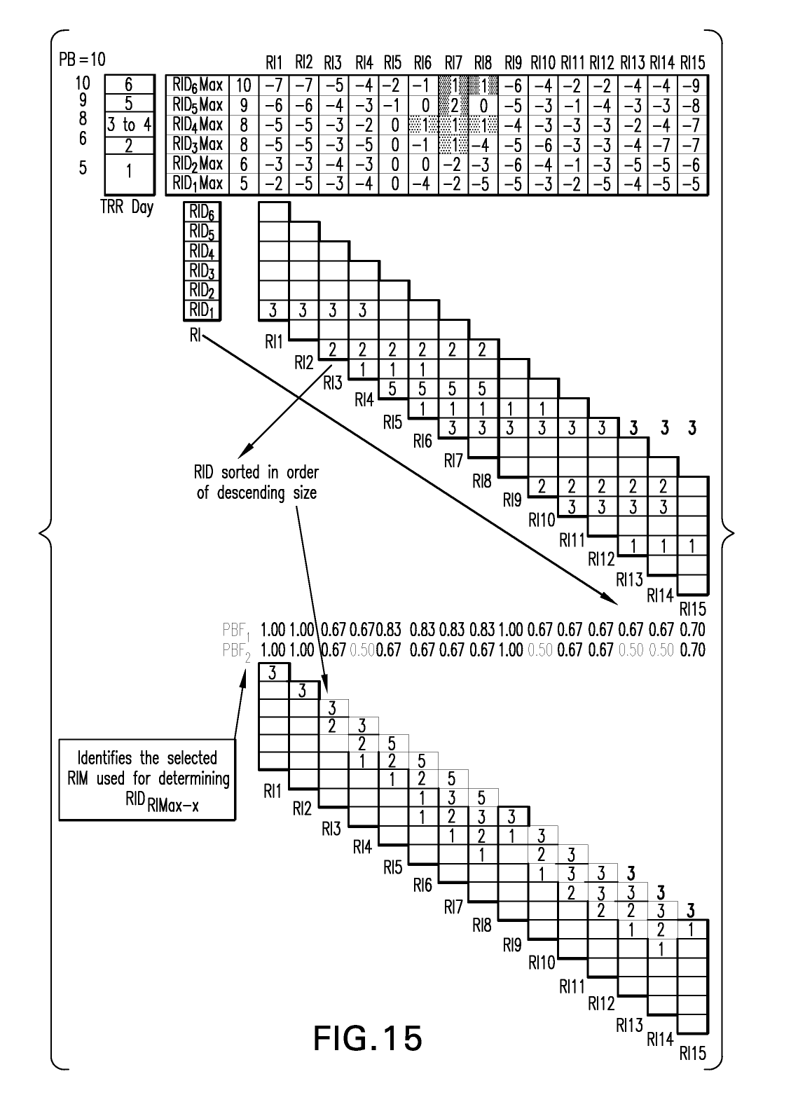

As described in the foregoing description, after step 406, the process shifts to steps 408 and 500 simultaneously. Step 408 and the steps subsequent thereto were described in the foregoing description. The ensuing description pertains to step 500 and the steps subsequent thereto. Step 500 is the first step in a series of steps that result in the computation of a Physical Buffer Factor (PBF). Steps 500-510 are shown in FIGS. 18M and 18N, and a graphical example of the implementation of steps 500-510 is shown in FIG. 15.

In step 500, the user is allowed to select which RIM (i.e. x=1−n) is to be used to determine the anticipated RID_{RIMax-x} (i.e. x=1−n) quantity for an approaching maximum coverage requirement.

In step 501, for each item managed, the user is allowed to establish the initial Time interval Between Occurrences (TBO_{RIMax-x}) to be used in conjunction with the selected RID_{RIMax-x} to determine the anticipated timing for an approaching maximum coverage requirement. During implementation of the method described in the aforesaid, commonly owned U.S. Patent Application Publication No. 20060235734, particular data can be extracted for use in establishing the initial Time interval Between RID_{RIMax-x} Occurrences (TBO_{RIMax-x}). However, other suitable techniques or methods may be used to establish the initial Time interval Between RID_{RIMax-x} Occurrences (TBO_{RIMax-x}).

Step 502 maintains, for each item managed, an ongoing record of the number of RID_{RIMax-x} occurrences in relation to the Time interval Between RID_{RIMax-x} Occurrences (TBO_{RIMax-x}). In step 504, the user is allowed to define a RID_{RIMax-x} Reporting Interval Factor (RIF) to be used to determine an updated TBO_{RIMax-x}. For example, the user can choose a RIF equal to a percent (e.g., 90%) of the RID_{RIMax-x} occurrences, to be used in conjunction with the distribution of TBO_{RIMax-x}, in order to establish the updated TBO_{RIMax-x} to be used to determine the anticipated timing for an approaching maximum coverage requirement.

In step 506, for each item, in each Reporting Interval (RI) following a user defined percent of the established TBO_{RIMax-x} after the last RID_{RIMax-x} occurrence, the largest RIDs are summed looking for a total quantity that is greater than or equal to the quantity of RID_{RIMax-x}.

Step 508 determines a Physical Buffer Factor (PBF) for each item, in each Reporting Interval (RI) following a user defined percent of the established TBO_{RIMax-x} after the last RID_{RIMax-x} occurrence. The PBF is determined by the following formula:

PBF=[1−(LRID/TRI)]

wherein:

“PBF” is the Physical Buffer Factor;

“LRID” is the number of largest RIDs required to arrive at a quantity greater than or equal to RID_{RIMax-x}; and

“TRI” is the total number of RIs in the TRR.

The next step, step 510, allows the user to define a PBF threshold value (e.g. <0.67) that will be used to trigger increases in priorities by adjusting the BRP value for an item's Open Documents totaling a quantity equal to the RID_{RIMax-x} less the on-hand quantity in the Physical Buffer (PB).

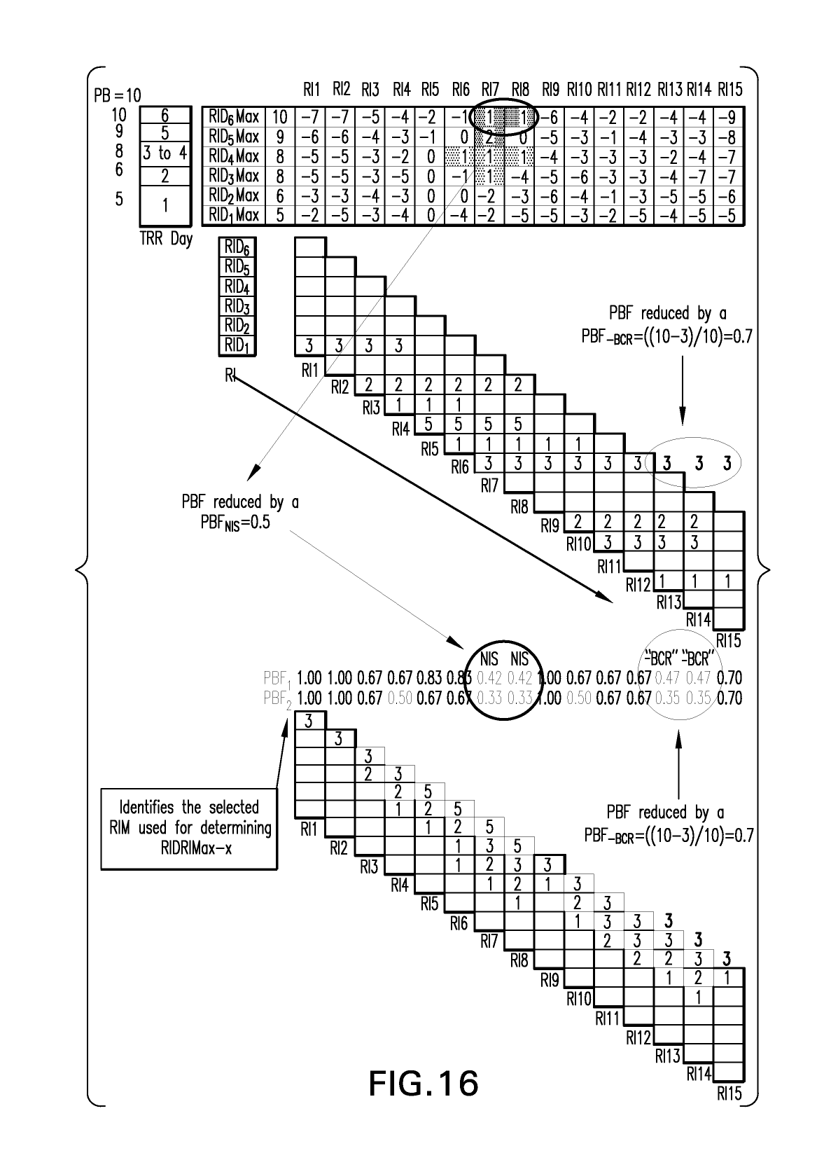

In step 514, the user is allowed to define a Not-In-Stock (NIS) adjustment to the PBF, referred to as PBF_{NIS}, with a user defined value (e.g. 0.50) that will be used to increase priorities by adjusting the BRP value for any item that becomes NIS for a quantity equal to the NIS quantity. FIG. 16 illustrates the implementation of step 514.

After step 514, step 516 is implemented. As described in the foregoing description, after the implementation of steps 254, the method shifts simultaneously to step 516. In step 516, the user is allowed to apply a Negative Buffer Consumption Ratio (BCR) adjustment to the PBF, referred to as PBF_{-BCR}, that will be used to increase priorities by adjusting the BRP value for an item's Open Documents having a positive BCR. The PBF_{-BCR} value is found by the following formula:

PBF_{-BCR}=(((PB)−(QBCR<0))/PB)

wherein:
“PBF_{-BCR}” is the negative BCR adjustment to the PBF;
“QBCR” is the number of parts with a BCR<0; and
“PB” is the current Physical Buffer size.
FIG. 16 illustrates the implementation of step 516.

Step 518 computes, for each item's Open Documents and at each Reporting Interval (RI), the PBF, including any (NIS) or (−BCR) adjustments. FIG. 16 also illustrates the implementation of this step.

After step 518, the computed PBF is made available to step 122 which was described in the foregoing description and shown in FIG. 18E.

### Plan

The PLAN portion utilizes the same document planning process as described in MANAGE (Parts A and B). The following abbreviations are used in the ensuing description and corresponding drawings:

RN: Resource Name

RGN: Resource Group Name

RQA: Resource Quantity Available

DWC: Daily Work Calendar

WDay: Work Day

RWC: Required Work Content

ATB: Allocated Time Buffer

RDRUM: Resource DRUM

DDRUM: Demand DRUM

EN: Equipment Name

EQ: Equipment Quantity

ON: Operator Name

OQ: Operator Quantity

SPN: Set Up Person Name

SPQ: Set Up Person Quantity

FN: Fixture Name

FQ: Fixture Quantity

TN: Tool Name

TQ: Tool Quantity

CAL: Calendar

WC: Work Center

TPU: Time Per Unit

SUT: Setup Time

OE: Operating Expense

DSM: Dependent Setup Matrix

RCCP: Rough Cut Capacity Planning

ICP: Impact Capacity Planning

The PLAN section of the method of the present invention provides “Rough Cut Capacity Planning (RCCP)” and “Impact Capacity Planning (ICP)”. These planning capabilities are discussed in the ensuing description.

### Rough Cut Capacity Planning (RCCP)

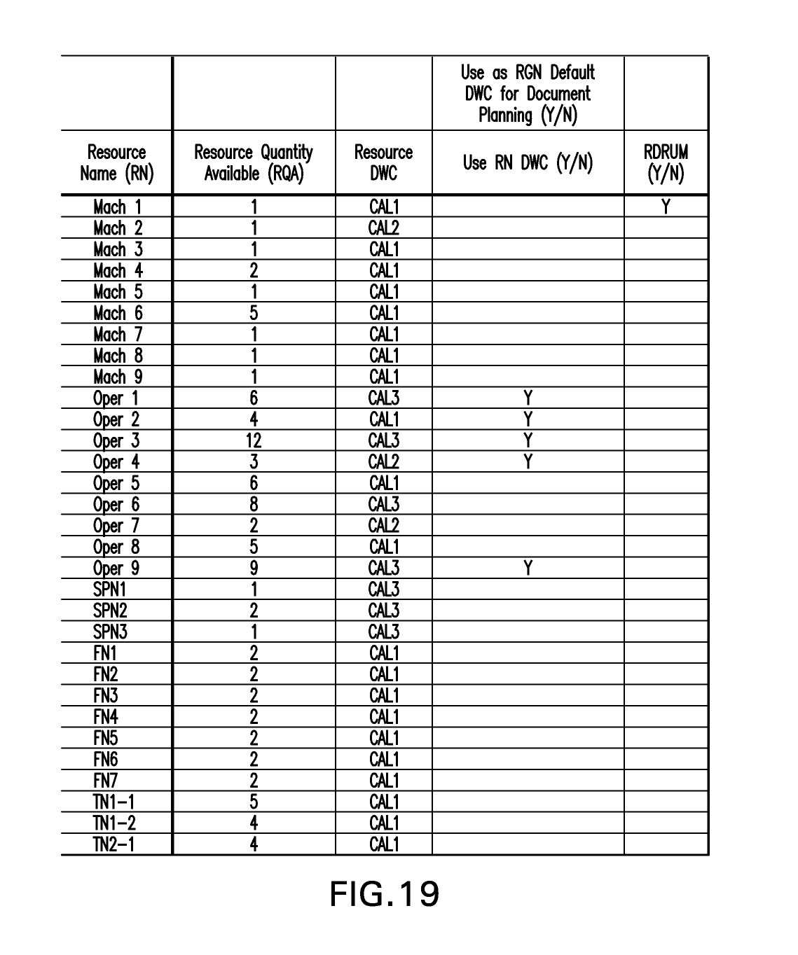

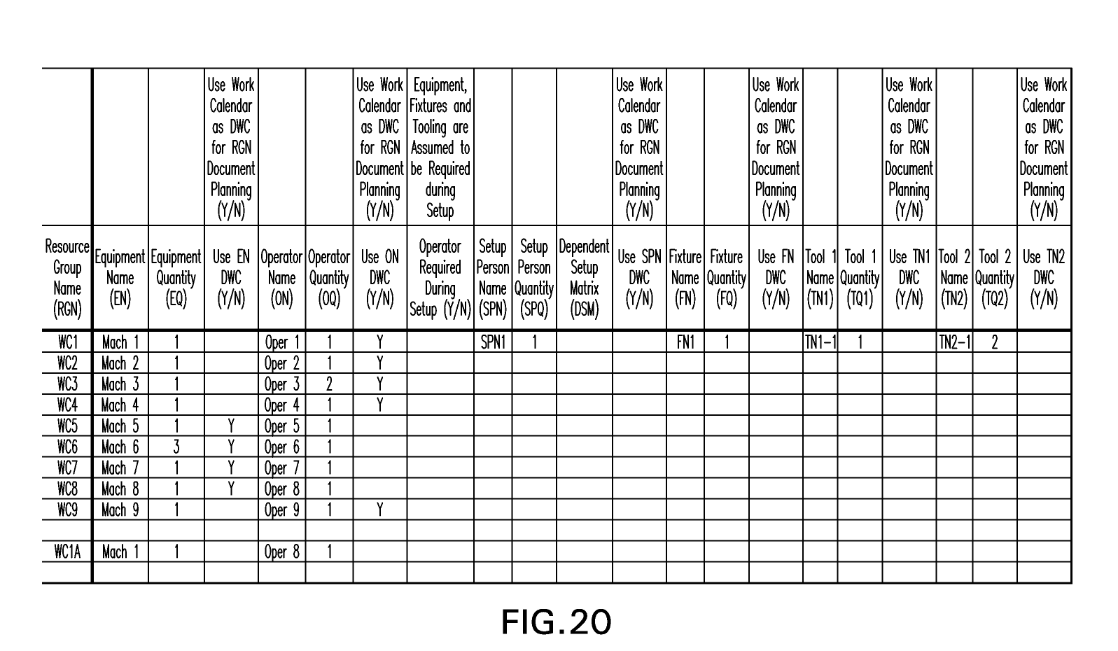

Reference is now made to FIGS. 19 and 20. In FIG. 19, there is shown a table containing information describing the details of the resources used in the Resource Group Name (RGN) shown in FIG. 20. A Resource Group Name (RGN) is used to identify a Work Center (WC) and is defined by particular resources of the Work Center (WC) such as equipment, operators, set-up persons, fixtures and tooling. Each selected item moves through a predefined process flow. A “predefined process flow” is associated with a specific item and its corresponding documents. The predefined process flow comprises one or more process steps, wherein each process step would use a specific Resource Group Name (RGN) or Work Center (WC). Thus, a Resource Group Name (RGN) represents a Work Center (WC) thereby relating the “Capacity Planning” aspect of the PLAN methodology to the document planning aspect of MANAGE (Parts A and B).

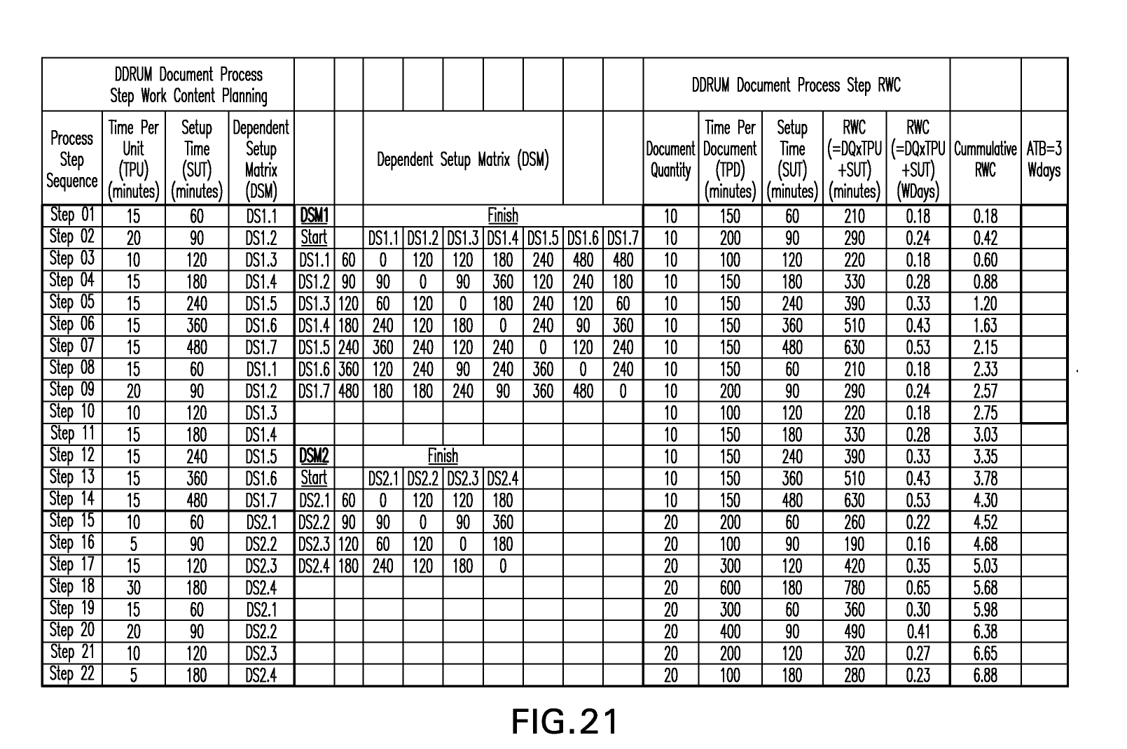

Referring to FIG. 21, there is shown a table that contains data relating to “DDRUM Document Process Step Work Content Planning”, “Dependent Setup Matrix (DSM)” and “DDRUM Document Process Step RWC”. This data enables conversion of Process Step Time-Per-Unit (TPU) and Setup Time (SUT) to Document Process Step RWC in Work Days (WDays) for the Document quantity of the item as input to the Document Planning Process in MANAGE. The Dependent Setup Matrix (DSM) data shown in FIG. 21 is not used in PLAN but instead, is used in SCHEDULE when performing overall reduction in Setup Time (SUT).

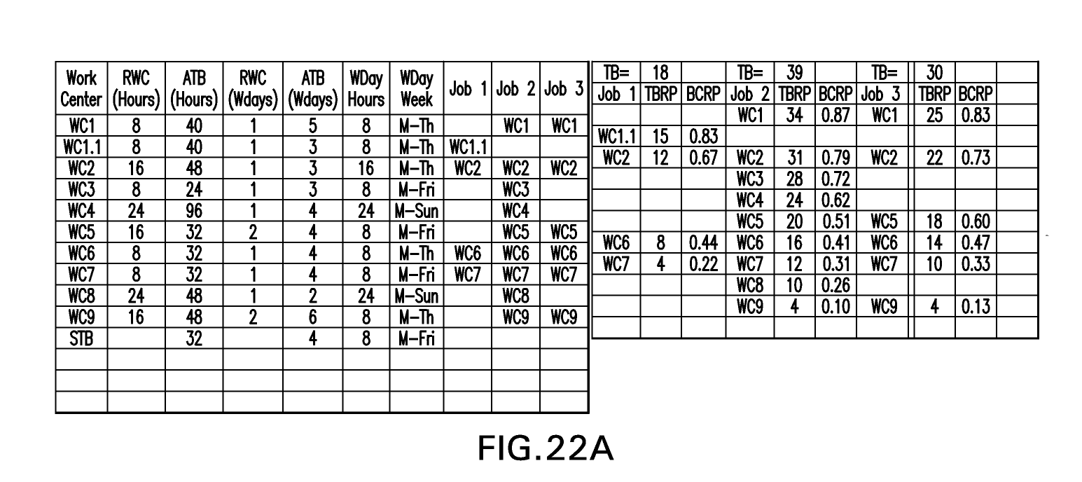

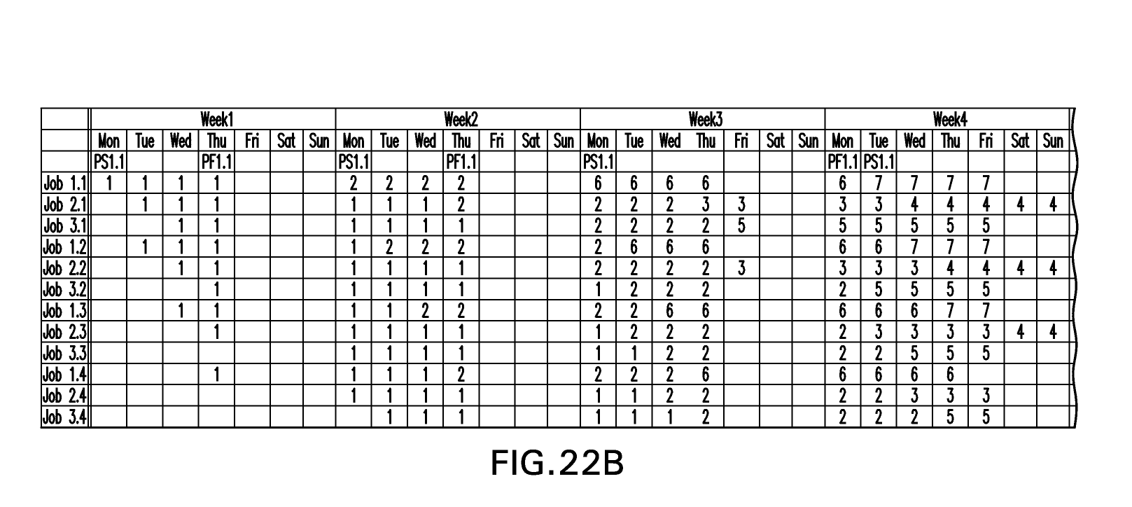

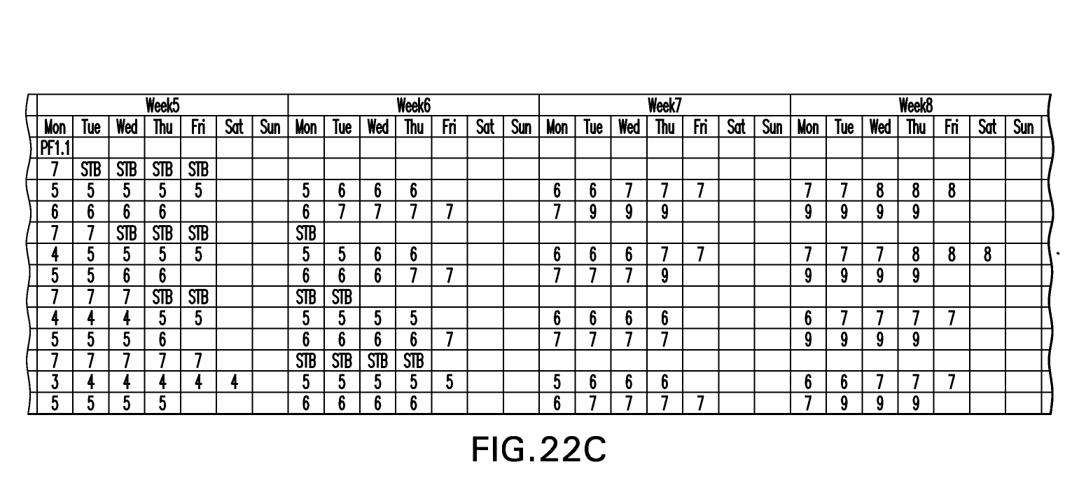

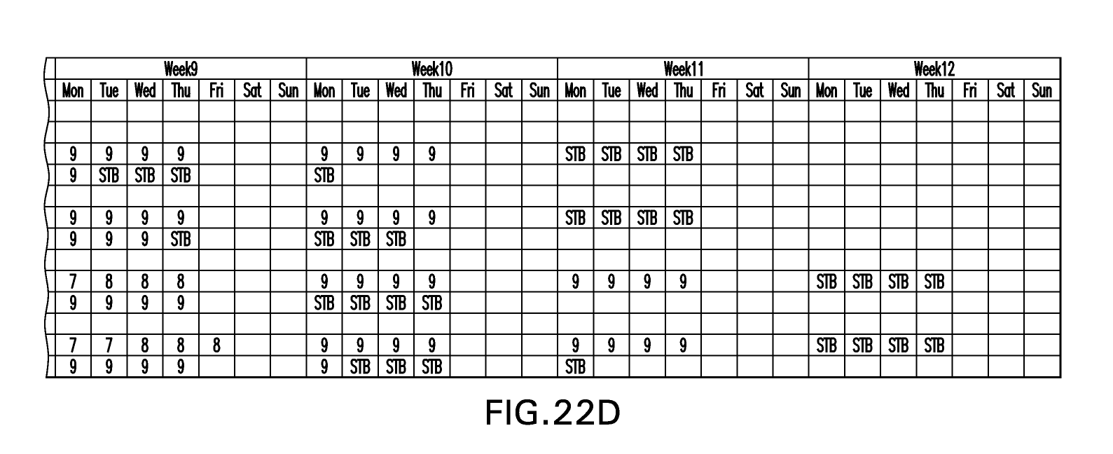

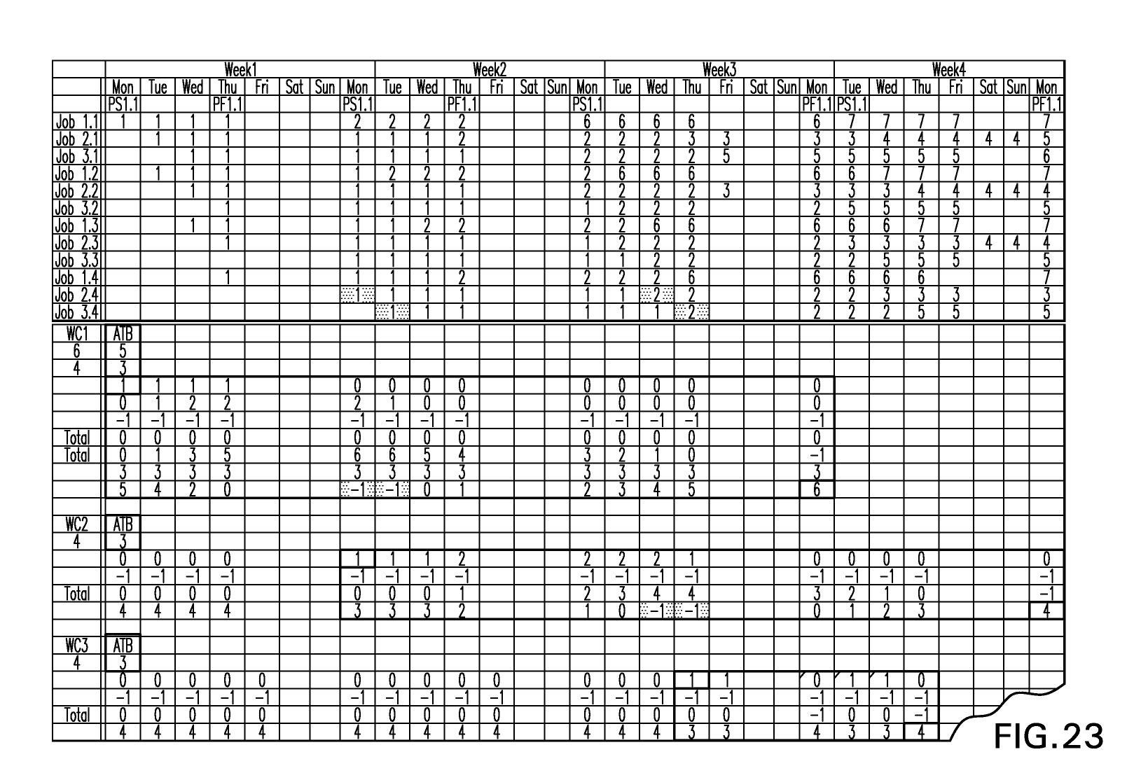

Referring to FIGS. 22A-D, there is shown an example of data and information that is generated by the MANAGE section of the method of the present invention. A portion of the Document Planning data and information shown in FIGS. 22A-D is used in “Rough Cut Capacity Planning” (RCCP). Specifically, Document Planning data and information generated by MANAGE, which is shown in FIGS. 22B-D, is also shown in the top table in FIG. 23. As shown by FIG. 23, Rough Cut Capacity Planning (RCCP) transfers particular Document Planning data and information into the Rough Cut Capacity Planning for the Resource Group Name and its individual resources. Thus, Rough Cut Capacity Planning provides the ability to identify Local Allocated Time Buffer (ATB) Overloads and relate them to the required resources using a Resource Group Name (RGN).

Therefore, in order to achieve Rough Cut Capacity Planning, this embodiment of the invention is directed to a method for determining the capacity required to complete work during planned start and finished times comprising the following steps:
a) providing a plurality of Resource Group Names (RGN) wherein each Resource Group Name (RGN) represents a particular Work Center (WC) having predetermined resources associated therewith. These predetermined resources include equipment, operators, set-up person(s), fixtures and tooling.
b) selecting a particular item that is in a predefined process flow;
c) providing data that represents a planned movement of the selected item along the predefined process flow;
d) identifying all process steps in the predefined process flow through which the selected item must pass;
e) identifying each Reporting Point (RP) in each selected item's predefined process flow and retrieving data that represents the Required Work Content (RWC) of the selected item at each process step along the predefined process flow;
f) determining the Required Work Content (RWC) to completely perform all process steps in the overall process and providing, for each step of the predefined process flow, an amount of Allocated Time Buffer (ATB) required for accommodating the variabilities associated with completing the Required Work Content (RWC). An example of a variability associated with completing the Required Work Content (RWC) is an unexpected delay in or additional time needed to complete a conformal coating process. The planned amount of time for completing the conformal coating process was two hours. However, the process used more coating material than expected and so the conformal coating machine had to be shut down for an hour in order to replenish the coating material. This is just one example and there are many more examples of variabilities;
g) establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB). Thus, there is a Daily Work Calendar (DWC) that is associated with each step of the predefined process flow;
h) retrieving a document start date-time for each selected item that enters the predefined process flow, and utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the planned start date-time and planned finish date-time at each process step in each item's open document's;
i) retrieving a document finish date-time for each selected item that enters the predefined process flow, and utilizing the Resource Group Name (RGN) representing the Work Center (WC) and the corresponding Work Center (WC) Daily Work Calendar (DWC), Required Work Content (RWC), Allocated Time Buffers (ATB) and document finish date-time to establish the planned start date-time and planned finish date-time at each process step in each item's open document's; and
j) utilizing the resources in the Resource Group Name (RGN) representing the Work Center (WC) and the corresponding Work Center (WC) Daily Work Calendar (DWC) to map resource loading at each process step within each open document in accordance with the established planned start date-time and planned finish date-time at each process step to identify any local Allocated Time Buffer (ATB) overloads corresponding to any of the Work Centers (WC) and the resources associated therewith.

In the top portion of the chart of FIG. 23, the four boxes that correspond to Jobs 2.4 and 3.4 and which have shading or dotted pattern indicate the jobs that may be affected by an overload of a local ATB at Work Center 1 (WC1) and Work Center 2 (WC2), respectively, based on the RCCP. In the lower portion of the chart, the four boxes that correspond to Work Center 1 (WC1) and Work Center 2 (WC2) and have shading or dotted pattern indicate an overload of a local ATB at WC1 and WC2, respectively, based on the RCCP.

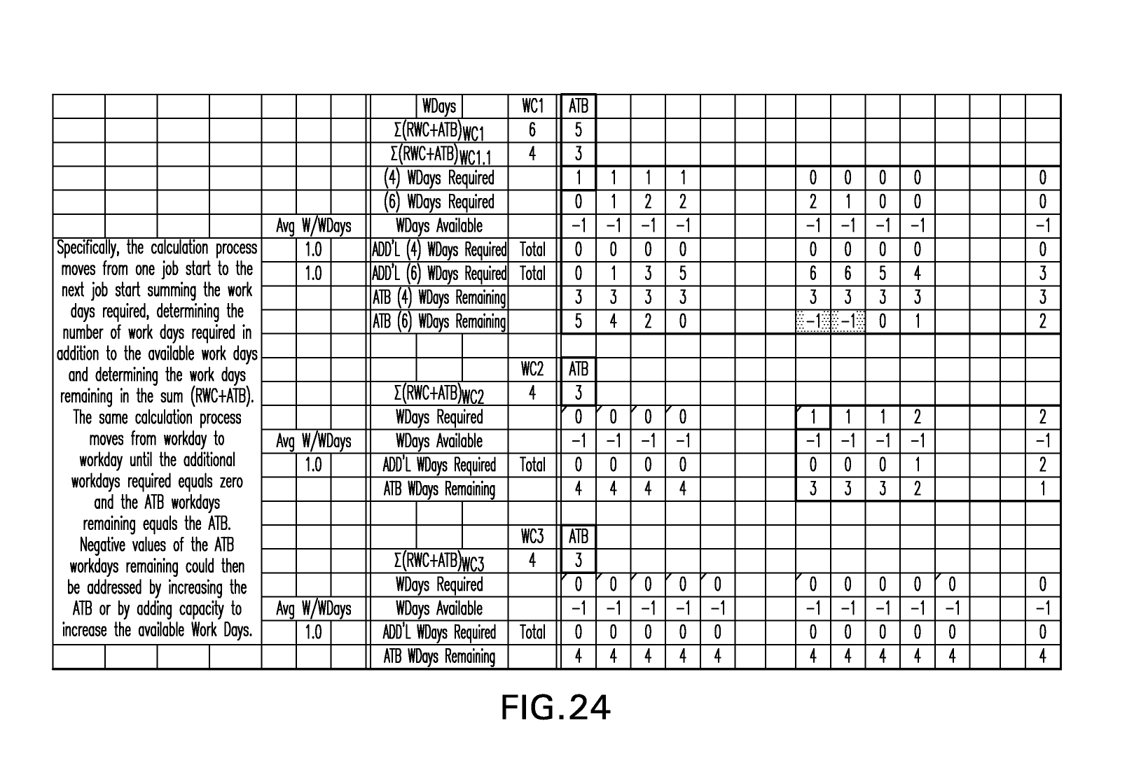

Referring to FIG. 24, there is shown an example of Rough Cut Capacity Planning (RCCP). This example explains how the RCCP calculations are done. The results of this calculation for the Resource Group Name (RGN) are subsequently reapplied or transferred to each resource in the Resource Group Name (RGN) in accordance with their individual work calendars to establish the Resource loading patterns per document, which are then summed up by Work Day (WDay) for each resource and Resource Group Name (RGN). Specifically, the calculation process moves from one job start to the next job start summing the work days required, determining the number of work days required in addition to the available work days and determining the work days remaining in the sum (RWC+ATB). The same calculation process moves from workday to work day until the additional workdays required equals zero and the ATB workdays remaining equals the ATB. Negative values of the ATB workdays remaining could then be addressed by increasing the ATB or by adding capacity to increase the available WDays. The two boxes that correspond to Work Center WC1 and which have shading or dotted pattern indicate an overload of a local ATB at Work Center WC1 based on the Rough Cut Capacity Planning.

Thus, as shown by the foregoing description and corresponding drawings, Rough Cut Capacity Planning uses the same Document Planning process as implemented in MANAGE in conjunction with the Resource Group Name (RGN) and the corresponding Daily Work Calendars (DWC) of resources in the RGN in order to map resource loading according to each document's planned start date and planned finish date at each Reporting Point (RP).

### Impact Capacity Planning (ICP)

Impact Capacity Planning (ICP) is capable of generating simulated data that is used for purposes of planning. Each simulation produced in Impact Capacity Planning is described separately in the ensuing description.

Simulation 1—Global Time Buffer Variance Patterns (Forward in Time)

In this simulation, Global Time Buffer Variance Patterns and their corresponding Local Allocated Time Buffer Variance Patterns are simulated. The simulation starts from the document start date and continues forward in time pushing all Reporting Point (RP) Planned Start Date to Planned Finish Date overloads (−BCRV) occurrences forward in time so as to generate simulated Global Time Buffer Variance Patterns and their corresponding Local Allocated Time Buffer Variance Patterns. Impact Capacity Planning (ICP) uses the same Document Planning process implemented in MANAGE as the baseline for Document Planned Start Dates and Planned Finish Dates and then sequences forward in time through each Reporting Point according to the Resource Calendar designated for simulation, and then captures the Resulting Global and Local Variance Pattern Data and the simulated document finish dates and increased lead times.

Simulation 2—Global Time Buffer Variance Patterns (Backward in Time)

In this simulation, Impact Capacity Planning (ICP) provides a simulation from the document finish date backward in time pushing all Reporting Point (RP) Planned Start Date to Planned Finish Date overloads (−BCRV) occurrences backward in time so as to produce simulated Global Time Buffer Variance Patterns and their corresponding Local Allocated Time Buffer Variance Patterns. Impact Capacity Planning (ICP) uses the same Document Planning process implemented in MANAGE as the baseline for Document Planned Start Dates and Planned Finish Dates and then sequences backward in time through each Reporting Point according to the Resource Calendar designated for simulation, and then captures the Resulting Global and Local Variance Pattern Data and the simulated document start dates and increased lead times.

Simulation 3—Additional Capacity Requirements (Forward in Time)

In this simulation, Impact Capacity Planning (ICP) generates a simulation from the document start date forward in time converting all Reporting Point (RP) Planned Start Date to Planned Finish Date overloads (−BCRV) occurrences into additional capacity requirements in specific windows of time for the corresponding Resource Group Name (RGN) and its resources. For this simulation, Impact Capacity Planning (ICP) uses the same Document Planning process as MANAGE as the baseline for Document Planned Start Dates and Planned Finish Dates and then sequences forward in time through each Reporting Point (RP) according to the Resource Daily Work Calendar (DWC) designated for simulation, and then captures the Resulting Global and Local Variance Pattern Data and the simulated additional capacity requirement to bring the (−BCRV) values connected to documents having a (−BCR_{FINISH}) in Simulation 1 to zero and the Specific Window of Time (SWT) in which to apply the additional capacity.

### EXAMPLE

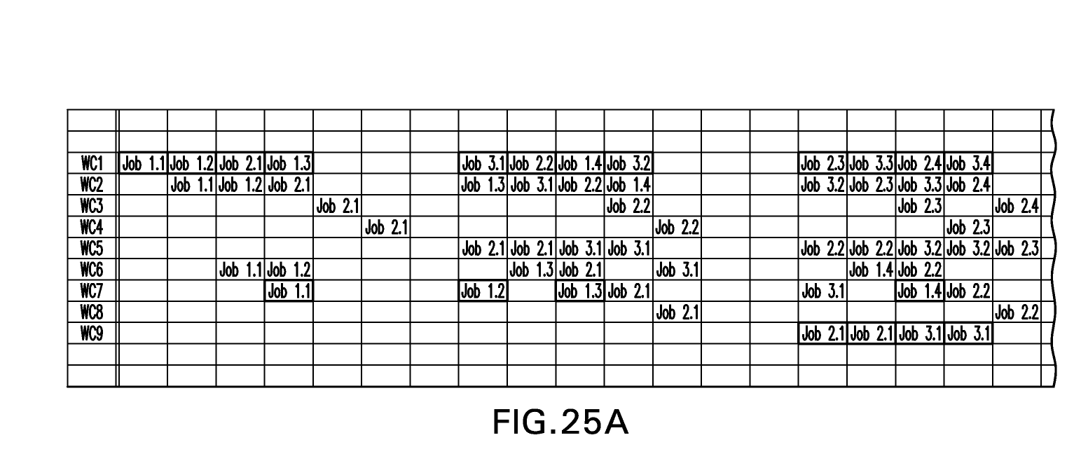

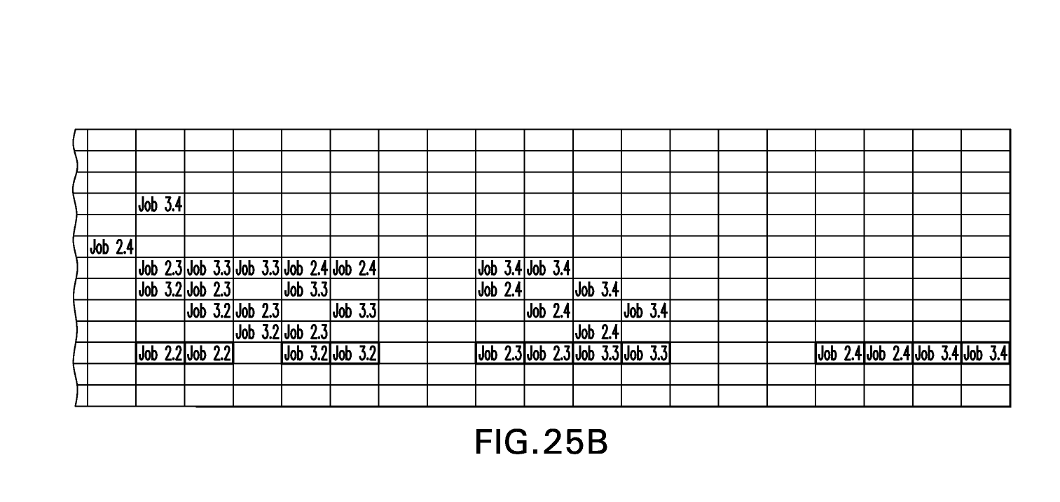

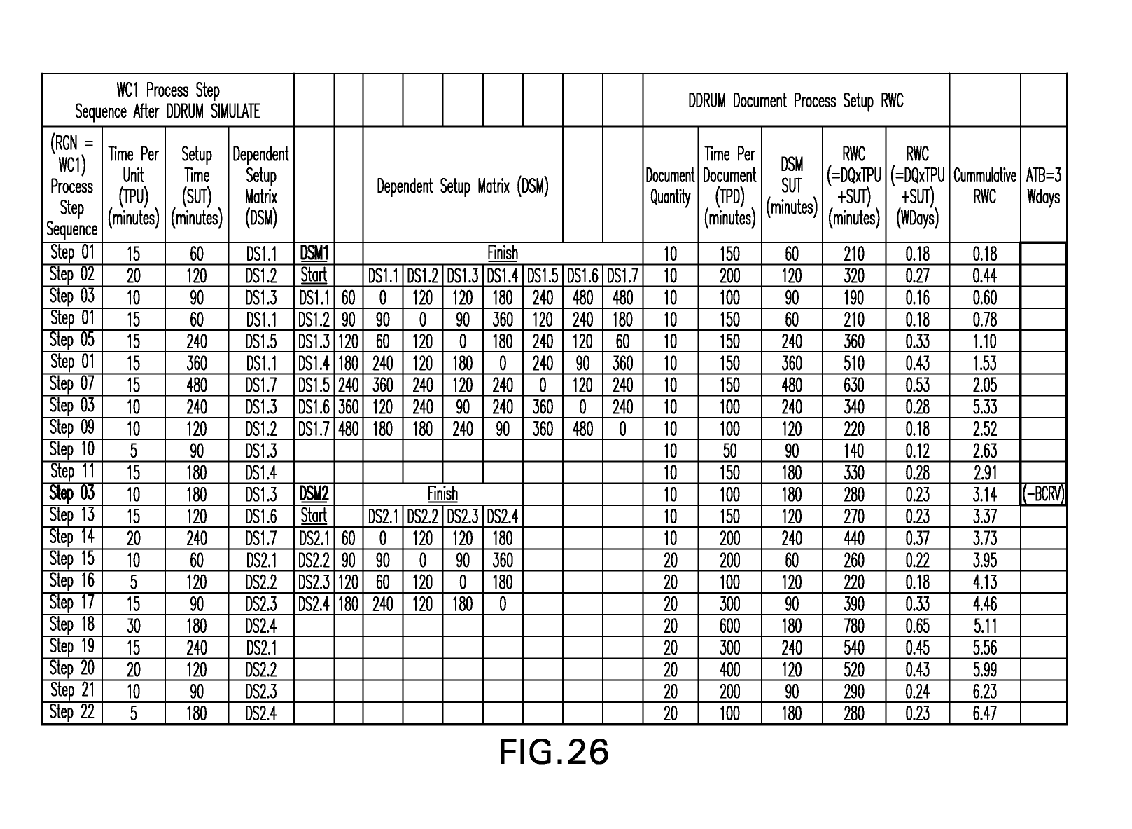

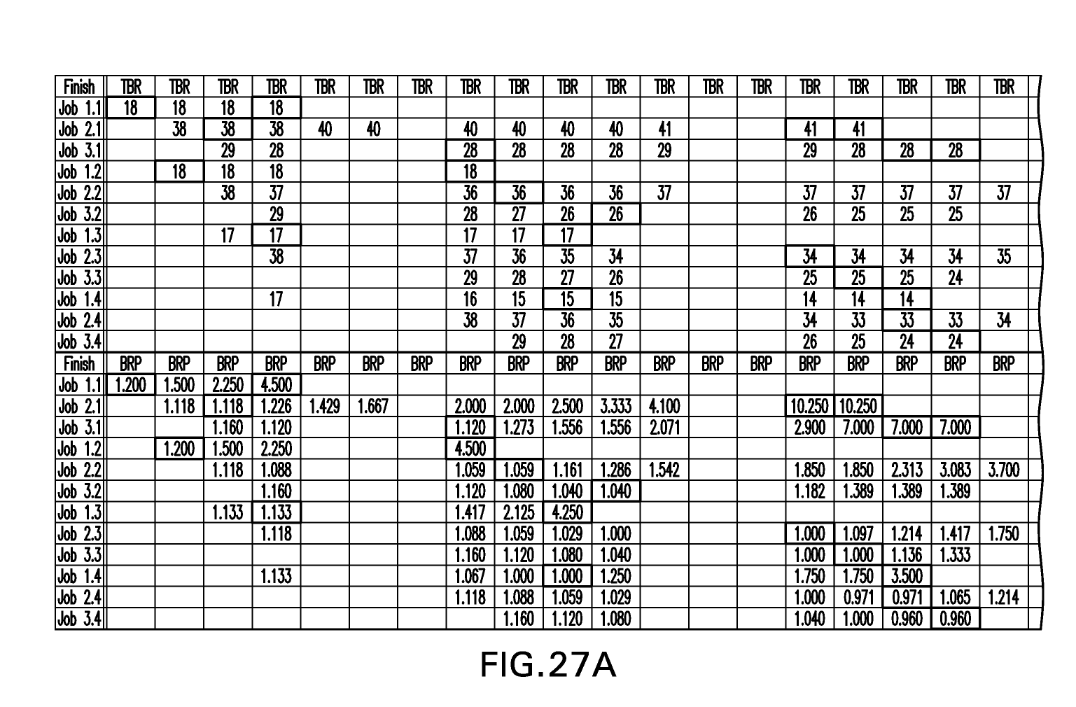

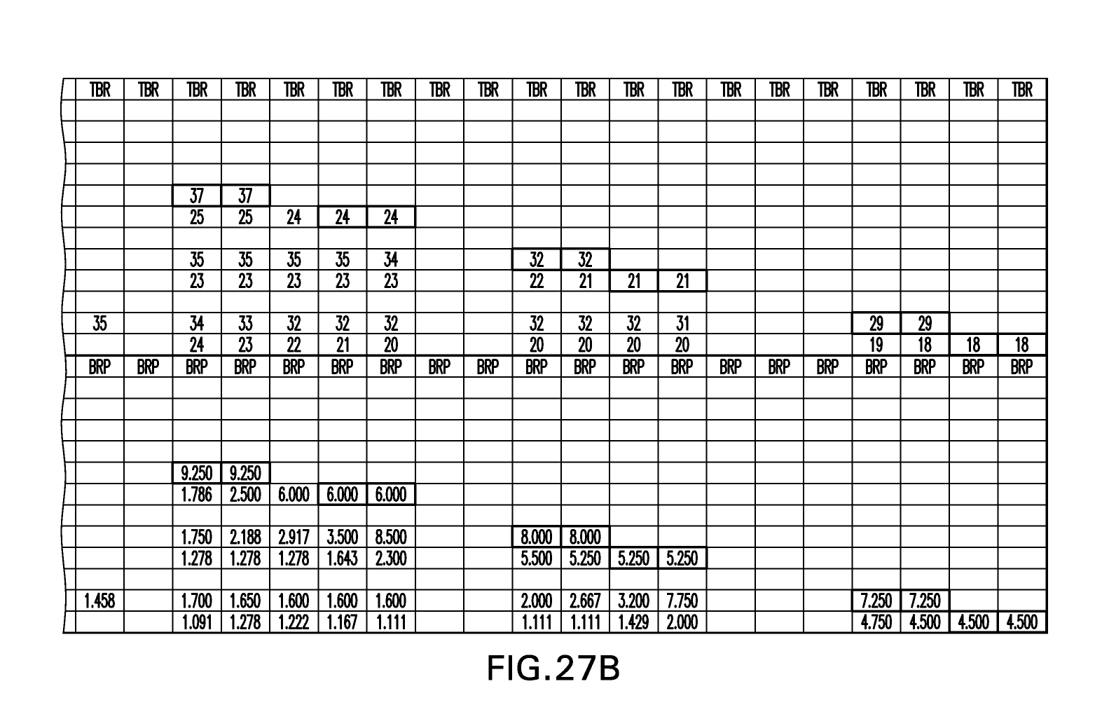

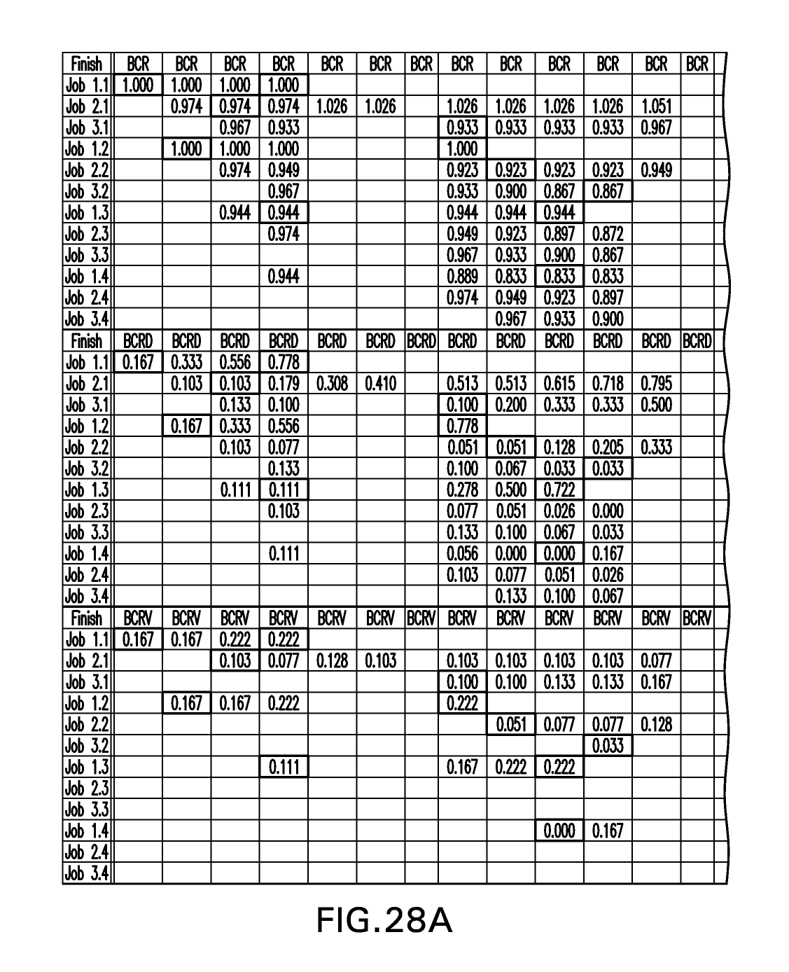

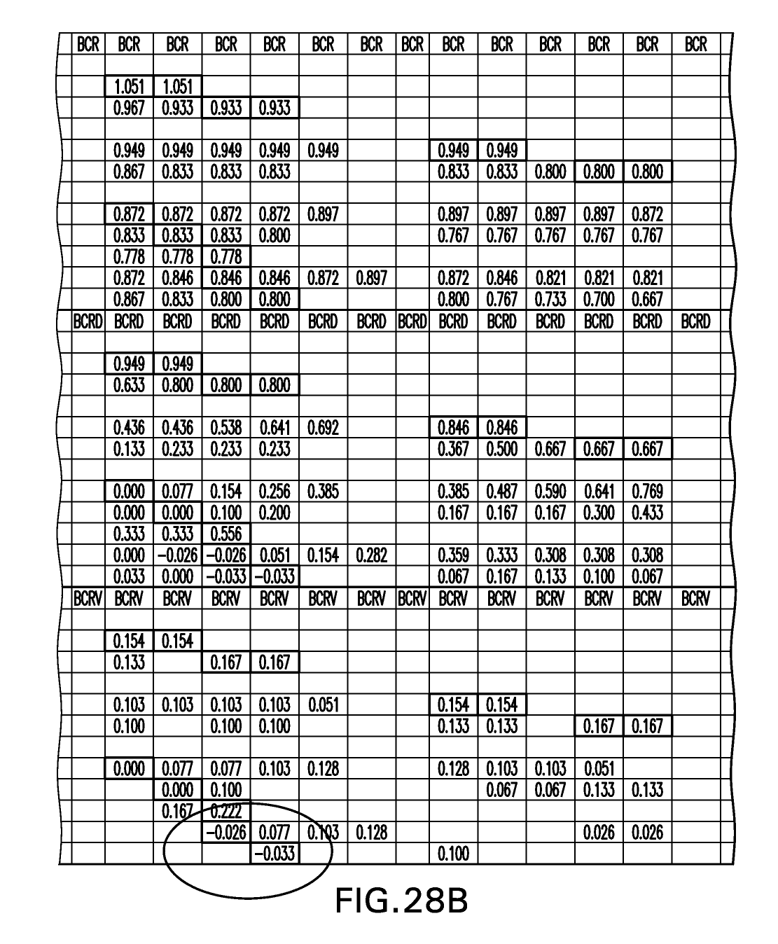

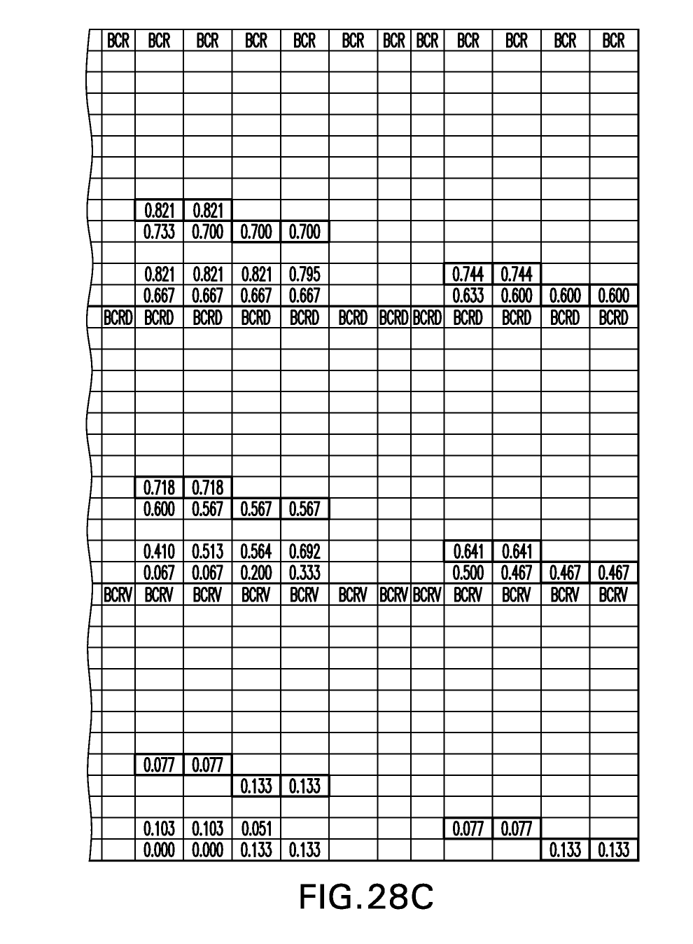

FIGS. 25A-B, 26, 27A-B and 28A-C exemplify the simulations generated by Impact Capacity Planning (ICP). Referring to FIGS. 25A-B, the simulation of the Work Flow is based on the data and information generated by MANAGE (see FIGS. 22A-D). Simulated work flow starts with either the first WDay of planning or the first WDay that has planned work. The sequencing of job starts begins with the first jobs being started first on the first available Work Day. If there is more than one job available to start with the same start time, the job with the smallest Time Buffer (TB) is started first. In FIG. 25A, boxes having bold borders indicate the occurrence of a simulated job-start or simulated job-finish. FIG. 26 shows an example of the resulting sequence of process steps on a given Resource Group Name (Work Center 1 or “WC1”). This example also shows where a particular process step (i.e. STEP 03) is projected to finish with a Negative BCRV, possibly requiring capacity to be added or capacity requirements to be reduced through overall Setup Reduction via the re-sequencing of select items within windows of time. (Overall Setup Reduction through re-sequencing of work is not part of Impact Capacity Planning (ICP) and requires the selection of a Resource DRUM (RDRUM) and is performed in SCHEDULE, which is discussed in the ensuing description). Referring to FIGS. 27A-B, there are shown tables having TBR and BRP data and information that was generated by MANAGE. In FIG. 27A, boxes having bold borders indicate the occurrence of a simulated job-start or simulated job-finish. Referring to FIGS. 28A-C, all of the BCR, BCRD and BCRV information and data shown was generated by MANAGE. The BCR_{FINISH} data shown in FIGS. 28A-C is used for overall document performance and is also generated by MANAGE. The encircled negative BCRV values will not have a negative effect if the overall Simulation completion date is less than the Planned Finish date from MANAGE. In FIG. 28A, boxes having bold borders indicate the occurrence of a simulated job-start or simulated job-finish. In FIG. 28B, the negative BCRV values identify a simulated overload in a local ATB for a specific Work Center.

### Quantifying Financial Impact

PLAN also quantifies the financial impact in terms of increased Operating Expense (OE) associated with satisfying the additional capacity requirements in the Specified Specific Windows of Time (SWT). In order to accomplish this, PLAN uses the Additional Capacity Requirements identified in “Simulation 3” in conjunction with user defined “Over Time Labor Rates” to compute the corresponding increase in Operating Expense (OE).

Thus, in accordance with the foregoing description, implementing Impact Capacity Planning comprises a method for determining the capacity required to complete work during planned start and finished times. The first step of the method comprises the step of providing a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling. The method further comprises the steps of selecting a particular item that is in a predefined process flow, providing data that represents a planned movement of the selected item along the predefined process flow, identifying all process steps in the predefined process flow through which the selected item must pass, identifying each Reporting Point (RP) in each selected item's predefined process flow, retrieving data that represents the Required Work Content (RWC) of the selected item at each process step along the predefined process flow, determining the Required Work Content (RWC) to completely perform all process steps in the overall process, and providing, for each step of the predefined process flow, an amount of Allocated Time Buffer (ATB) required to accommodate variability associated with completing the Required Work Content (RWC). The next step comprises establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB). The method further comprises the steps of retrieving a document start date-time for each selected item that enters the predefined process flow, retrieving a document finish date-time for each selected item that enters the predefined process flow, utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the baseline planned start date-time and planned finish date-time at each process step in each item's open document's. The method further comprises the step of performing a first simulation that comprises simulating the Required Work Content (RWC) completion forward in time, according to the Work Center (WC) Daily Work Calendar (DWC) designated for the first simulation, by sequencing forward in time from the planned document start date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}). The next step comprises capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance). The next step comprises the step of performing a second simulation that comprises simulating the Required Work Content (RWC) completion backward in time, according to the Work Center (WC) Daily Work Calendar (DWC) designated for the second simulation, by sequencing backward in time from the planned document finish date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time. The next step entails capturing the resulting early document start date-time (global variance) and corresponding Work Center (WC) Reporting Point (RP) negative Buffer Consumption Ratio Variance (−BCRV) values (local variance). The next step comprises the step of performing a third simulation that comprises simulating forward in time the Required Work Content (RWC) completion, according to the Work Center (WC) Daily Work Calendar (DWC) designated for the third simulation, by sequencing forward in time from the planned document start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the first forward-in-time simulation that finished with a negative Buffer Consumption Ratio (−BCR_{FINISH}) into additional capacity requirements in Specific Windows of Time (SWT) for the corresponding Work Center (WC) and the resources associated therewith. The method includes the step of converting additional capacity requirements into financial requirements in accordance with user-defined “Over Time Labor Rates”.

In the foregoing method related to ICP, the step of determining the Time Buffer Remaining (TBR) at each Reporting Point (RP) further comprises the steps of:
A) determining, for each Reporting Point (RP) that is completed, if the Reporting Point (RP) completion date-time is (i) before the Reporting Point's planned start date-time, (ii) between the Reporting Point's planned start date-time and planned finish date-time, (iii) after the Reporting Point's planned finish date-time and before the document planned finish date-time, or (iv) after the document planned finish date-time;
B) computing, for each Reporting Point (RP) that is completed, the Time Buffer Remaining (TBR), if the Reporting Point (RP) completion date-time is (i) before the Reporting Point's planned start date-time, (ii) between the Reporting Point's planned start date-time and planned finish date-time, and (iii) after the Reporting Point's planned finish date-time and before the document planned finish date-time, by summing from the Reporting Point's actual completion date-time the remaining unused planned time for RWC, ATB and STB; and
C) computing, for each Reporting Point (RP) that is completed after the document planned finish date-time, the negative Time Buffer Remaining (TBR) by summing the number of available Daily Work Calendar (DWC) days from the document's planned completion date-time to the Reporting Point's (RP) actual completion date-time and any remaining RWC for those Reporting Points not yet completed.

The foregoing method related to Impact Capacity Planning further comprises the steps of processing the Time Buffer Remaining (TBR) and the Time Buffer (TB) to provide a Buffer Consumption Ratio (BCR), wherein the step of processing comprises the step of implementing in a processing resource the mathematical operation BCR=TBR/TB, and maintaining, for each selected item, an ongoing record of the Buffer Consumption Ratio (BCR) for each document processed at each Reporting Point (RP). The method of achieving Impact Capacity Planning further comprises the steps of processing the extracted transaction data to determine the selected item's simulated movement along the predefined process flow and comparing the simulated movement of the selected item to the planned movement of the selected item through the predefined process flow, determining the variance between the simulated movement of the selected item and the planned movement of the selected item, processing the determined variance to compute the simulated amount of downstream Time Buffer Remaining (TBR) in relation to the total planned Time Buffer (TB), and comparing the simulated amount of downstream Time Buffer Remaining (TBR) to the Planned amount of downstream Time Buffer Remaining (TBRP) at each Reporting Point (RP) and computing the ratio TBR/TBRP wherein said ratio yields a Buffer Recovery Percent (BRP) for the selected item. The method further comprises the steps of computing a Planned Buffer Consumption Ratio (BCRP) based on the Planned amount of downstream Time Buffer Remaining (TBRP) in relation to the total planned Time Buffer (TB), and computing, for each selected item and at each Reporting Point (RP) associated with the selected item, a Planned Buffer Consumption Ratio (BCRP), wherein the step of computing the Planned Buffer Consumption Ratio (BCRP) comprises the step of implementing in the processing resource the mathematical operation BCRP=TBRP/TB. The method includes the step of computing, for each selected item's Open Documents and at each Reporting Point (RP) associated with that selected item, a difference between the Buffer Consumption Ratio (BCR) and the Planned Buffer Consumption Ratio (BCRP), wherein the step of computing the difference between the Buffer Consumption Ratio (BCR) and the Planned Buffer Consumption Ratio (BCRP) comprises the step of implementing in the processing resource the mathematical operation

BCRD_{RPi}=BCR_{RPi}−BCRP_{RPi}

wherein:
“BCR_{RPi}” is the Buffer Consumption Ratio computed at each Reporting Point “i”;
“BCRP_{RPi}” is the Planned Buffer Consumption Ratio computed at each Reporting Point “i”; and
“BCRD_{RPi}” is the difference, at each Reporting Point “i” between the BCR_{RPi} and BCRP_{RPi}.

The method related to Impact Capacity Planning further comprises the steps of computing, for each selected item's Open Documents and at each Reporting Point (RP) associated with that selected item, a Buffer Consumption Ratio Variance (BCRV) relative to the previous Reporting Point in accordance with the formula

BCRV_{RPi}=BCRD_{RPi}−BCRD_{RPi-1}

wherein:
“BCRD_{RPi}” is the difference, at each Reporting Point “i” between the BCR_{RPi} and BCRP_{RPi};
“BCRD_{RPi-1}” is the difference, at each previous Reporting Point “i−1” between the BCR_{RPi} and BCRP_{RPi}; and
“BCRV_{RPi}” is the Buffer Consumption Ratio Variance at each Reporting Point “i”.

The method related to Impact Capacity Planning further comprises the steps of maintaining, for each selected item and at each Reporting Point (RP) associated with the selected item, ongoing BCRD_{RPi} and BCRV_{RPi} records for all documents processed, analyzing BCRV_{RPi} records to rank the Reporting Points (RP) according to the amount of negative variance occurring for reallocation of the Time Buffer (TB) within the process flow and/or to focus additional capacity requirements, and analyzing BCRV_{RPi} records to rank the Reporting Points (RP) according to the amount of positive variance occurring for reallocation and/or reduction of Time Buffer (TB) within the process flow. The method further comprises the steps of maintaining, for each selected item, an ongoing record of the Buffer Consumption Ratio (BCR) for each document processed and finished (BCR_{FINISH}), and analyzing the BCR_{FINISH} records for each item in conjunction with negative BCRV_{RPi} records from each Reporting Point (RP) to further focus local capacity requirements in terms of global outcomes.

### Schedule

The “SCHEDULE” section is directed to particular features and aspects of the present invention such as: (a) scheduling based on Impact Capacity Planning (ICP), (b) producing simulated Global Time Buffer Variance Patterns and their corresponding Local Allocated Time Buffer Variance Patterns, (c) selection of primary Resource DRUM (RDRUM), (d) scheduling primary Resource DRUM (RDRUM), (e) selection of secondary Resource DRUM (RDRUM), and (f) scheduling secondary Resource DRUM (RDRUM).

As stated above, in the SCHEDULE section, scheduling is based on Impact Capacity Planning (ICP). Specifically, the simulated data generated by Impact Capacity Planning (ICP) is used to generate Scheduling information and data. The SCHEDULE section utilizes simulated data generated by several simulations that are described separately in the ensuing description.

### Simulation 1—Global Time Buffer Variance Patterns (Forward in Time)

In this simulation, Global Time Buffer Variance Patterns and their corresponding Local Allocated Time Buffer Variance Patterns are simulated. The simulation starts from the document start date and continues forward in time pushing all Reporting Point (RP) Planned Start Date to Planned Finish Date overloads (−BCRV) occurrences forward in time so as to generate simulated Global Time Buffer Variance Patterns and their corresponding Local Allocated Time Buffer Variance Patterns. In this simulation, Impact Capacity Planning (ICP) uses the same Document Planning process implemented in MANAGE as the baseline for Document Planned Start Dates and Planned Finish Dates and then sequences forward in time through each Reporting Point according to the Resource Calendar designated for simulation, and then captures the Resulting Global and Local Variance Pattern Data and the simulated document finish dates and increased lead times.

### Simulation 2—Global Time Buffer Variance Patterns (Backward in Time)

In this simulation, Impact Capacity Planning (ICP) provides a simulation from the document finish date backward in time pushing all Reporting Point (RP) Planned Start Date to Planned Finish Date overloads (−BCRV) occurrences backward in time so as to produce simulated Global Time Buffer Variance Patterns and their corresponding Local Allocated Time Buffer Variance Patterns. Impact Capacity Planning (ICP) uses the same Document Planning process implemented in MANAGE as the baseline for Document Planned Start Dates and Planned Finish Dates and then sequences backward in time through each Reporting Point according to the Resource Calendar designated for simulation, and then captures the Resulting Global and Local Variance Pattern Data and the simulated document start dates and increased lead times.

### Simulation 3—Additional Capacity Requirements (Forward in Time)

In this simulation, Impact Capacity Planning (ICP) generates a simulation from the document start date forward in time converting all Reporting Point (RP) Planned Start Date to Planned Finish Date overloads (−BCRV) occurrences into additional capacity requirements in specific windows of time for the corresponding Resource Group Name (RGN) and its resources. For this simulation, Impact Capacity Planning (ICP) uses the same Document Planning process as MANAGE as the baseline for Document Planned Start Dates and Planned Finish Dates and then sequences forward in time through each Reporting Point (RP) according to the Resource Calendar designated for simulation, and then captures the Resulting Global and Local Variance Pattern Data and the simulated additional capacity requirement to bring the (−BCRV) values connected to documents having a (−BCR_{FINISH}) in Simulation 1 to zero and the Specific Window of Time (SWT) in which to apply the additional capacity and subsequently select the (Primary) RDRUM.

Primary RDRUM Scheduling

Another important capability of the SCHEDULE section is the Primary RDRUM scheduling via Dependent Setup Optimization in those Specific Windows of Time (SWT) requiring additional capacity and/or customer preference or manual manipulation. Specifically, the Schedule section re-sequences the Primary RDRUM Schedule to reduce the overall time spent on setups during the Specific Windows of Time requiring the simulated additional capacity to bring the (−BCRV) values connected to documents, for all or specific customers, having a (−BCR_{FINISH}) in Simulation 1 to zero. In order to accomplish this, the Schedule section uses the (Primary) RDRUM Simulation 3 additional capacity requirement to bring the (−BCRV) values connected to documents (for all or specific customers) having a (−BCR_{FINISH}) in Simulation 1 to zero in the Specific Window of Time (SWT) in which to apply the additional capacity and/or the dependent set-up matrix to re-sequence work in the Specific Window of Time so as to reduce the capacity required for setups.

The SCHEDULE section includes the capability to hold the (Primary) RDRUM Schedule fixed and generate simulation from the (Primary) RDRUM finish date forward in time pushing all Reporting Point (RP) Planned Start Date to Planned Finish Date overloads (−BCRV) occurrences forward in time and from the (Primary) RDRUM start date backward in time pushing all Reporting Point (RP) Planned Start Date to Planned Finish Date overloads (−BCRV) occurrences backward in time thus producing simulated global (Time Buffer) variance patterns and their corresponding local (Allocated Time Buffer) variance patterns. The SCHEDULE section uses the same document planning process as the MANAGE section as the baseline for document planned start dates and planned finish dates and then sequences forward in time from the (Primary) RDRUM finish date and backward through Time from the (Primary) RDRUM start date through each Reporting Point according to the Resource Calendar designated for Simulation 4 and captures the resulting global and local variance pattern data and the Simulation 4 document finish dates, document start dates and resulting lead times.

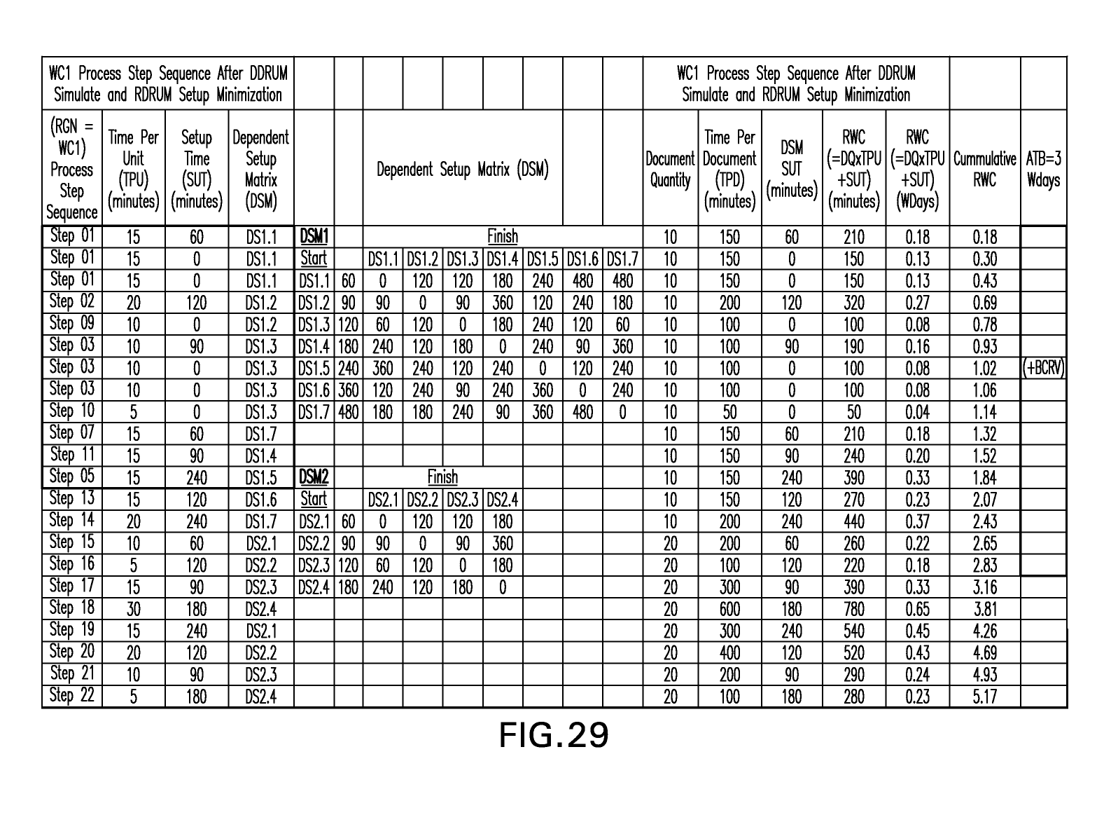

Referring to FIG. 29, there is shown a comparative example, from FIG. 26, of the resulting sequence of process steps on a given RDRUM (i.e., WC1) after DDRUM simulation and RDRUM setup minimization. Overall setup reduction through re-sequencing of work is not part of the PLAN section and requires selection of an RDRUM and is performed in the SCHEDULE section. FIG. 29 shows the resulting sequence of process steps on given RGN (WC1) after overall setup reduction. It also shows where a particular process step (Step 03) is no longer projected to finish with a negative BCRV. It also shows more jobs being completed in the same three day ATB as a result of less time being spent on Setup.

### Secondary Resource DRUM (RDRUM) Selection

The SCHEDULE section of the method of the present invention also has the capability to hold the (Primary) RDRUM schedule fixed and Simulation 5 from the (Primary) RDRUM finish date forward in time converting all Reporting Point (RP) Planned Start Date to Planned Finish Date overload (−BCRV) occurrences into additional capacity requirements in Specific Windows of Time for the RGN and its resources and from the (Primary) RDRUM start date backward in time converting all Reporting Point (RP) Planned Start Date to Planned Finish Date overload (−BCRV) occurrences into additional capacity requirements in Specific Windows of Time for the corresponding RGN and its resources. The SCHEDULE section uses the same document planning process as the MANAGE section as the baseline for document planned start dates and planned finish dates and then sequences forward in time from the (Primary) RDRUM finish date and backward through time from the (Primary) RDRUM start date through each Reporting Point (RP) according to the Resource Calendar designated for the simulation and captures the resulting global and local variance pattern data and the Simulation 5 additional capacity requirement to bring the (−BCRV) values connected to documents (for all or for specific customers) having a (−BCR_{FINISH}) or an early document start date-time in Simulation 4 to zero and the Specific Window of Time (SWT) in which to apply the additional capacity and subsequently select the (Secondary) RDRUM.

### Secondary RDRUM Scheduling

The SCHEDULE section further includes the capability to hold the (Primary) RDRUM schedule fixed and re-sequence the (Secondary) RDRUM schedule to reduce the overall time spent on setups during the Specific Windows of Time requiring the simulated additional capacity to bring the (−BCRV) values connected to documents (for all or for specific customers) having a (−BCR_{FINISH}) in Simulation 4 to zero. The SCHEDULE section uses the (Secondary) RDRUM Simulation 5 additional capacity requirement to bring the (−BCRV) values connected to documents (for all or for specific customers) having a (−BCR_{FINISH}) in Simulation 4 to zero and the Specific Window of Time (SWT) in which to apply the additional capacity and/or (the dependent setup matrix) to re-sequence work in the Specific Window of Time so as to reduce the capacity required for setups. When re-sequencing the (Secondary) RDRUM, those process steps that have a preceding process step on the (Primary) RDRUM can only be re-sequenced forward in time while those process steps that have a succeeding process step on the (Primary) RDRUM can only be re-sequenced backward in time.

The SCHEDULE section further comprises the capability to hold the (Primary and Secondary) RDRUM Schedules fixed and Simulation 6 from the (Primary and Secondary) RDRUM finish date forward in time pushing all Reporting Point (RP) Planned Start Date to Planned Finish Date overloads (−BCRV) occurrences forward in time and from the (Primary and Secondary) RDRUM start date backward in time pushing all Reporting Point (RP) Planned Start Date to Planned Finish Date overloads (−BCRV) occurrences backward in time thus producing simulated global (Time Buffer) variance patterns and their corresponding local (Time Buffer) variance patterns. The SCHEDULE section also uses the same document planning process as the MANAGE section as the baseline for document planned start dates and planned finish dates and then sequences forward in time from the (Primary and Secondary) RDRUM finish date and backward through time from the (Primary and Secondary) RDRUM start date through each Reporting Point (RP) according to the Resource Calendar designated for simulation and captures the resulting global and local variance pattern data and the Simulation 6 document finish dates, document start dates and resulting lead times.

### Determination of Remaining RGN and Resources Additional Capacity Requirement

The SCHEDULE section further comprises the ability to hold the (Primary and Secondary) RDRUM schedule fixed and Simulation 7 from the (Primary and Secondary) RDRUM finish date forward in time converting all Reporting Point (RP) Planned Start Date to Planned Finish Date overload (−BCRV) occurrences into additional capacity requirements in Specific Windows of Time for the RGN and its resources and from the (Primary and Secondary) RDRUM start date backward in time converting all Reporting Point (RP) Planned Start Date to Planned Finish Date overload (−BCRV) occurrences into additional capacity requirements in Specific Windows of Time for the corresponding RGN and its resources. The SCHEDULE section also uses the same document planning process as the MANAGE section as the baseline for document planned start dates and planned finish dates and then sequences forward in time from the (Primary and Secondary) RDRUM finish date and backward through time from the (Primary and Secondary) RDRUM start date through each Reporting Point (RP) according to the Resource Calendar designated for Simulation 7 and captures the resulting global and local variance pattern data and the Simulation 7 additional capacity requirement to bring the (−BCRV) values connected to documents (for all or for specific customers) having a (−BCR_{FINISH}) or and early document start date-time in Simulation 6 to zero and the Specific Window of Time in which to apply the additional capacity and subsequently defines the additional capacity requirements for all remaining RGN and their resources.

Thus, in accordance with the foregoing description, in order to implement the Schedule aspect of the present invention, a method is provided which determines the capacity required to complete work during planned start and finished times. The first step of the method is to provide a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling. The method further comprises the steps of selecting a particular item that is in a predefined process flow, providing data that represents a planned movement of the selected item along the predefined process flow, identifying all process steps in the predefined process flow through which the selected item must pass, identifying each Reporting Point (RP) in each selected item's predefined process flow, retrieving data that represents the Required Work Content (RWC) of the selected item at each process step along the predefined process flow, determining the Required Work Content (RWC) to completely perform all process steps in the overall process, and providing, for each step of the predefined process flow, an amount of Allocated Time Buffer (ATB) required to accommodate variability associated with completing the Required Work Content (RWC). The next step in the method is to establish for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB). The method further comprises the steps of retrieving a document start date-time for each selected item that enters the predefined process flow, retrieving a document finish date-time for each selected item that enters the predefined process flow and utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the baseline planned start date-time and planned finish date-time at each process step in each item's open document's. The next step is to perform a first simulation comprising the step of simulating the Required Work Content (RWC) completion forward in time, according to the Work Center (WC) Daily Work Calendar (DWC) designated for the first simulation, by sequencing forward in time from the planned document start date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}). The next step comprises capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance). The next step of this method is to perform a second simulation comprising the step of simulating the Required Work Content (RWC) completion backward in time, according to the Work Center (WC) Daily Work Calendar (DWC) designated for the second simulation, by sequencing backward in time from the planned document finish date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time. The next step entails capturing the resulting early document start date-time (global variance) and corresponding Work Center (WC) Reporting Point (RP) negative Buffer Consumption Ratio Variance (−BCRV) values (local variance). The next step comprises performing a third simulation comprising the step of simulating forward in time the Required Work Content (RWC) completion, according to the Work Center (WC) Daily Work Calendar (DWC) designated for the third simulation, by sequencing forward in time from the planned document start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the first forward-in-time simulation that finished with a negative Buffer Consumption Ratio (−BCR_{FINISH}) into additional capacity requirements in Specific Windows of Time (SWT) for the corresponding Work Center (WC) and the resources associated therewith. The next step of this method is to convert additional capacity requirements into identification of the Primary Resource DRUM (RDRUM). The method further comprises the step of re-sequencing Required Work Content (RWC) on the Primary RDRUM, utilizing the user defined Dependent Setup Matrix (DSM) information, to reduce the overall time spent on setups during the Specific Windows of Time (SWT) requiring additional simulated capacity to bring the negative Buffer Consumption Ratio (−BCRV) values computed in the third simulation connected to documents (for all or specific customers) finishing with a negative Buffer Consumption Ratio (−BCR_{FINISH}) in the first simulation to zero. The next step is to hold the (Primary) Resource DRUM (RDRUM) schedule fixed and performing a fourth simulation that comprises the step of simulating the Required Work Content (RWC) completion, according to the Work Center (WC) Daily Work Calendar (DWC) designated for the fourth simulation, by sequencing forward in time from the scheduled RDRUM finish date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}) and by sequencing backward in time from the scheduled RDRUM start date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time. The method further comprises the steps of capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance), and capturing the resulting early document start date-time (global variance) and corresponding Work Center (WC) Reporting Point (RP) negative Buffer Consumption Ratio Variance (−BCRV) values (local variance). The next step comprises holding the Primary Resource DRUM (RDRUM) schedule fixed and performing a fifth simulation comprising the step of simulating the Required Work Content (RWC) completion, according to the Work Center (WC) Daily Work Calendar (DWC) designated for the fifth simulation, by sequencing forward in time from the scheduled RDRUM finish date-time and backward in time from the scheduled RDRUM start date-time through each Reporting Point (RP) in each item's open documents and converting all Reporting Point (RP) planned start date-time to planned finish date-time overloads as computed by the corresponding negative Buffer Consumption Ratio Variance (−BCRV) values that are associated with documents in the fourth simulation (Primary RDRUM forward/backward in time simulation) that finished with a negative Buffer Consumption Ratio (−BCR_{FINISH}) or an early document start into additional capacity requirements in Specific Windows of Time (SWT) for the corresponding Work Center (WC) and the resources associated therewith.

In the next step, additional capacity requirements are converted into identification of the Secondary Resource DRUM (RDRUM). The next step entails holding the Primary Resource DRUM (RDRUM) schedule fixed and re-sequencing Required Work Content (RWC) on the Secondary RDRUM. This step utilizes the user defined Dependent Setup Matrix (DSM) information to reduce the overall time spent on setups during the Specific Windows of Time (SWT) requiring additional simulated capacity in order to bring to zero the negative Buffer Consumption Ratio (−BCRV) values computed in the fifth simulation which were associated with documents (for all or specific customers) finishing with a negative Buffer Consumption Ratio (−BCR_{FINISH}) or an early document start date-time in the fourth simulation. The process steps on the Secondary RDRUM having preceding steps on the Primary RDRUM are only re-sequenced forward in time while those process steps on the Secondary RDRUM having succeeding steps on the Primary RDRUM are only re-sequenced backward in time.

The next step comprises holding the Primary and Secondary Resource DRUM (RDRUM) schedules fixed and performing a sixth simulation which comprises simulating the Required Work Content (RWC) completion, according to the Work Center (WC) Daily Work Calendar (DWC) designated for the sixth simulation. The sixth simulation is accomplished by sequencing forward in time from the scheduled Primary and Secondary RDRUM finish date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}) and by sequencing backward in time from the scheduled Primary and Secondary RDRUM start date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time.

The method further comprises the steps of capturing the resulting late document finish date-time, negative Buffer Consumption Ratio (−BCR_{FINISH}) and corresponding Work Center (WC) Reporting Point (RP) negative Buffer Consumption Ratio Variance (−BCRV) values, capturing the resulting early document start date-time and corresponding Work Center (WC) Reporting Point (RP) negative Buffer Consumption Ratio Variance (−BCRV) values, and holding the Primary and Secondary Resource DRUM (RDRUM) schedules fixed and performing a seventh simulation which comprises the steps of simulating the Required Work Content (RWC) completion, according to the Work Center (WC) Daily Work Calendar (DWC) designated for the seventh simulation. The seventh simulation is accomplished by sequencing forward in time from the Primary and Secondary scheduled RDRUM finish date-time and backward in time from the Primary and Secondary scheduled RDRUM start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the sixth simulation that finished with a negative Buffer Consumption Ratio (−BCR_{FINISH}) or an early document start into additional capacity requirements in Specific Windows of Time (SWT) for the corresponding Work Center (WC) and the resources associated therewith.

The step of determining the Time Buffer Remaining (TBR) at each Reporting Point (RP) further comprises the steps of determining, for each Reporting Point (RP) that is completed, if the Reporting Point (RP) completion date-time is (i) before the Reporting Point's planned start date-time, (ii) between the Reporting Point's planned start date-time and planned finish date-time, (iii) after the Reporting Point's planned finish date-time and before the document planned finish date-time, or (iv) after the document planned finish date-time. The next steps comprise computing, for each Reporting Point (RP) that is completed, the Time Buffer Remaining (TBR), if the Reporting Point (RP) completion date-time is (i) before the Reporting Point's planned start date-time, (ii) between the Reporting Point's planned start date-time and planned finish date-time, and (iii) after the Reporting Point's planned finish date-time and before the document planned finish date-time, by summing from the Reporting Point's actual completion date-time the remaining unused planned time for RWC, ATB and STB, and computing, for each Reporting Point (RP) that is completed after the document planned finish date-time, the negative Time Buffer Remaining (TBR) by summing the number of available Daily Work Calendar (DWC) days from the document's planned completion date-time to the Reporting Point's (RP) actual completion date-time and any remaining RWC for those Reporting Points not yet completed.

The next step in implementing the SCHEDULE section is processing the Time Buffer Remaining (TBR) and the Time Buffer (TB) to provide a Buffer Consumption Ratio (BCR), wherein the step of processing comprises the step of implementing in a processing resource the mathematical operation BCR=TBR/TB.

The next step entails maintaining, for each selected item, an ongoing record of the Buffer Consumption Ratio (BCR) for each document processed at each Reporting Point (RP).

The method of implementing the schedule section further comprises the steps of processing the extracted transaction data to determine the selected item's simulated movement along the predefined process flow and comparing the simulated movement of the selected item to the planned movement of the selected item through the predefined process flow, determining the variance between the simulated movement of the selected item and the planned movement of the selected item, processing the determined variance to compute the simulated amount of downstream Time Buffer Remaining (TBR) in relation to the total planned Time Buffer (TB), and comparing the simulated amount of downstream Time Buffer Remaining (TBR) to the Planned amount of downstream Time Buffer Remaining (TBRP) at each Reporting Point (RP) and computing the ratio TBR/TBRP wherein said ratio yields a Buffer Recovery Percent (BRP) for the selected item.

The method further comprises the steps of computing a Planned Buffer Consumption Ratio (BCRP) based on the Planned amount of downstream Time Buffer Remaining (TBRP) in relation to the total planned Time Buffer (TB), and computing, for each selected item and at each Reporting Point (RP) associated with the selected item, a Planned Buffer Consumption Ratio (BCRP). The step of computing the Planned Buffer Consumption Ratio (BCRP) comprises the step of implementing in the processing resource the mathematical operation BCRP=TBRP/TB.

The method further comprises the step of computing, for each selected item's Open Documents and at each Reporting Point (RP) associated with that selected item, a difference between the Buffer Consumption Ratio (BCR) and the Planned Buffer Consumption Ratio (BCRP). The step of computing the difference between the Buffer Consumption Ratio (BCR) and the Planned Buffer Consumption Ratio (BCRP) comprises the step of implementing in the processing resource the mathematical operation

BCRD_{RPi}=BCR_{RPi}−BCRP_{RPi}

wherein:
“BCR_{RPi}” is the Buffer Consumption Ratio computed at each Reporting Point “i”;
“BCRP_{RPi}” is the Planned Buffer Consumption Ratio computed at each Reporting Point “i”; and
“BCRD_{RPi}” is the difference, at each Reporting Point “i” between the BCR_{RPi} and BCRP_{RPi}.

The next step comprises computing, for each selected item's Open Documents and at each Reporting Point (RP) associated with that selected item, a Buffer Consumption Ratio Variance (BCRV) relative to the previous Reporting Point in accordance with the formula

BCRV_{RPi}=BCRD_{RPi}−BCRD_{RPi-1}

wherein:
“BCRD_{RPi}” is the difference, at each Reporting Point “i” between the BCR_{RPi} and BCRP_{RPi};
“BCRD_{RPi-1}” is the difference, at each previous Reporting Point “i−1” between the BCR_{RPi} and BCRP_{RPi}; and
“BCRV_{RPi}” is the Buffer Consumption Ratio Variance at each Reporting Point “i”.

The next step in this method is to maintain, for each selected item and at each Reporting Point (RP) associated with the selected item, ongoing BCRD_{RPi} and BCRV_{RPi} records for all documents processed.

The method further comprises the steps of analyzing BCRV_{RPi} records to rank the Reporting Points (RP) according to the amount of negative variance occurring for reallocation of the Time Buffer (TB) within the process flow and/or to focus additional capacity requirements, and analyzing BCRV_{RPi} records to rank the Reporting Points (RP) according to the amount of positive variance occurring for reallocation and/or reduction of Time Buffer (TB) within the process flow.

The method further comprises the steps of maintaining, for each selected item, an ongoing record for the Buffer Consumption Ratio (BCR) for each document processed and finished (BCR_{FINISH}), and analyzing the BCR_{FINISH} records for each item in conjunction with negative BCRV_{RPi} records from each Reporting Point (RP) to further focus local capacity requirements in terms of global outcomes.

While the present invention has been described in the context of a fully functioning data processing system and method, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disc drive, RAM, and CD-ROMs as well as transmission-type media such as digital and analog communication links.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the invention.

In any case, because the scope of the invention is much broader than any particular embodiment, the foregoing detailed description should not be construed as a limitation of the present invention, which is limited only by the claims appended hereto.

What is claimed is:

1. A method for determining the capacity required to complete work during planned start and finished times comprising the steps of:
providing a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling;
selecting a particular item that is in a predefined process flow;
providing data that represents a planned movement of the selected item along the predefined process flow;
identifying all process steps in the predefined process flow through which the selected item must pass;
identifying each Reporting Point (RP) in each selected item's predefined process flow;
retrieving data that represents the Required Work Content (RWC) of the selected item at each process step along the predefined process flow;
determining the Required Work Content (RWC) to completely perform all process steps in the overall process;
providing, for each step of the predefined process flow, an amount of Allocated Time Buffer (ATB) required to accommodate variability associated with completing the Required Work Content (RWC);
establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB);
retrieving a document start date-time for each selected item that enters the predefined process flow;
retrieving a document finish date-time for each selected item that enters the predefined process flow;
utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the planned start date-time and planned finish date-time at each process step in each item's open document's;
utilizing the Resource Group Name (RGN) representing the Work Center (WC) and the corresponding Work Center (WC) Daily Work Calendar (DWC), Required Work Content (RWC), Allocated Time Buffers (ATB) and document finish date-time to establish the planned start date-time and planned finish date-time at each process step in each item's open document's; and
utilizing the resources in the Resource Group Name (RGN) representing the Work Center (WC) and the corresponding Work Center (WC) Daily Work Calendar (DWC) to map resource loading at each process step within each open document in accordance with the established planned start date-time and planned finish date-time at each process step to identify any local Allocated Time Buffer (ATB) overloads corresponding to any of the Work Centers (WC) and the resources associated therewith.

2. A method for determining the capacity required to complete work during planned start and finished times comprising the steps of:
providing a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling;
selecting a particular item that is in a predefined process flow;
providing data that represents a planned movement of the selected item along the predefined process flow;
identifying all process steps in the predefined process flow through which the selected item must pass;
identifying each Reporting Point (RP) in each selected item's predefined process flow;
retrieving data that represents the Required Work Content (RWC) of the selected item at each process step along the predefined process flow;
determining the Required Work Content (RWC) to completely perform all process steps in the overall process;
providing, for each step of the predefined process flow, an amount of Allocated Time Buffer (ATB) required to accommodate variability associated with completing the Required Work Content (RWC);
establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB);
retrieving a document start date-time for each selected item that enters the predefined process flow;
retrieving a document finish date-time for each selected item that enters the predefined process flow;
utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the baseline planned start date-time and planned finish date-time at each process step in each item's open document's;
performing a first simulation that comprises simulating the Required Work Content (RWC) completion forward in time, according to the Work Center (WC) Daily Work Calendar (DWC) designated for the first simulation, by sequencing forward in time from the planned document start date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH});
capturing the resulting late document finish date-time (global variance), negative Buffer Consumption Ratio (−BCR_{FINISH}) and corresponding Work Center (WC) Reporting Point (RP) negative Buffer Consumption Ratio Variance (−BCRV) values (local variance);
performing a second simulation that comprises simulating the Required Work Content (RWC) completion backward in time, according to the Work Center (WC) Daily Work Calendar (DWC) designated for the second simulation, by sequencing backward in time from the planned document finish date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time;
capturing the resulting early document start date-time (global variance) and corresponding Work Center (WC) Reporting Point (RP) negative Buffer Consumption Ratio Variance (−BCRV) values (local variance);
performing a third simulation comprising simulating forward in time the Required Work Content (RWC) completion, according to the Work Center (WC) Daily Work Calendar (DWC) designated for the third simulation, by sequencing forward in time from the planned document start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the first forward-in-time simulation that finished with a negative Buffer Consumption Ratio (−BCR_{FINISH}) into additional capacity requirements in Specific Windows of Time (SWT) for the corresponding Work Center (WC) and the resources associated therewith; and
converting additional capacity requirements into financial requirements in accordance with user-defined “Over Time Labor Rates”.

3. The method according to claim 2 wherein the step of determining the Time Buffer Remaining (TBR) at each Reporting Point (RP) further comprises the steps of:
determining, for each Reporting Point (RP) that is completed, if the Reporting Point (RP) completion date-time is (i) before the Reporting Point's planned start date-time, (ii) between the Reporting Point's planned start date-time and planned finish date-time, (iii) after the Reporting Point's planned finish date-time and before the document planned finish date-time, or (iv) after the document planned finish date-time;
computing, for each Reporting Point (RP) that is completed, the Time Buffer Remaining (TBR), if the Reporting Point (RP) completion date-time is (i) before the Reporting Point's planned start date-time, (ii) between the Reporting Point's planned start date-time and planned finish date-time, and (iii) after the Reporting Point's planned finish date-time and before the document planned finish date-time, by summing from the Reporting Point's actual completion date-time the remaining unused planned time for RWC, ATB and STB; and
computing, for each Reporting Point (RP) that is completed after the document planned finish date-time, the negative Time Buffer Remaining (TBR) by summing the number of available Daily Work Calendar (DWC) days from the document's planned completion date-time to the Reporting Point's (RP) actual completion date-time and any remaining RWC for those Reporting Points not yet completed.

4. The method according to claim 3 further comprising the step of processing the Time Buffer Remaining (TBR) and the Time Buffer (TB) to provide a Buffer Consumption Ratio (BCR), wherein the step of processing comprises the step of implementing in a processing resource the mathematical operation BCR=TBR/TB.

5. The method according to claim 4 further comprising the step of maintaining, for each selected item, an ongoing record of the Buffer Consumption Ratio (BCR) for each document processed at each Reporting Point (RP).

6. The method according to claim 5 further comprising the steps of:
processing the extracted transaction data to determine the selected item's simulated movement along the predefined process flow and comparing the simulated movement of the selected item to the planned movement of the selected item through the predefined process flow;
determining the variance between the simulated movement of the selected item and the planned movement of the selected item;
processing the determined variance to compute the simulated amount of downstream Time Buffer Remaining (TBR) in relation to the total planned Time Buffer (TB);
comparing the simulated amount of downstream Time Buffer Remaining (TBR) to the Planned amount of downstream Time Buffer Remaining (TBRP) at each Reporting Point (RP) and computing the ratio TBR/TBRP wherein said ratio yields a Buffer Recovery Percent (BRP) for the selected item.

7. The method according to claim 2 further comprising the step of computing a Planned Buffer Consumption Ratio (BCRP) based on the Planned amount of downstream Time Buffer Remaining (TBRP) in relation to the total planned Time Buffer (TB).

8. The method according to claim 7 further comprising the steps of computing, for each selected item and at each Reporting Point (RP) associated with the selected item, a Planned Buffer Consumption Ratio (BCRP).

9. The method according to claim 8 wherein the step of computing the Planned Buffer Consumption Ratio (BCRP) comprises the step of implementing in the processing resource the mathematical operation BCRP=TBRP/TB.

10. The method according to claim 9 further comprising the step of computing, for each selected item's Open Documents and at each Reporting Point (RP) associated with that selected item, a difference between the Buffer Consumption Ratio (BCR) and the Planned Buffer Consumption Ratio (BCRP).

11. The method according to claim 10 wherein the step of computing the difference between the Buffer Consumption Ratio (BCR) and the Planned Buffer Consumption Ratio (BCRP) comprises the step of implementing in the processing resource the mathematical operation
BCRD_{RPi}=BCR_{RPi}−BCRP_{RPi}
wherein:
“BCR_{RPi}” is the Buffer Consumption Ratio computed at each Reporting Point “i”;
“BCRP_{RPi}” is the Planned Buffer Consumption Ratio computed at each Reporting Point “i”; and
“BCRD_{RPi}” is the difference, at each Reporting Point “i” between the BCR_{RPi} and BCRP_{RPi}.

12. The method according to claim 11 further comprising the steps of computing, for each selected item's Open Documents and at each Reporting Point (RP) associated with that selected item, a Buffer Consumption Ratio Variance (BCRV) relative to the previous Reporting Point in accordance with the formula
BCRV_{RPi}=BCRD_{RPi}−BCRD_{RPi-1}
wherein:
“BCRD_{RPi}” is the difference, at each Reporting Point “i” between the BCR_{RPi} and BCRP_{RPi};
“BCRD_{RPi-1}” is the difference, at each previous Reporting Point “i−1” between the BCR_{RPi}^{and} BCRP_{RPi}; and
“BCRV_{RPi}” is the Buffer Consumption Ratio Variance at each Reporting Point “i”.

13. The method according claim 12 further comprising the step of maintaining, for each selected item and at each Reporting Point (RP) associated with the selected item, ongoing BCRD_{RPi} and BCRV_{RPi} records for all documents processed.

14. The method according to claim 13 further comprising the steps of:
analyzing BCRV_{RPi} records to rank the Reporting Points (RP) according to the amount of negative variance occurring for reallocation of the Time Buffer (TB) within the process flow and/or to focus additional capacity requirements; and
analyzing BCRV_{RPi} records to rank the Reporting Points (RP) according to the amount of positive variance occurring for reallocation and/or reduction of Time Buffer (TB) within the process flow.

15. The method according to claim 14 further comprising the steps of:
maintaining, for each selected item, an ongoing record of the Buffer Consumption Ratio (BCR) for each document processed and finished (BCR_{FINISH}); and
maintaining, for each completed document, an ongoing record of the Buffer Consumption Ratio (BCR) for each document processed and finished (BCR_{FINISH}).

16. The method according to claim 15 further comprising the step of analyzing the BCR_{FINISH} records for each item in conjunction with negative BCRV_{RPi} records from each Reporting Point (RP) to further focus local capacity requirements in terms of global outcomes.

17. A method for determining the capacity required to complete work during planned start and finished times comprising the steps of:
providing a plurality of Resource Group Names (RGN), wherein each Resource Group Name (RGN) represents a particular Work Center (WC) having predetermined resources associated therewith, wherein the predetermined resources include equipment, operators, set-up person(s), fixtures and tooling;
selecting a particular item that is in a predefined process flow;
providing data that represents a planned movement of the selected item along the predefined process flow;
identifying all process steps in the predefined process flow through which the selected item must pass;
identifying each Reporting Point (RP) in each selected item's predefined process flow;
retrieving data that represents the Required Work Content (RWC) of the selected item at each process step along the predefined process flow;
determining the Required Work Content (RWC) to completely perform all process steps in the overall process;
providing, for each step of the predefined process flow, an amount of Allocated Time Buffer (ATB) required to accommodate variability associated with completing the Required Work Content (RWC);
establishing for each process step and Reporting Point (RP), using the designated Resource Group Name (RGN) representing the Work Center (WC), a Daily Work Calendar (DWC) which is used for assigning Required Work Content (RWC) and Allocated Time Buffer (ATB);
retrieving a document start date-time for each selected item that enters the predefined process flow;
retrieving a document finish date-time for each selected item that enters the predefined process flow;
utilizing the Resource Group Name (RGN) representing the Work Center (WC) and the corresponding Work Center (WC) Daily Work Calendar (DWC), Required Work Content (RWC), Allocated Time Buffers (ATB) and document start date-time to establish the baseline planned start date-time and planned finish date-time at each process step in each item's open document's;
performing a first simulation comprising the step of simulating the Required Work Content (RWC) completion forward in time, according to the Work Center (WC) Daily Work Calendar (DWC) designated for the first simulation, by sequencing forward in time from the planned document start date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH});
capturing the resulting late document finish date-time, negative Buffer Consumption Ratio (−BCR_{FINISH}) and corresponding Work Center (WC) Reporting Point (RP) negative Buffer Consumption Ratio Variance (−BCRV) values;
performing a second simulation comprising the step of simulating the Required Work Content (RWC) completion backward in time, according to the Work Center (WC) Daily Work Calendar (DWC) designated for the second simulation, by sequencing backward in time from the planned document finish date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time;
capturing the resulting early document start date-time and corresponding Work Center (WC) Reporting Point (RP) negative Buffer Consumption Ratio Variance (−BCRV) values;
performing a third simulation comprising the step of simulating forward in time the Required Work Content (RWC) completion, according to the Work Center (WC) Daily Work Calendar (DWC) designated for the third simulation, by sequencing forward in time from the planned document start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the first forward-in-time simulation that finished with a negative Buffer Consumption Ratio (−BCR_{FINISH}) into additional capacity requirements in Specific Windows of Time (SWT) for the corresponding Work Center (WC) and the resources associated therewith;
converting additional capacity requirements into identification of the Primary Resource DRUM (RDRUM);
re-sequencing Required Work Content (RWC) on the Primary RDRUM, utilizing the user defined Dependent Setup Matrix (DSM) information, to reduce the overall time spent on setups during the Specific Windows of Time (SWT) requiring additional simulated capacity to bring the negative Buffer Consumption Ratio (−BCRV) values computed in the third simulation connected to documents (for all or specific customers) finishing with a negative Buffer Consumption Ratio (−BCR_{FINISH}) in the first simulation to zero;
holding the (Primary) Resource DRUM (RDRUM) schedule fixed and performing a fourth simulation that comprises the step of simulating the Required Work Content (RWC) completion, according to the Work Center (WC) Daily Work Calendar (DWC) designated for the fourth simulation, by sequencing forward in time from the scheduled RDRUM finish date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}) and by sequencing backward in time from the scheduled RDRUM start date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time;
capturing the resulting late document finish date-time, negative Buffer Consumption Ratio (−BCR_{FINISH}) and corresponding Work Center (WC) Reporting Point (RP) negative Buffer Consumption Ratio Variance (−BCRV) values;
capturing the resulting early document start date-time and corresponding Work Center (WC) Reporting Point (RP) negative Buffer Consumption Ratio Variance (−BCRV) values; and
holding the Primary Resource DRUM (RDRUM) schedule fixed and performing a fifth simulation comprising the step of simulating the Required Work Content (RWC) completion, according to the Work Center (WC) Daily Work Calendar (DWC) designated for the fifth simulation, by sequencing forward in time from the scheduled RDRUM finish date-time and backward in time from the scheduled RDRUM start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the fourth simulation that finished with a negative Buffer Consumption Ratio (−BCR_{FINISH}) or an early document start into additional capacity requirements in Specific Windows of Time (SWT) for the corresponding Work Center (WC) and the resources associated therewith.

18. The method according to claim 17 further comprising the steps of:
converting additional capacity requirements into identification of the Secondary Resource DRUM (RDRUM);
holding the Primary Resource DRUM (RDRUM) schedule fixed and re-sequencing Required Work Content (RWC) on the Secondary RDRUM, utilizing the user defined Dependent Setup Matrix (DSM) information, to reduce the overall time spent on setups during the Specific Windows of Time (SWT) requiring additional simulated capacity to bring the negative Buffer Consumption Ratio (−BCRV) values computed in the fifth simulation, connected to documents (for all or specific customers) finishing with a negative Buffer Consumption Ratio (−BCR_{FINISH}) or an early document start date-time in the fourth simulation to zero, wherein process steps on the Secondary RDRUM having preceding steps on the Primary RDRUM can only be re-sequenced forward in time while those process steps on the Secondary RDRUM having succeeding steps on the Primary RDRUM can only be re-sequenced backward in time;
holding the Primary and Secondary Resource DRUM (RDRUM) schedules fixed and performing a sixth simulation which comprises simulating the Required Work Content (RWC) completion, according to the Work Center (WC) Daily Work Calendar (DWC) designated for the sixth simulation, by sequencing forward in time from the scheduled Primary and Secondary RDRUM finish date-time through each Reporting Point (RP) in each item's open documents and pushing forward in time all Reporting Point (RP) planned start date-time to planned finish date-time overloads as computed by the corresponding negative Buffer Consumption Ratio Variance (−BCRV) values to determine the resulting document completion date-time, as computed by the Buffer Consumption Ratio (BCR_{FINISH}) and by sequencing backward in time from the scheduled Primary and Secondary RDRUM start date-time through each Reporting Point (RP) in each item's open documents and pushing backward in time all Reporting Point (RP) planned start date-time to planned finish date-time overloads as computed by the corresponding negative Buffer Consumption Ratio Variance (−BCRV) values to determine the resulting document start date-time;
capturing the resulting late document finish date-time, negative Buffer Consumption Ratio (−BCR_{FINISH}) and corresponding Work Center (WC) Reporting Point (RP) negative Buffer Consumption Ratio Variance (−BCRV) values;
capturing the resulting early document start date-time and corresponding Work Center (WC) Reporting Point (RP) negative Buffer Consumption Ratio Variance (−BCRV) values; and
holding the Primary and Secondary Resource DRUM (RDRUM) schedules fixed and performing a seventh simulation comprising the steps of simulating the Required Work Content (RWC) completion, according to the Work Center (WC) Daily Work Calendar (DWC) designated for the seventh simulation, by sequencing forward in time from the Primary and Secondary scheduled RDRUM finish date-time and backward in time from the Primary and Secondary scheduled RDRUM start date-time through each Reporting Point (RP) in each item's open documents and converting all Reporting Point (RP) planned start date-time to planned finish date-time overloads as computed by the corresponding negative Buffer Consumption Ratio Variance (−BCRV) values connected to documents in the sixth simulation that finished with a negative Buffer Consumption Ratio (−BCR_{FINISH}) or an early document start into additional capacity requirements in Specific Windows of Time (SWT) for the corresponding Work Center (WC) and the resources associated therewith.

19. The method according to claim 17 wherein the step of determining the Time Buffer Remaining (TBR) at each Reporting Point (RP) further comprises the steps of:
determining, for each Reporting Point (RP) that is completed, if the Reporting Point (RP) completion date-time is (i) before the Reporting Point's planned start date-time, (ii) between the Reporting Point's planned start date-time and planned finish date-time, (iii) after the Reporting Point's planned finish date-time and before the document planned finish date-time, or (iv) after the document planned finish date-time;
computing, for each Reporting Point (RP) that is completed, the Time Buffer Remaining (TBR), if the Reporting Point (RP) completion date-time is (i) before the Reporting Point's planned start date-time, (ii) between the Reporting Point's planned start date-time and planned finish date-time, and (iii) after the Reporting Point's planned finish date-time and before the document planned finish date-time, by summing from the Reporting Point's actual completion date-time the remaining unused planned time for RWC, ATB and STB; and
computing, for each Reporting Point (RP) that is completed after the document planned finish date-time, the negative Time Buffer Remaining (TBR) by summing the number of available Daily Work Calendar (DWC) days from the document's planned completion date-time to the Reporting Point's (RP) actual completion date-time and any remaining RWC for those Reporting Points not yet completed.

20. The method according to claim 19 further comprising the step of processing the Time Buffer Remaining (TBR) and the Time Buffer (TB) to provide a Buffer Consumption Ratio (BCR), wherein the step of processing comprises the step of implementing in a processing resource the mathematical operation BCR=TBR/TB.

21. The method according to claim 20 further comprising the step of maintaining, for each selected item, an ongoing record of the Buffer Consumption Ratio (BCR) for each document processed at each Reporting Point (RP).

22. The method according to claim 21 further comprising the steps of:
processing the extracted transaction data to determine the selected item's simulated movement along the predefined process flow and comparing the simulated movement of the selected item to the planned movement of the selected item through the predefined process flow;
determining the variance between the simulated movement of the selected item and the planned movement of the selected item;
processing the determined variance to compute the simulated amount of downstream Time Buffer Remaining (TBR) in relation to the total planned Time Buffer (TB); and
comparing the simulated amount of downstream Time Buffer Remaining (TBR) to the Planned amount of downstream Time Buffer Remaining (TBRP) at each Reporting Point (RP) and computing the ratio TBR/TBRP wherein said ratio yields a Buffer Recovery Percent (BRP) for the selected item.

23. The method according to claim 17 further comprising the step of computing a Planned Buffer Consumption Ratio (BCRP) based on the Planned amount of downstream Time Buffer Remaining (TBRP) in relation to the total planned Time Buffer (TB).

24. The method according to claim 23 further comprising the steps of computing, for each selected item and at each Reporting Point (RP) associated with the selected item, a Planned Buffer Consumption Ratio (BCRP).

25. The method according to claim 24 wherein the step of computing the Planned Buffer Consumption Ratio (BCRP) comprises the step of implementing in the processing resource the mathematical operation BCRP=TBRP/TB.

26. The method according to claim 25 further comprising the step of computing, for each selected item's Open Documents and at each Reporting Point (RP) associated with that selected item, a difference between the Buffer Consumption Ratio (BCR) and the Planned Buffer Consumption Ratio (BCRP).

27. The method according to claim 26 wherein the step of computing the difference between the Buffer Consumption Ratio (BCR) and the Planned Buffer Consumption Ratio (BCRP) comprises the step of implementing in the processing resource the mathematical operation
BCRD_{RPi}=BCR_{RPi}−BCRP_{RPi}
wherein:
“BCR_{RPi}” is the Buffer Consumption Ratio computed at each Reporting Point “i”;
“BCRP_{RPi}” is the Planned Buffer Consumption Ratio computed at each Reporting Point “i”; and
“BCRD_{RPi}” is the difference, at each Reporting Point “i” between the BCR_{RPi} and BCRP_{RPi}.

28. The method according to claim 27 further comprising the steps of computing, for each selected item's Open Documents and at each Reporting Point (RP) associated with that selected item, a Buffer Consumption Ratio Variance (BCRV) relative to the previous Reporting Point in accordance with the formula
BCRV_{RPi}=BCRD_{RPi}−BCRD_{RPi-1}
wherein:
“BCRD_{RPi}” is the difference, at each Reporting Point “i” between the BCR_{RPi} and BCRP_{RPi};
“BCRD_{RPi-1}” is the difference, at each previous Reporting Point “i−1” between the BCR_{RPi} and BCRP_{RPi}; and
“BCRV_{RPi}” is the Buffer Consumption Ratio Variance at each Reporting Point “i”.

29. The method according claim 28 further comprising the step of maintaining, for each selected item and at each Reporting Point (RP) associated with the selected item, ongoing BCRD_{RPi} and BCRV_{RPi} records for all documents processed.

30. The method according to claim 29 further comprising the steps of:
analyzing BCRV_{RPi} records to rank the Reporting Points (RP) according to the amount of negative variance occurring for reallocation of the Time Buffer (TB) within the process flow and/or to focus additional capacity requirements; and
analyzing BCRV_{RPi} records to rank the Reporting Points (RP) according to the amount of positive variance occurring for reallocation and/or reduction of Time Buffer (TB) within the process flow.

31. The method according to claim 30 further comprising the steps of:
maintaining, for each selected item, an ongoing record for the Buffer Consumption Ratio (BCR) for each document processed and finished (BCR_{FINISH}); and
maintaining, for each completed document, an ongoing record of the Buffer Consumption Ratio (BCR) for each document processed and finished (BCR_{FINISH}).

32. The method according to claim 31 further comprising the step of analyzing the BCR_{FINISH} records for each item in conjunction with negative BCRV_{RPi} records from each Reporting Point (RP) to further focus local capacity requirements in terms of global outcomes.
